(19) United States
(12) Patent Application Publication
(10) Pub. No.: US 2017/0134809 A1
(43) Pub. Date: May 11, 2017

(54) BROADCASTING SIGNAL TRANSMISSION APPARATUS, BROADCASTING SIGNAL RECEPTION APPARATUS, BROADCASTING SIGNAL TRANSMISSION METHOD, AND BROADCASTING SIGNAL RECEPTION METHOD

(71) Applicant: LG ELECTRONICS INC., Seoul (KR)

(72) Inventors: Seungjoo AN, Seoul (KR); Kyoungsoo MOON, Seoul (KR); Huisang YOO, Seoul (KR); Jinwon LEE, Seoul (KR); Woosuk KO, Seoul (KR); Sungryong HONG, Seoul (KR)

(73) Assignee: LG ELECTRONICS INC., Seoul (KR)

(21) Appl. No.: 15/411,565

(22) Filed: Jan. 20, 2017

Related U.S. Application Data
(63) Continuation of application No. PCT/KR2015/007352, filed on Jul. 15, 2015.
(60) Provisional application No. 62/030,603, filed on Jul. 29, 2014.

(51) Int. Cl. H04N 21/475; G06F 17/30; H04N 21/8358; H04N 21/658; H04N 21/466; H04N 21/45

(52) U.S. Cl. CPC H04N 21/4758; H04N 21/4667; H04N 21/4532; H04N 21/8358; H04N 21/6582; G06F 17/30867; G06F 17/3082

(57) ABSTRACT

The present invention suggests a method for providing a personalized service at a broadcasting receiver. The present method can be a method for providing a personalized service, the method comprising the steps of: receiving, by a receiving module, a personalization table including at least one personalization question about personalized service provision; acquiring an answer to the at least one personalization question from a user, and storing the answer, by a personalization module; receiving, by the receiving module, first filtering criteria including personalization reference information about a particular service; and comparing, by a filtering module, the personalization reference information of the received first filtering criteria with the stored answer, and if they match, receiving, by the receiving module, service data about the particular service.

### TECHNICAL FIELD

The present invention relates to a broadcast signal transmitting device, a broadcast signal receiving device, and a broadcast transceiving method.

### BACKGROUND ART

As analog broadcast signal transmission is terminated, various technologies for transmitting and receiving a digital broadcast signal have been developed. A digital broadcast signal is capable of containing a larger amount of video/audio data than an analog broadcast signal and further containing various types of additional data as well as video/audio data.

### DISCLOSURE

### Technical Problem

That is, a digital broadcast system may provide a high definition (HD) image, multi channel audio, and various additional services. However, for digital broadcast, network flexibility obtained by considering data transmission efficiency for a large amount of data transmission, robustness of a transceiving network, and a mobile receiving apparatus needs to be enhanced.

### Technical Solution

The object of the present invention can be achieved by providing a method of providing a personalized service by a broadcast receiver, the method including receiving a personalization table including at least one personalization question about provision of a personalized service by a receiving module, acquiring an answer to the at least one personalization question from a user and storing the answer by a personalization module, receiving first filtering criteria including personalization criteria information on a specific service by the receiving module, and receiving service data about the specific service by the receiving module by a filtering module when personalization criteria information of the received first filtering criteria and the stored answer are compared and match.

The method may further include generating and storing viewing history information on service viewing of a user by a history module.

In another aspect of the present invention, provided herein is a broadcast receiver for providing a personalized service, including a receiving module configured to receive a personalization table including at least one personalization question about provision of a personalized service, a personalization module configured to acquire an answer to the at least one personalization question from a user and to store the answer, the receiving module receiving first filtering criteria including personalization criteria information on a specific service, and a filtering module configured to compare personalization criteria information of the received first filtering criteria and the stored answer, when the personalization criteria information and the stored answer match, the receiving module receiving service data about the specific service.

The broadcast receiver may further include a history module configured to generate and store viewing history information on service viewing of a user.

### Advantageous Effects

As is apparent from the above description, the embodiments of the present invention can process data according to service characteristics to control QoS (Quality of Service) for each service or service component, thereby providing various broadcast services.

The embodiments of the present invention can achieve transmission flexibility by transmitting various broadcast services through the same radio frequency (RF) signal bandwidth.

The embodiments of the present invention can provide a method and apparatus, which are configured to receive digital broadcast signals without errors even with mobile reception equipment or in an indoor environment, for transmitting and receiving broadcast signals.

### DESCRIPTION OF DRAWINGS

FIG. 1 illustrates a structure of an apparatus for transmitting broadcast signals for future broadcast services according to an embodiment of the present invention.

FIG. 2 illustrates a BICM block according to an embodiment of the present invention.

FIG. 3 illustrates a frame building block according to one embodiment of the present invention.

FIG. 4 illustrates an OFDM generation block according to an embodiment of the present invention.

FIG. 5 is a diagram showing an automatic content recognition (ACR) based enhanced television (ETV) service system.

FIG. 6 is a diagram showing an ACR query result format according to an embodiment of the present invention.

FIG. 7 is a diagram showing the structure of a receiver according to the embodiment of the present invention.

FIG. 8 is a diagram showing the structure of a receiver according to another embodiment of the present invention.

FIG. 9 is a diagram illustrating a digital broadcast system according to an embodiment of the present invention.

FIG. 10 is a flowchart of a digital broadcast system according to another embodiment of the present invention.

FIG. 11 is a flowchart of a digital broadcast system according to another embodiment of the present invention.

FIG. 12 is a diagram illustrating a PDI table according to an embodiment of the present invention.

FIG. 13 is a diagram illustrating a PDI table according to another embodiment of the present invention.

FIG. 14 is a diagram illustrating a PDI table according to another embodiment of the present invention.

FIG. 15 is a diagram illustrating a PDI table according to another embodiment of the present invention.

FIG. 16 is a diagram illustrating a PDI table according to another embodiment of the present invention.

FIG. 17 is a diagram illustrating a filtering criteria table according to an embodiment of the present invention.

FIG. 18 is a diagram illustrating a filtering criteria table according to another embodiment of the present invention.

FIG. 19 is a diagram illustrating a filtering criteria table according to another embodiment of the present invention.

FIG. 20 is a diagram illustrating a filtering criteria table according to another embodiment of the present invention.

FIG. 21 is a flowchart of a digital broadcast system according to another embodiment of the present invention.

FIG. 22 is a diagram illustrating a filtering criteria descriptor syntax according to an embodiment of the present invention.

FIG. 23 is a flowchart of a digital broadcast system according to another embodiment of the present invention.

FIG. 24 is a flowchart illustrating a digital broadcast system according to another embodiment of the present invention.

FIG. 25 is a diagram illustrating a TPT according to an embodiment of the present invention.

FIG. 26 is a flowchart of a digital broadcast system according to another embodiment of the present invention.

FIG. 27 is a view showing a Protocol Stack for a next generation broadcasting system according to an embodiment of the present invention.

FIG. 28 is a structural view showing exchange of user data between a receiver and a companion device according to an embodiment of the present invention.

FIG. 29 is a view showing a portion of PDI user data according to an embodiment of the present invention.

FIG. 30 is a view showing another portion of PDI user data according to an embodiment of the present invention.

FIG. 31 is a view showing GetUserDataIdsList and GetUserData, actions of a UserData service, according to an embodiment of the present invention.

FIG. 32 is a view showing GetUserDataQAIdsList and GetUserDataQA, actions of a UserData service for transmission on a per pair basis of questions and answers, according to an embodiment of the present invention.

FIG. 33 is a structural view showing exchange of user data between a receiver and companion devices according to another embodiment of the present invention.

FIG. 34 is a view showing an action of a FilteringCriteria service according to an embodiment of the present invention.

FIG. 35 is a view showing a broadcast receiver according to an embodiment of the present invention.

FIG. 36 is a diagram illustrating a receiver further including a content history engine according to another embodiment of the present invention.

FIG. 37 is a diagram illustrating a content history table according to an embodiment of the present invention.

FIG. 38 is a diagram illustrating FC corresponding to a content history table according to an embodiment of the present invention.

FIG. 39 is a diagram illustrating a simplified content history table according to an embodiment of the present invention.

FIG. 40 is a diagram illustrating a simplified content history table according to another embodiment of the present invention.

FIG. 41 is a diagram illustrating simplified FC corresponding to the content history table according to an embodiment of the present invention.

FIG. 42 is a diagram illustrating part of usage reporting data according to an embodiment of the present invention.

FIG. 43 is a diagram illustrating another part of usage reporting data according to an embodiment of the present invention.

FIG. 44 is a diagram illustrating a sequence for providing a personalized service using a content history table and FC according to an embodiment of the present invention.

FIG. 45 is a diagram illustrating part of FC including count information according to an embodiment of the present invention.

FIG. 46 is a diagram illustrating parting of FC including threshold value information according to an embodiment of the present invention.

FIG. 47 is a diagram illustrating a comparison procedure in FC including threshold value information according to an embodiment of the present invention.

FIG. 48 is a sequence diagram illustrating the case in which criteria information is transmitted through PDI user data when PDI user data is collected based on content history information according to an embodiment of the present invention.

FIG. 49 is a diagram illustrating a configuration of PDI user data when criteria information is transmitted through the PDI user data during collection of PDI user data based on content history information according to an embodiment of the present invention.

FIG. 50 is a diagram illustrating examples of content history information and PDI user data when criteria information is transmitted through the PDI user data during collection of PDI user data based on content history information according to an embodiment of the present invention.

FIG. 51 is a sequence diagram illustrating the case in which criteria information is transmitted through filtering criteria during collection of PDI user data based on content history information according to an embodiment of the present invention.

FIG. 52 is a diagram illustrating a configuration of filtering criteria when criteria information is transmitted through filtering criteria during collection of PDI user data based on content history information according to an embodiment of the present invention.

FIG. 53 is a diagram illustrating an example of filtering criteria when criteria information is transmitted through filtering criteria during collection of PDI user data based on content history information according to an embodiment of the present invention.

FIG. 54 is a diagram illustrating the case in which content history information is simplified using a heuristic method according to an embodiment of the present invention.

FIG. 55 is a diagram illustrating a procedure of collecting PDI user data based on simplified content history information using a heuristic method according to an embodiment of the present invention (criteria information is transmitted through PDI user data).

FIG. 56 is a diagram illustrating a procedure of collecting PDI user data based on simplified content history information using a heuristic method according to an embodiment of the present invention (criteria information is transmitted through filtering criteria).

FIG. 57 is a diagram illustrating a procedure of collecting PDI user data based on content history information in an auto content recognition (ACR) situation according to an embodiment of the present invention.

FIG. 58 is a diagram illustrating a method of providing a personalized service according to an embodiment of the present invention.

FIG. 59 is a diagram illustrating a broadcast receiver for providing a personalized service according to an embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

The present invention provides apparatuses and methods for transmitting and receiving broadcast signals for future broadcast services. Future broadcast services according to an embodiment of the present invention include a terrestrial broadcast service, a mobile broadcast service, a UHDTV service, etc.

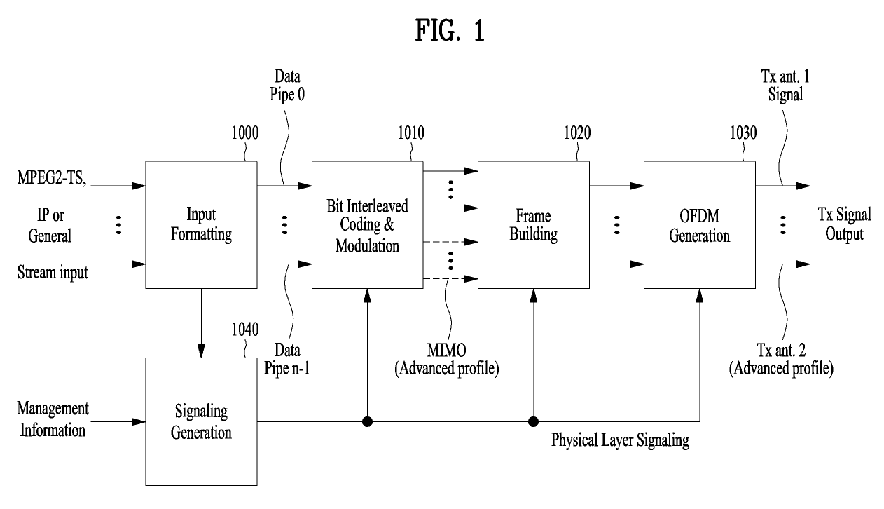

FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PARR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

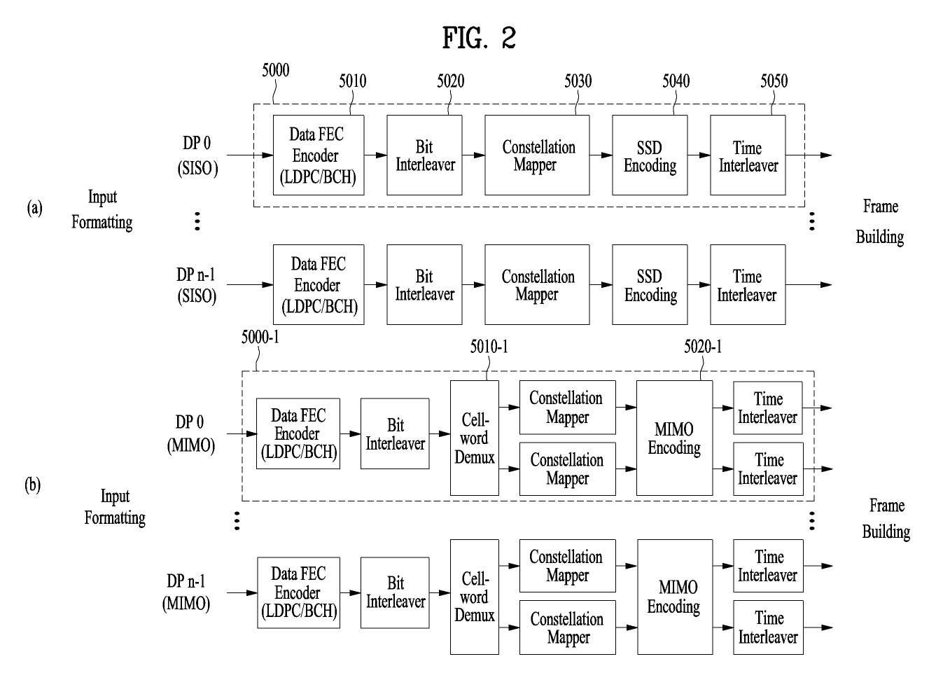

FIG. 2 illustrates a BICM block according to an embodiment of the present invention.

The BICM block illustrated in FIG. 2 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, el. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver.

However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

The above-described blocks may be omitted or replaced by blocks having similar or identical functions.

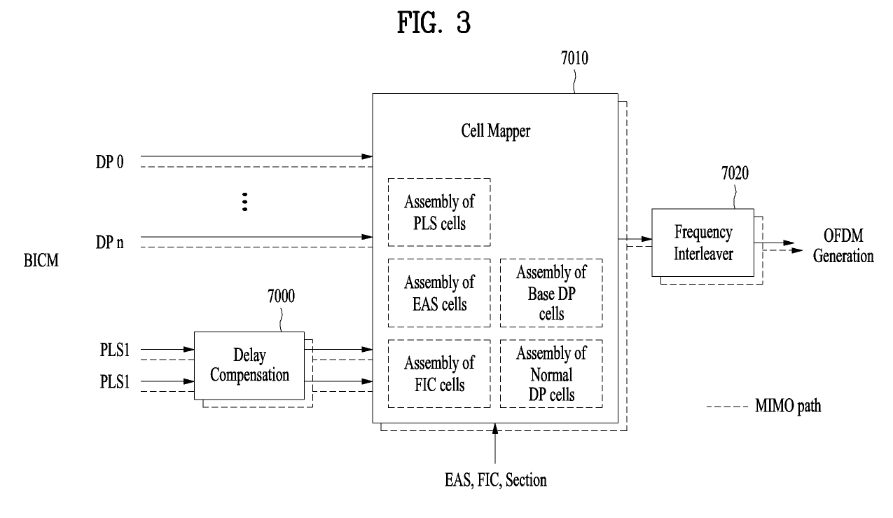

FIG. 3 illustrates a frame building block according to one embodiment of the present invention.

The frame building block illustrated in FIG. 3 corresponds to an embodiment of the frame building block 1020 described with reference to FIG. 1.

Referring to FIG. 3, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver 5050. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the Tis for each of the DPs, PLS cells, and EAC/FIC cells, if any, into arrays of active OFDM cells corresponding to each of the OFDM symbols within a frame. Service signaling data (such as PSI (program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame.

The above-described blocks may be omitted or replaced by blocks having similar or identical functions.

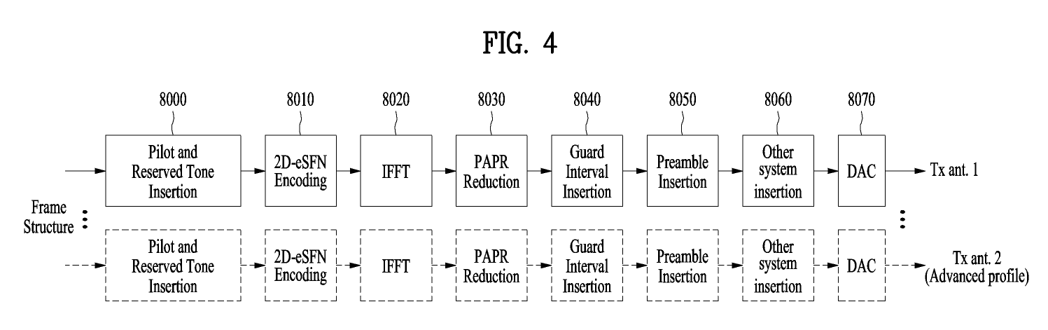

FIG. 4 illustrates an OFDM generation block according to an embodiment of the present invention.

The OFDM generation block illustrated in FIG. 4 corresponds to an embodiment of the OFDM generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 4, the OFDM generation block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070.

The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc.

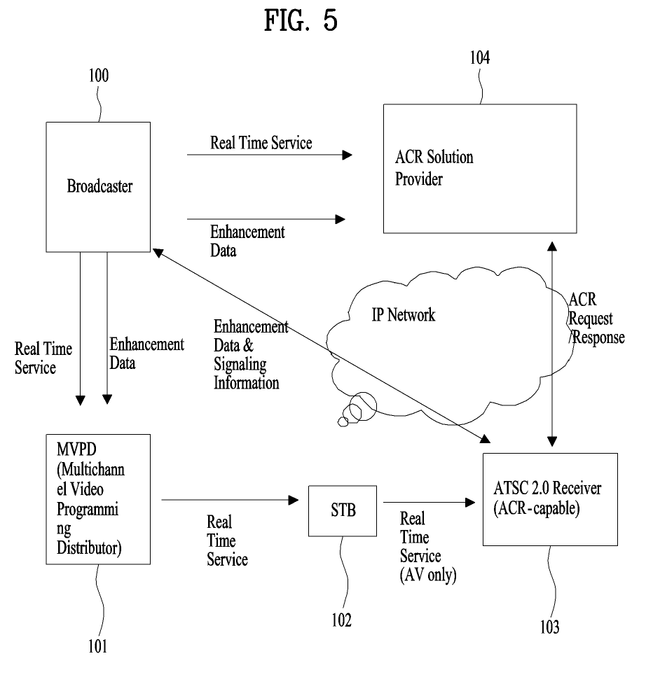

FIG. 5 is a diagram showing an automatic content recognition (ACR) based enhanced television (ETV) service system.

The ACR based ETV service system shown in FIG. 5 may include a broadcaster or content provider 100, a multichannel video programming distributor (MVPD) 101, a set-top box (STB) 102, a receiver 103 such as a digital TV receiver, and an ACR server (or an ACR Solution Provider) 104. The receiver 103 may operate according to definition of the advanced television system committee (ATSC) and may support an ACR function. A real-time broadcast service 110 may include A/V content.

A digital broadcast service may be largely divided into a terrestrial broadcast service provided by the broadcaster 100 and a multi-channel broadcast service, such as a cable broadcast or a satellite broadcast, provided by the MVPD 101. The broadcaster 100 may transmit a real-time broadcast service 110 and enhancement data (or additional data) 120 together. In this case, as shown in FIG. 5, the receiver 103 may receive only the real-time broadcast service 110 and may not receive the enhancement data 120 through the MVPD 101 and the STB 102.

Accordingly, in order to receive the enhancement data 120, the receiver 103 analyzes and processes A/V content output as the real-time broadcast service 110 and identifies broadcast program information and/or broadcast program related metadata. Using the identified broadcast program information and/or broadcast program related metadata, the receiver 103 may receive the enhancement data from the broadcaster 100 or the ACR server 104 (140). In this case, the enhancement data may be transmitted via an Internet protocol (IP) network 150.

If the enhancement data is received from a separate ACR server 104 (140), in a mechanism between the ACR server 104 and the receiver 103, a request/response model among triggered declarative object (TDO) models defined in the ATSC 2.0 standard may be applied to the ACR server 104. Hereinafter, the TDO and request/response model will be described.

TDO indicates additional information included in broadcast content. TDO serves to timely triggers additional information within broadcast content. For example, if an audition program is broadcast, a current ranking of an audition participant preferred by a viewer may be displayed along with the broadcast content. At this time, additional information of the current rating of the audition participant may be a TDO. Such a TDO may be changed through interaction with viewers or provided according to viewer's intention.

In the request/response ACR model of the standard ATSC 2.0, the digital broadcast receiver 103 is expected to generate signatures of the content periodically (e.g. every 5 seconds) and send requests containing the signatures to the ACR server 104. When the ACR server 104 gets a request from the digital broadcast receiver 103, it returns a response. The communications session is not kept open between request/response instances. In this model, it is not feasible for the ACR server 104 to initiate messages to the client.

As digital satellite broadcasting has been introduced, digital data broadcasting has appeared as a new supplementary service. An interactive data broadcast, which is a representative interactive service, may transmit not only a data signal but also an existing broadcast signal to a subscriber so as to provide various supplementary services.

A digital data broadcast may be largely divided into an independent service using a virtual channel and a broadcast-associated service via an enhanced TV (ETV). The independent service includes only text and graphics without a broadcast image signal and is provided in a format similar to an existing Internet web page. Representative examples of the independent service include a weather and stock information provision service, a TV banking service, a commercial transaction service, etc. The broadcast-associated service transmits not only a broadcast image signal but also additional text and graphic information. A viewer may obtain information regarding a viewed broadcast program via a broadcast-associated service. For example, there is a service for enabling a viewer to view a previous story or a filming location while viewing a drama.

In a broadcast-associated service of a digital data broadcast, an ETV service may be provided based on ACR technology. ACR means technology for automatically recognizing content via information hidden in the content when a device plays audio/video (A/V content) back.

In implementation of ACR technology, a watermarking or fingerprinting scheme may be used to acquire information regarding content. Watermarking refers to technology for inserting information indicating a digital content provider into digital content. Fingerprinting is equal to watermarking in that specific information is inserted into digital content and is different therefrom in that information regarding a content purchaser is inserted instead of information regarding a content provider.

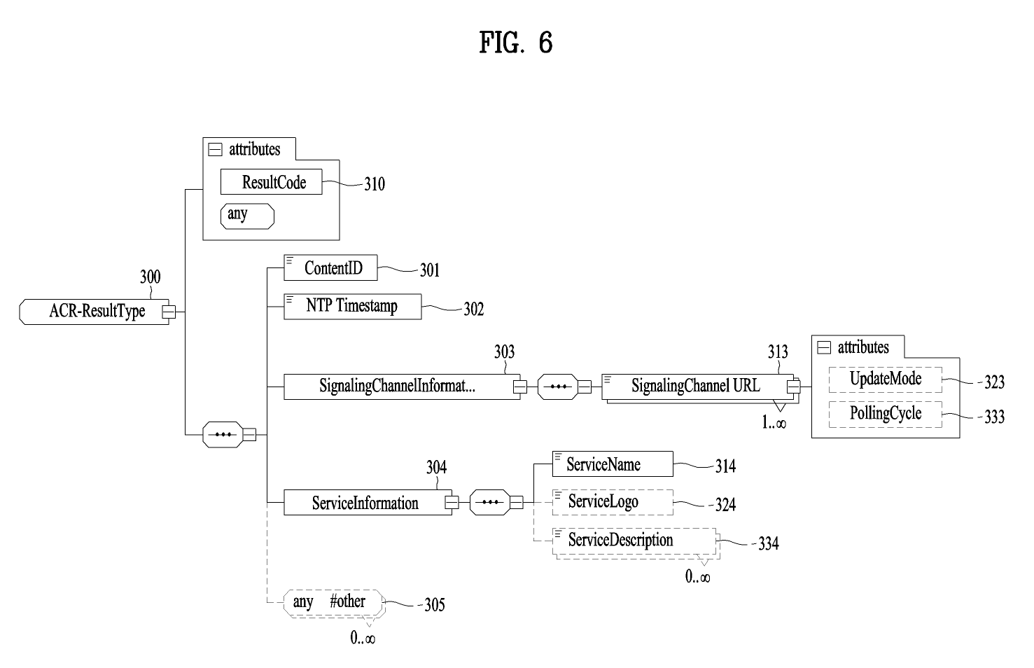

FIG. 6 is a diagram showing an ACR query result format according to an embodiment of the present invention.

According to the existing ACR service processing system, if a broadcaster transmits content for a real-time service and enhancement data for an ETV service together and a TV receiver receives the content and the ETV service, the content for the real-time service may be received but the enhancement data may not be received.

In this case, according to the embodiment of the present invention, it is possible to solve problems of the existing ACR processing system through an independent IP signaling channel using an IP network. That is, a TV receiver may receive content for a real-time service via an MVPD and receive enhancement data via an independent IP signaling channel.

In this case, according to the embodiment of the present invention, an IP signaling channel may be configured such that a PSIP stream is delivered and processed in the form of a binary stream. At this time, the IP signaling channel may be configured to use a pull method or a push method.

The IP signaling channel of the pull method may be configured according to an HTTP request/response method. According to the HTTP request/response method, a PSIP binary stream may be included in an HTTP response signal for an HTTP request signal and transmitted through SignalingChannelURL. In this case, a polling cycle may be periodically requested according to Polling_cycle in metadata delivered as an ACR query result. In addition, information about a time and/or a cycle to be updated may be included in a signaling channel and transmitted. In this case, the receiver may request signaling information from a server based on update time and/or cycle information received from the IP signaling channel.

The IP signaling channel of the push method may be configured using an XMLHTTPRequest application programming interface (API). If the XMLHTTPRequest API is used, it is possible to asynchronously receive updates from the server. This is a method of, at a receiver, asynchronously requesting signaling information from a server through an XMLHTTPRequest object and, at the server, providing signaling information via this channel in response thereto if signaling information has been changed. If there is a limitation in standby time of a session, a session timeout response may be generated and the receiver may recognize the session timeout response, request signaling information again and maintain a signaling channel between the receiver and the server.

In order to receive enhancement data through an IP signaling channel, the receiver may operate using watermarking and fingerprinting. Fingerprinting refers to technology for inserting information about a content purchaser into content instead of a content provider. If fingerprinting is used, the receiver may search a reference database to identify content. A result of identifying the content is called an ACR query result. The ACR query result may include a query provided to a TV viewer and answer information of the query in order to implement an ACR function. The receiver may provide an ETV service based on the ACR query result.

Information about the ACR query result may be inserted/embedded into/in A/V content on a watermark based ACR system and may be transmitted. The receiver may extract and acquire ACR query result information through a watermark extractor and then provide an ETV service. In this case, an ETV service may be provided without a separate ACR server and a query through an IP network may be omitted.

FIG. 6 is a diagram of an XML scheme indicating an ACR query result according to an embodiment of the present invention. As shown in FIG. 6, the XML format of the ACR query result may include a result code element 310 and the ACR query result type 300 may include a content ID element 301, a network time protocol (NTP) timestamp element 302, a signaling channel information element 303, a service information element 304 and an other-identifier element 305. The signaling channel information element 303 may include a signaling channel URL element 313, an update mode element 323 and a polling cycle element 333, and the service information element 304 may include a service name element 314, a service logo element 324 and a service description element 334.

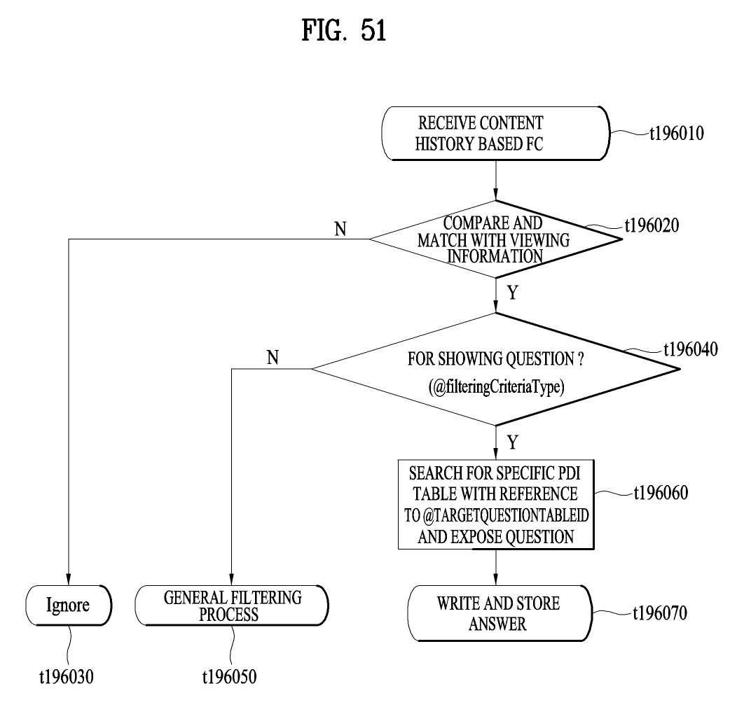

Hereinafter, the diagram of the XML schema of the ACR query result shown in FIG. 51 will be described in detail and an example of the XML schema will be described.

The result code element 310 may indicate a result value of an ACR query. This may indicate query success or failure and a failure reason if a query fails in the form of a code value. For example, if the value of the result code element 310 is 200, this may indicate that a query succeeds and content information corresponding thereto is returned and, if the value of the result code element 310 is 404, this may indicate that content is not found.

The content ID element 301 may indicate an identifier for globally and uniquely identifying content and may include a global service identifier element, which is an identifier for identifying a service.

The NTP timestamp element 302 may indicate that a time of a specific point of a sample frame interval used for an ACR query is provided in the form of an NTP timestamp. Here, the specific point may be a start point or end point of the sample frame. NTP means a protocol for synchronizing a time of a computer with a reference clock through the Internet and may be used for time synchronization between a time server and client distributed on a computer network. Since NTP uses a universal time coordinated (UTC) time and ensures accuracy of 10 ms, the receiver may accurately process a frame synchronization operation.

The signaling channel information element 303 may indicate access information of an independent signaling channel on an IP network for an ETV service.

More specifically, the signaling channel URL element 313, which is a sub element of the signaling channel information element 303, may indicate URL information of a signaling channel. The signaling channel URL element 313 may include an update mode element 323 and a polling cycle element 333 as sub elements. The update mode element 323 may indicate a method of acquiring information via an IP signaling channel. For example, in a pull mode, the receiver may periodically perform polling according to a pull method to acquire information and, in a push mode, the server may transmit information to the receiver according to a push method. The polling cycle element 333 may indicate a basic polling cycle value of the receiver according to a pull method if the update mode element 323 is a pull mode. Then, the receiver may specify a basic polling cycle value and transmit a request signal to the server at a random time interval, thereby preventing requests from overloading in the server.

The service information element 304 may indicate information about a broadcast channel. The content id element 301 may indicate an identifier of a service which is currently being viewed by a viewer and the service information element 304 may indicate detailed information about the broadcast channel. For example, the detailed information indicated by the service information element 304 may be a channel name, a logo, or a text description.

More specifically, the service name element 314 which is a sub element of the service information element 304 may indicate a channel name, the service logo element 324 may indicate a channel logo, and the service description element 334 may indicate a channel text description.

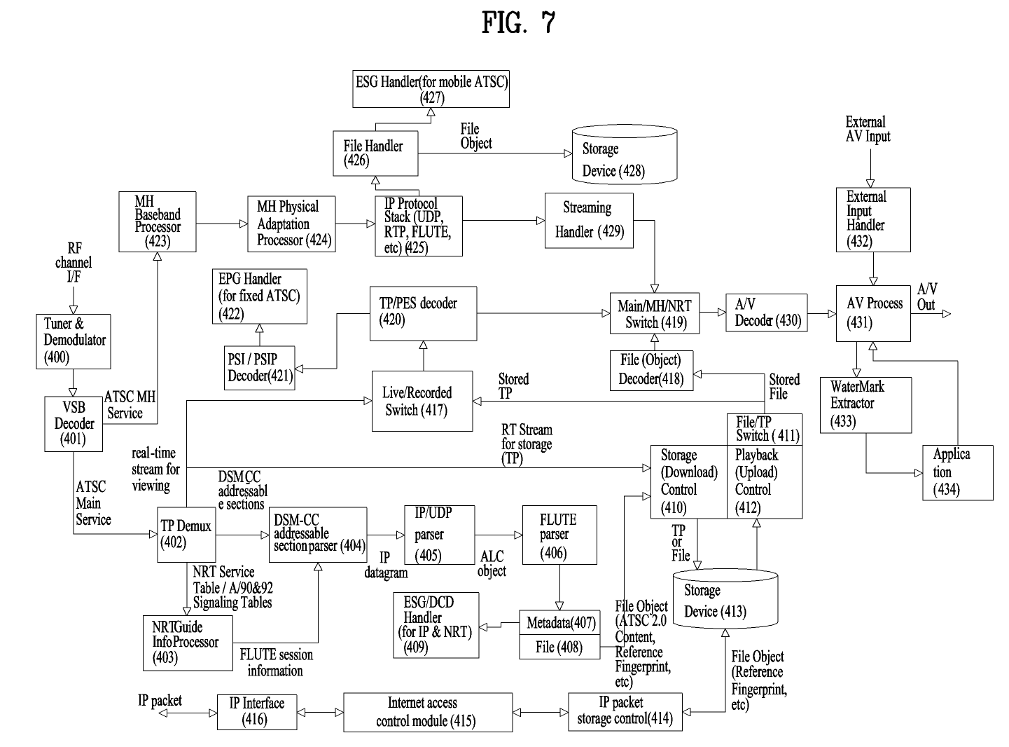

FIG. 7 is a diagram showing the structure of a receiver according to the embodiment of the present invention.

More specifically, FIG. 7 shows an embodiment of the configuration of a receiver supporting an ACR based ETV service using watermarking.

As shown in FIG. 7, the receiver supporting the ACR based ETV service according to the embodiment of the present invention may include an input data processor, an ATSC main service processor, an ATSC mobile/handheld (MH) service processor and/or an ACR service processor. The input data processor may include a tuner/demodulator 400 and/or a vestigial side band (VSB) decoder 401. The ATSC main service processor may include a transport protocol (TP) demux 402, a Non Real Time (NRT) guide information processor 403, a digital storage media command and Control (DSM-CC) addressable section parser 404, an Information Provider (IP)/User Datagram Protocol (UDP) parser 405, a FLUTE parser 406, a metadata module 407, a file module 408, an electronic service guide (ESG)/data carrier detect (DCD) handler 409, a storage control module 410, a file/TP switch 411, a playback control module 412, a first 1 storage device 413, an IP packet storage control module 414, an Internet access control module 415, an IP interface 416, a live/recorded switch 417, a file (object) decoder 418, a TP/Packetized Elementary Stream (PES) decoder 420, a Program Specific Information (PSI)/program and system information protocol (PSIP) decoder 421 and/or an Electronic Program Guide (EPG) handler 422. The ATSC MH service processor may include a main/MH/NRT switch 419, a MH baseband processor 423, an MH physical adaptation processor 424, an IP protocol stack 425, a file handler 426, an ESG handler 427, a second storage device 428 and/or a streaming handler 429. The ACR service processor may include a main/MH/NRT switch 419, an A/V decoder 430, an A/V process module 431, an external input handler 432, a watermark extractor 433 and/or an application 434.

Hereinafter, operation of each module of each processor will be described.

In the input data processor, the tuner/demodulator 400 may tune and demodulate a broadcast signal received from an antenna. Through this process, a VSB symbol may be extracted. The VSB decoder 401 may decode the VSB symbol extracted by the tuner/demodulator 400.

The VSB decoder 401 may output ATSC main service data and MH service data according to decoding. The ATSC main service data may be delivered to and processed by the ATSC main service processor and the MH service data may be delivered to and processed by the ATSC MH service processor.

The ATSC main service processor may process a main service signal in order to deliver main service data excluding an MH signal to the ACR service processor. The TP demux 402 may demultiplex transport packets of ATSC main service data transmitted via the VSB signal and deliver the demultiplexed transport packets to other processing modules. That is, the TP demux 402 may demultiplex a variety of information included in the transport packets and deliver information such that elements of the broadcast signal are respectively processed by modules of the broadcast receiver. The demultiplexed data may include real-time streams, DSM-CC addressable sections and/or an NRT service table/A/90&92 signaling table. More specifically, as shown in FIG. 7, the TP demux 402 may output the real-time streams to the live/recorded switch 417, output the DSM-CC addressable sections to the DSM-CC addressable section parser 404 and output the NRT service table/A/90&92 signaling table to the NRT guide information processor 403.

The NRT guide information processor 403 may receive the NRT service table/A/90&92 signaling table from the TP demux 402 and extract and deliver FLUT session information to the DSM-CC addressable section parser 404. The DSM-CC addressable section parser 404 may receive the DSM-CC addressable sections from the TP demux 402, receive the FLUT session information from the NRT guide information processor 403 and process the DSM-CC addressable sections. The IP/UDP parser 405 may receive the data output from the DSM-CC addressable section parser 404 and parse IP datagrams transmitted according to the IP/UDP. The FLUTE parser 406 may receive data output from the IP/UDP parser 405 and process FLUTE data for transmitting a data service transmitted in the form of an asynchronous layered coding (ALC) object. The metadata module 407 and the file module 408 may receive the data output from the FLUTE parser 406 and process metadata and a restored file. The ESG/DCD handler 409 may receive data output from the metadata module 407 and process an electronic service guide and/or downlink channel descriptor related to a broadcast program. The restored file may be delivered to the storage control module 410 in the form of a file object such as ATSC 2.0 content and reference fingerprint. The file object may be processed by the storage control module 410 and divided into a normal file and a TP file to be stored in the first storage device 413. The playback control module 412 may update the stored file object and deliver the file object to the file/TP switch 411 in order to decode the normal file and the TP file. The file/TP switch 411 may deliver the normal file to the file decoder 418 and deliver the TP file to the live/recorded switch 417 such that the normal file and the TP file are decoded through different paths.

The file decoder 418 may decode the normal file and deliver the decoded file to the ACR service processor. The decoded normal file may be delivered to the main/MH/NRT switch 419 of the ACR service processor. The TP file may be delivered to the TP/PES decoder 420 under the control of the live/recorded switch 417. The TP/PES decoder 420 decodes the TP file and the PSI/PSIP decoder 421 decodes the decoded TP file again. The EPG handler 422 may process the decoded TP file and process an EPG service according to ATSC.

The ATSC MH service processor may process the MH signal in order to transmit ATSC MH service data to the ACR service processor. More specifically, the MH baseband processor 423 may convert the ATSC MH service data signal into a pulse waveform suitable for transmission. The MH physical adaptation processor 424 may process the ATSC MH service data in a form suitable for an MH physical layer.

The IP protocol stack module 425 may receive the data output from the MH physical adaption processor 424 and process data according to a communication protocol for Internet transmission/reception. The file handler 426 may receive the data output from the IP protocol stack module 425 and process a file of an application layer. The ESG handler 427 may receive the data output from the file handler 426 and process a mobile ESG. In addition, the second storage device 428 may receive the data output from the file handler 426 and store a file object. In addition, some of the data output from the IP protocol stack module 425 may become data for an ACR service of the receiver instead of a mobile ESG service according to ATSC. In this case, the streaming handler 429 may process real streaming received via a real-time transport protocol (RTP) and deliver the real streaming to the ACR service processor.

The main/MH/NRT switch 419 of the ACR service processor may receive the signal output from the ATSC main service processor and/or the ATSC MH service processor. The A/V decoder 430 may decode compression A/V data received from the main/MH/NRT switch 419. The decoded A/V data may be delivered to the A/V process module 431.

The external input handler 432 may process the A/V content received through external input and transmit the A/V content to the A/V process module 431.

The A/V process module 431 may process the A/V data received from the A/V decoder 430 and/or the external input handler 432 to be displayed on a screen. In this case, the watermark extractor 433 may extract data inserted in the form of a watermark from the A/V data. The extracted watermark data may be delivered to the application 434. The application 434 may provide an enhancement service based on an ACR function, identify broadcast content and provide enhancement data associated therewith. If the application 434 delivers the enhancement data to the A/V process module 431, the A/V process module 431 may process the received A/V data to be displayed on a screen.

In detail, the watermark extractor 433 illustrated in FIG. 7 may extract data (or watermark) inserted in the form of a watermark from the A/V data received through external input. The watermark extractor 433 may extract a watermark from the audio data, extract a watermark from the video data, and extract a watermark from audio and video data. The watermark extractor 433 may acquire channel information and/or content information from the extracted watermark.

The receiver according to the present embodiment may tune an ATSC mobile handheld (MH) channel and receive corresponding content and/or metadata using the channel information and/or the content information that are acquired by the watermark extractor 433. In addition, the receiver according to the present embodiment may receive corresponding content and/or metadata via the Internet. Then, the receiver may display the receive content and/or the metadata using trigger, etc.

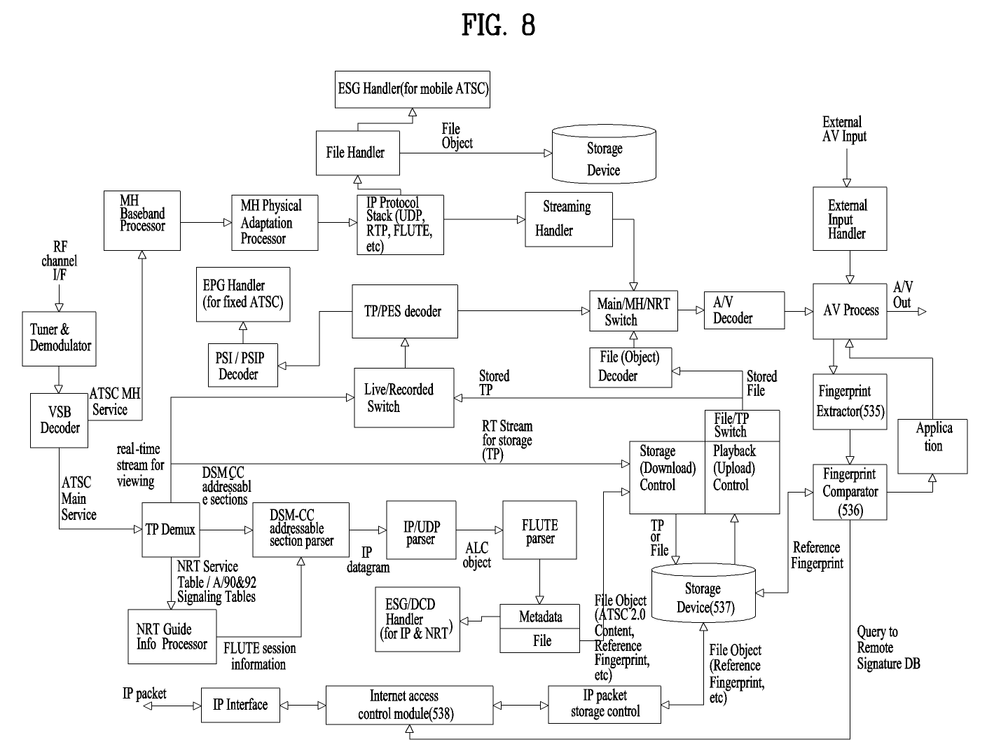

FIG. 8 is a diagram showing the structure of a receiver according to another embodiment of the present invention.

More specifically, FIG. 8 shows an embodiment of the configuration of a receiver supporting an ACR based ETV service using fingerprinting.

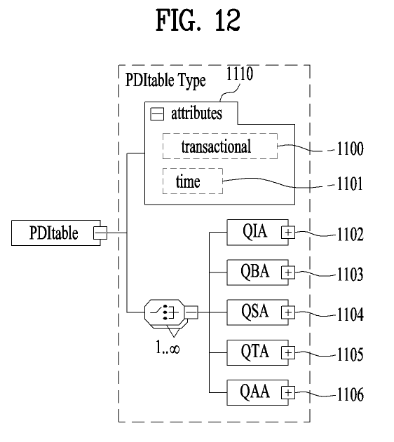

The basic structure of the receiver illustrated in FIG. 8 is basically the same as that of the receiver illustrated in FIG. 7. However, the receiver illustrated in FIG. 8 is different from the receiver illustrated in FIG. 7 in that the receiver of FIG. 12 further includes a fingerprint extractor 535 and/or a fingerprint comparator 536 according to an embodiment of the present invention. In addition, the receiver of FIG. 8 may not include the watermark extractor 433 among the elements illustrated in FIG. 7

The basic structure of the receiver of FIG. 8 is basically the same as the structure of the receiver illustrated in FIG. 7, and thus, a detailed description thereof will be omitted. Hereinafter, an operation of the receiver will be described in terms of the fingerprint extractor 535 and/or the fingerprint comparator 536.

The fingerprint extractor 535 may extract data (or signature) inserted into A/V content received through external input. The fingerprint extractor 535 according to the present embodiment may extract signature from audio content, extract signature from video content, or extract signature from audio content and video content.

The fingerprint comparator 536 may acquire channel information and/or content information using the signature extracted from the A/V content. The fingerprint comparator 536 according to the present embodiment may acquire the channel information and/or the content information through a local search and/or a remote search.

In detail, as illustrated in FIG. 8, a route for an operation of the fingerprint comparator 536 that accesses a storage device 537 is referred to as a local search. In addition, as illustrated in FIG. 8, a route for an operation of the fingerprint comparator 536 that accesses an internet access control module 538 is referred to as a remote search. The local search and the remote search will be described below.

In the local search according to the present embodiment, the fingerprint comparator 536 may compare the extracted signature with a reference fingerprint stored in the storage device 537. The reference fingerprint is data that the fingerprint comparator 536 further receives in order to process the extracted signature.

In detail, the fingerprint comparator 536 may match and compare the extracted signal and the reference fingerprint in order to determine whether the extracted signal and the reference fingerprint are identical to acquire channel information and/or content information.

As the comparison result, when the extracted signal is identical to the reference fingerprint, the fingerprint comparator 536 may transmit the comparison result to application. The application may transmit content information and/or channel information related to the extracted signature using the comparison result to the receiver.

As the comparison result, when the extracted signature is not matched with the reference fingerprint or the number of reference fingerprints is not sufficient, the fingerprint comparator 536 may receive a new reference fingerprint through an ATSC MH channel. Then, the fingerprint comparator 536 may re-compare the extracted signature and the reference fingerprint.

In the remote search according to the present embodiment, the fingerprint comparator 536 may receive channel information and/or content information from a signature database server on the Internet.

In detail, the fingerprint comparator 536 may access the Internet via the internet access control module 538 to access the signature database server. Then, the fingerprint comparator 536 may transmit the extracted signature as a query parameter to the signature database server.

When all broadcasters use one integrated signature database server, the fingerprint comparator 536 may transmit the query parameter to a corresponding signature database server. When broadcasters separately manage respective signature database servers, the fingerprint comparator 536 may transmit query parameters to respective signature databases. In addition, the fingerprint comparator 536 may simultaneously transmit the query parameter to two or more signature database servers.

The receiver according to the present embodiment may tune an ATSC MH channel using the channel information and/or the content information that are acquired by the fingerprint comparator 536 and receive corresponding content and/or metadata. Then, the receiver may display the received content and/or metadata using trigger, etc.

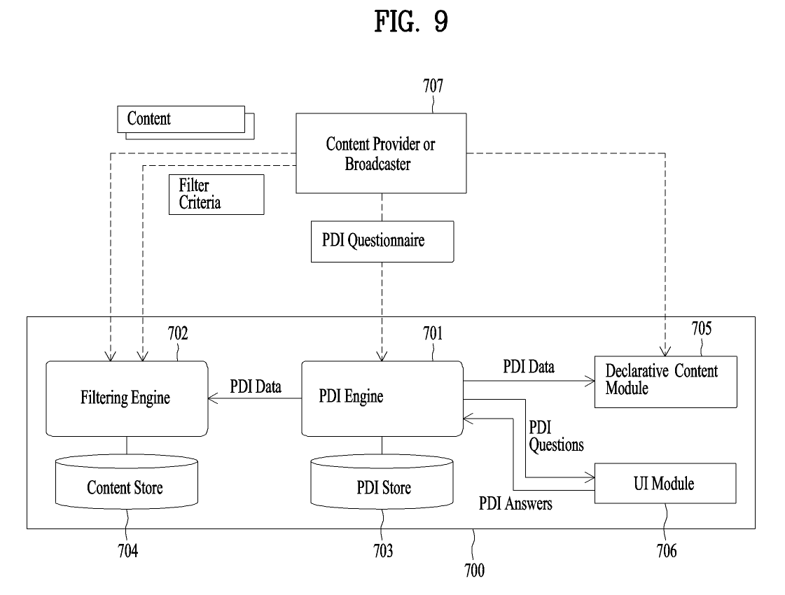

FIG. 9 is a diagram illustrating a digital broadcast system according to an embodiment of the present invention.

In detail, FIG. 9 illustrates a personalization broadcast system including a digital broadcast receiver (or a receiver) for a personalization service. The personalization service according to the present embodiment is a service for selecting and supplying content appropriate for a user based on user information. In addition, the personalization broadcast system according to the present embodiment may provide a next generation broadcast service for providing an ATSC 2.0 service or a personalization service.

According to an embodiment of the present invention, as an example of the user information, user's profiles, and demographics and interests information (or PDI data) are defined. Hereinafter, elements of the personalization broadcast system will be described.

The answers to the questionnaires, taken together, represent the user's Profile, Demographics, and Interests (PDI). The data structure that encapsulates the questionnaire and the answers given by a particular user is called a PDI Questionnaire or a PDI Table. A PDI Table, as provided by a network, broadcaster or content provider, includes no answer data, although the data structure accommodates the answers once they are available. The question portion of an entry in a PDI Table is informally called a “PDI Question” or “PDI-Q.” The answer to a given PDI question is referred to informally as a “PDI-A.” A set of filter criteria is informally called a “PDI-FC.”

The client device such as an ATSC 2.0-capable receiver includes a function allowing the creation of answers to the questions in the questionnaire (PDI-A instances). This PDI-generation function uses PDI-Q instances as input and produces PDI-A instances as output. Both PDI-Q and PDI-A instances are saved in non-volatile storage in the receiver. The client also provides a filtering function in which it compares PDI-A instances against PDI-FC instances to determine which content items will be suitable for downloading and use.

On the service provider side as shown, a function is implemented to maintain and distribute the PDI Table. Along with content, content metadata are created. Among the metadata are PDI-FC instances, which are based on the questions in the PDI Table.

As illustrated in FIG. 9, the personalization broadcast system may include a content provider (or broadcaster) 707 and/or a receiver 700. The receiver 700 according to the present embodiment may include a PDI engine 701, a filtering engine 702, a PDI store 703, a content store 704, a declarative content module 705, and/or a user interface (UI) module 706. As illustrated in FIG. 9, the receiver 700 according to the present embodiment may receive content, etc. from the content provider 707. The structure of the aforementioned personalization broadcast system may be changed according to a designer's intention.

The content provider 707 according to the present embodiment may transmit content, PDI questionnaire, and/or filtering criteria to the receiver 700. The data structure that encapsulates the questionnaire and the answers given by a particular user is called a PDI questionnaire. According to an embodiment of the present invention, the PDI questionnaire may include questions (or PDI questions) related to profiles, demographics and interests, etc. of a user.

The receiver 700 may process the content, the PDI questionnaire, and/or the filtering criteria, which are received from the content provider 707. Hereinafter, the digital broadcast system will be described in terms of operations of modules included in the receiver 700 illustrated in FIG. 9.

The PDI engine 701 according to the present embodiment may receive the PDI questionnaire provided by the content provider 707. The PDI engine 701 may transmit PDI questions contained in the received in the PDI questionnaire to the UI module 706. When a user's input corresponding to a corresponding PDI question is present, the PDI engine 701 may receive a user's answer and other information (hereafter, referred to as a PDI answer) related to the corresponding PDI question from the UI module 706. Then, the PDI engine 701 may process PDI questions and PDI answers in order to supply the personalization service to generate PDI data. That is, according to an embodiment of the present invention, the PDI data may contain the aforementioned PDI questions and/or PDI answers. Therefore, the PDI answers to the PDI questionnaires, taken together, represent the user's profile, demographics, and interests (or PDI).

In addition, the PDI engine 701 according to the present embodiment may update the PDI data using the received PDI answers. In detail, the PDI engine 701 may delete, add, and/or correct the PDI data using an ID of a PDI answer. The ID of the PDI answer will be described below in detail with regard to an embodiment of the present invention. In addition, when another module requests the PDI engine 701 to transmit PDI data, the PDI engine 701 may transmit PDI data appropriate for the corresponding request to the corresponding module.

The filtering engine 702 according to the present embodiment may filter content according to the PDI data and the filtering criteria. The filtering criteria refers to a set filtering criterias for filtering only contents appropriate for a user using the PDI data. In detail, the filtering engine 702 may receive the PDI data from the PDI engine 701 and receive the content and/or the filtering criteria from the content provider 707. In addition, when the convent provider 707 transmits a parameter related to declarative content, the convent provider 707 may transmit a filtering criteria table related to the declarative content together.

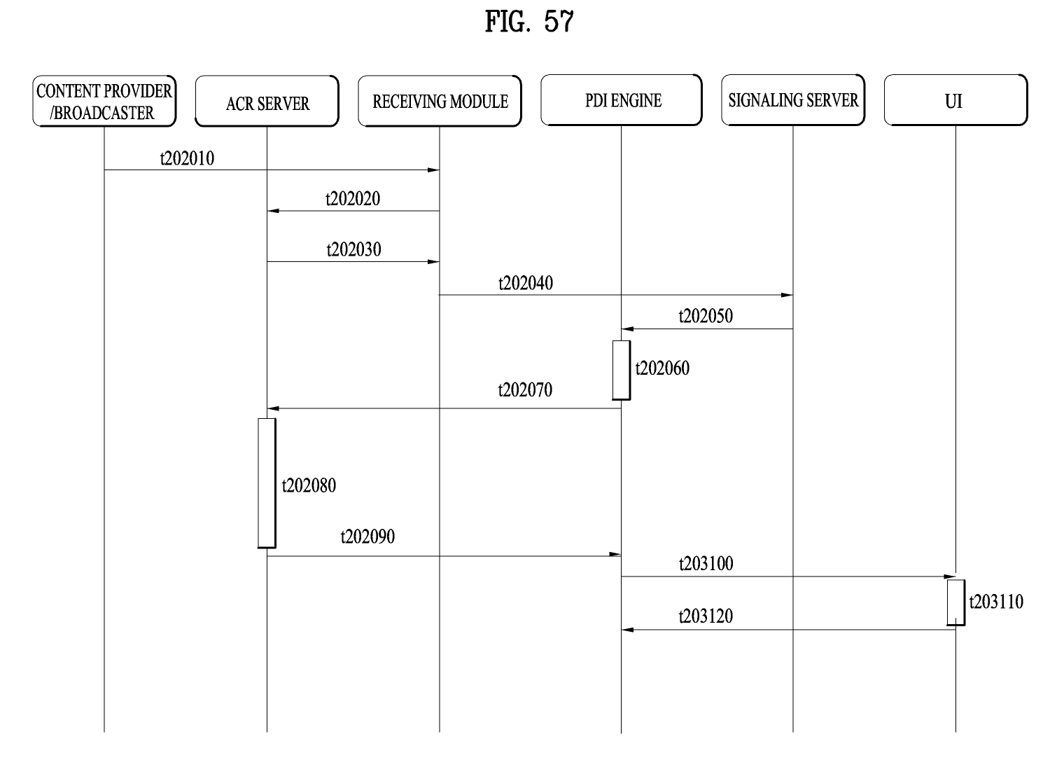

Then, the filtering engine 702 may match and compare the filtering criteria and the PDI data and filter and download the content using the comparison result. The downloaded content may be stored in the content store 704. A filtering method and the filtering criteria will be described in detail with reference to FIGS. 57 and 58.

According to an embodiment of the present invention, the UI module 706 may display the PDI received from the PDI engine 701 and receive the PDI answer to the corresponding PDI question from the user. The user may transmit the PDI answer to the displayed PDI question to the receiver 700 using a remote controller. The UI module 706 may transmit the received PDI answer to the PDI engine 701.

The declarative content module 705 according to the present embodiment may access the PDI engine 701 to acquire PDI data. In addition, as illustrated in FIG. 9, the declarative content module 705 may receive declarative content provided by the content provider 707. According to an embodiment of the present invention, the declarative content may be content related to application executed by the receiver 700 and may include a declarative object (DO) such as a triggered declarative object (TDO).

Although not illustrated in FIG. 9, the declarative content module 705 according to the present embodiment may access the PDI store 703 to acquire the PDI question and/or the PDI answer. In this case, the declarative content module 705 may use an application programming interface (API). In detail, the declarative content module 705 may retrieve the PDI store 703 using the API to acquire at least one PDI question. Then, the declarative content module 705 may transmit the PDI question, receive the PDI answer, and transmit the received PDI answer to the PDI store 703 through the UI module 706.

The PDI store 703 according to the present embodiment may store the PDI question and/or the PDI answer.

The content store 704 according to the present embodiment may store the filtered content.

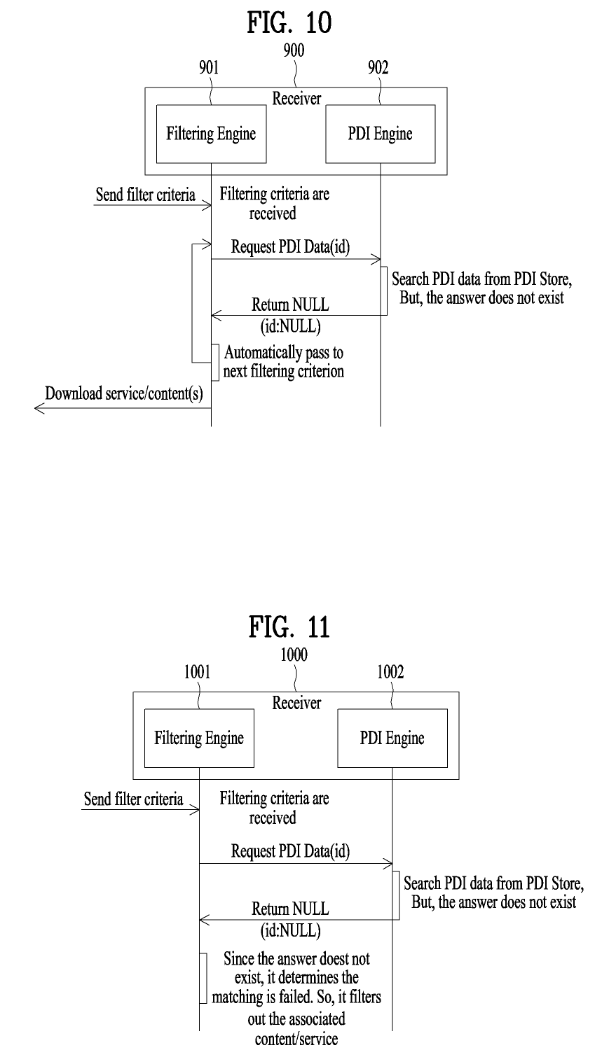

As described above, the PDI engine 701 illustrated in FIG. 9 may receive the PDI questionnaire from the content provider 707. The receiver 700 may display PDI questions of the PDI questionnaire received through the UI module 706 and receive the PDI answer to the corresponding PDI question from the user. The PDI engine 701 may transmit PDI data containing the PDI question and/or the PDI answer to the filtering engine 702. The filtering engine 702 may filter content through the PDI data and the filtering criteria. Thus, the receiver 700 may provide the filtered content to the user to embody the personalization service. FIG. 10 is a flowchart of a digital broadcast system according to another embodiment of the present invention.

In detail, FIG. 10 is a flowchart of operations of a filtering engine and a PDI engine of the personalization broadcast system described with reference to FIG. 9.

As illustrated in FIG. 10, a receiver 900 according to the present embodiment may include a filtering engine 901 and/or a PDI engine 902. Hereinafter, operations of the filtering engine 901 and the PDI engine 902 according to the present embodiment will be described. The structure of the aforementioned receiver may be changed according to a designer's intention.

As described with reference to FIG. 9, in order to filter content, the receiver 900 according to the present embodiment may match and compare filtering criteria and PDI data.

In detail, the filtering engine 901 according to the present embodiment may receive filtering criteria from a content provider and transmit a signal (or a PDI data request signal) for requesting PDI data to the PDI engine 902. The PDI engine 902 according to the present embodiment may search for PDI data corresponding to the corresponding PDI data request signal according to the transmitted PDI data request signal.

The filtering engine 901 illustrated in FIG. 10 may transmit the PDI data request signal including a criteria ID (identifier) to the PDI engine 902. As described above, the filtering criteria may be a set of filtering criterias, each of which may include a criteria ID for identifying the filtering criterias. In addition, according to an embodiment of the present invention, a criteria ID may be used to identify a PDI question and/or a PDI answer.

The PDI engine 902 that has received the PDI data request signal may access a PDI store to search for the PDI data. According to an embodiment of the present invention, the PDI data may include a PDI data ID for identifying a PDI question and/or a PDI answer. The PDI engine 902 illustrated in FIG. 10 may match and compare whether the criteria ID and PDI data ID in order to determine whether the criteria ID and the PDI data ID are identical to each other.

As the matching result, when the criteria ID and the PDI data ID are identical to each other and values thereof are identical to each other, the receiver 900 may download corresponding content. In detail, the filtering engine 901 according to the present embodiment may transmit a download request signal for downloading content to the content provider.

As the matching result, when the criteria ID and the PDI data ID are not identical to each other, the PDI engine 902 may transmit a null ID (identifier) to the filtering engine 901, as illustrated in FIG. 10. The filtering engine 901 that has received the null ID may transmit a new PDI data request signal to the PDI engine 902. In this case, the new PDI data request signal may include a new criteria ID.

The receiver 900 according to the present embodiment may match all filtering criterias contained in the filtering criteria with the PDI data using the aforementioned method. As the matching result, when the all filtering criterias are matched with the PDI data, the filtering engine 901 may transmit the download request signal for downloading contents to the content provider.

FIG. 11 is a flowchart of a digital broadcast system according to another embodiment of the present invention.

In detail, FIG. 11 is a flowchart of operations of a filtering engine and a PDI engine of the personalization broadcast system described with reference to FIG. 9.

As illustrated in FIG. 11, a receiver 1000 according to the present embodiment may include a filtering engine 1001 and/or a PDI engine 1002. The structure of the aforementioned receiver may be changed according to a designer's intention. Basic operations of the filtering engine 1001 and the PDI engine 1002 illustrated in FIG. 11 are the same as the operations described with reference to FIG. 10.

However, as the matching result of the filtering criteria and the PDI data, when the criteria ID is not identical to the PDI data ID, the receiver 1000 illustrated in FIG. 11 may not download corresponding content, according to an embodiment of the present invention.

In detail, when the filtering engine 1001 according to the present embodiment receives a null ID, a new PDI data request signal may not be transmitted to the PDI engine 1002, according to an embodiment of the present invention. In addition, when all the filtering criterias contained in the filtering criteria are not matched with the PDI data, the filtering engine 1001 according to the present embodiment may not transmit the download request signal to the content provider, according to an embodiment of the present invention.

FIG. 12 is a diagram illustrating a PDI Table according to an embodiment of the present invention.

The personalization broadcast system described with reference to FIG. 9 may use PDI data in order to provide a personalization service and process the PDI data in the form of PDI Table. The data structure that encapsulates the questionnaire and the answers given by a particular user is called a PDI questionnaire or a PDI Table. A PDI Table, as provided by a network, broadcaster or content provider, includes no answer data, although the data structure accommodates the answers once they are available. The question portion of an entry in a PDI Table is informally called a “PDI question” or “PDI-Q.” The answer to a given PDI question is referred to informally as a “PDI-A.” A set of filtering criteria is informally called a “PDI-FC”. According to an embodiment of the present invention, the PDI table may be represented in XML schema. A format of the PDI table according to the present embodiment may be changed according to a designer's intention.

As illustrated in FIG. 12, the PDI table according to the present embodiment may include attributes 1110 and/or PDI type elements. The attributes 1110 according to the present embodiment may include a transactional attribute 1100 and a time attribute 1101. The PDI type elements according to the present embodiment may include question with integer answer (QIA) elements 1102, question with Boolean answer (QBA) elements 1102, question with selection answer (QSA) elements 1104, question with text answer (QTA) elements 1105, and/or question with any-format answer (QAA) elements 1106. Hereinafter, elements of the PDI table illustrated in FIG. 12 will be described.

In detail, the attributes 1110 illustrated in FIG. 12 may indicate information of attributes of the PDI table according to the present embodiment. Thus, even if the PDI type elements included in the PDI table are changed, the attributes 1110 may not be changed in the PDI table according to the present embodiment. For example, the transactional attribute 1100 according to the present embodiment may indicate information regarding an objective of a PDI question. The time attribute 1101 according to the present embodiment may indicate information regarding time when the PDI table is generated or updated. In this case, even if PDI type elements are changed, PDI tables including different PDI type elements may include the transactional attribute 1100 and/or the time attribute 1101.

The PDI table according to the present embodiment may include one or two or more PDI type elements 1102 as root elements. In this case, the PDI type elements 1102 may be represented in a list form.

The PDI type elements according to the present embodiment may be classified according to a type of PDI answer. For example, the PDI type elements according to the present embodiment may be referred to as “QxA” elements. In this case, “x” may be determined according to a type of PDI answer. The type of the PDI answer according to an embodiment of the present invention may include an integer type, a Boolean type, a selection type, a text type, and any type of answers other than the aforementioned four types.

QIA elements 1103 according to an embodiment of the present invention may include an integer type of PDI answer to one PDI question and/or corresponding PDI question.

QBA elements 1104 according to an embodiment of the present invention may include a Boolean type of PDI answer to one PDI question and/or corresponding PDI question.

QSA elements 1105 according to an embodiment of the present invention may include a multiple selection type of PDI answer to one PDI question and/or corresponding PDI question.

QTA elements 1106 according to an embodiment of the present invention may include a text type of PDI answer to one PDI question and/or corresponding PDI question.

QAA elements 1107 according to an embodiment of the present invention may include a predetermined type of PDI answer, other than integer, Boolean, multiple-selection, and text types, to one PDI question and/or corresponding PDI question.

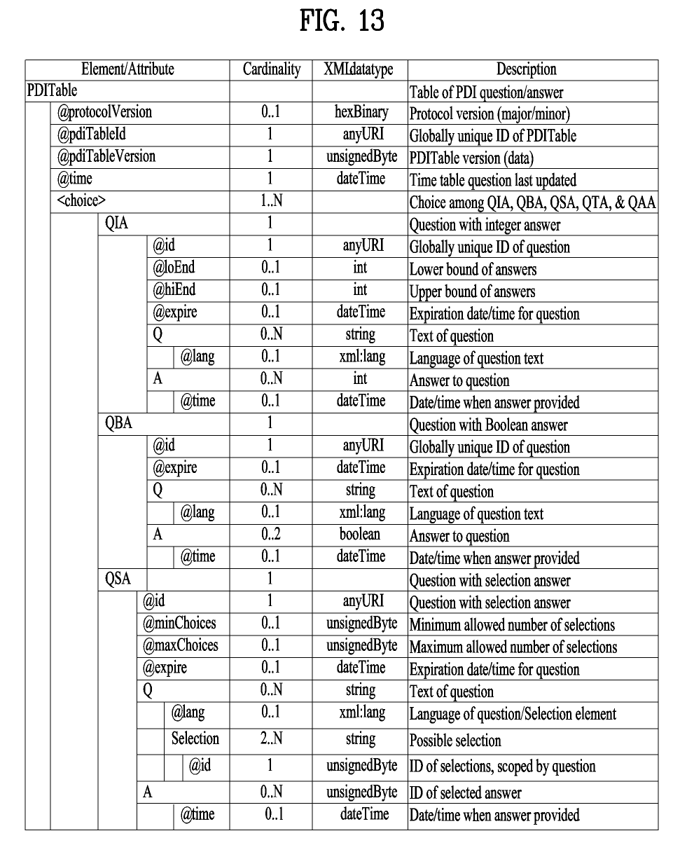

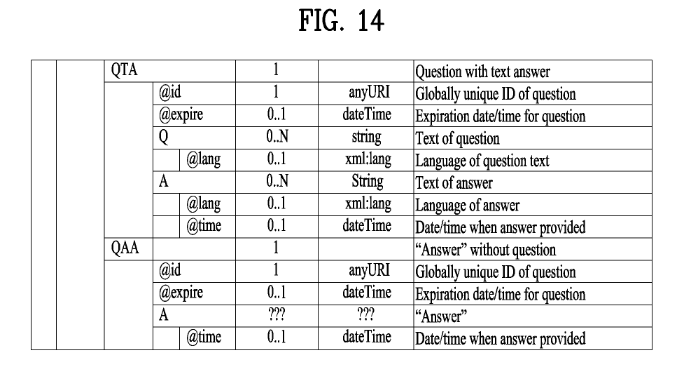

FIGS. 13 and 14 are diagrams illustrating a PDI table according to another embodiment of the present invention.

Specifically, FIGS. 13 and 14 are diagrams illustrating an embodiment of a PDI table according to the XML schema described with reference to FIG. 12.

FIGS. 13 and 14 show definition of XML schema for a root element called the PDI table that defines the structure of a PDI table instance document. The PDI table instance document according to an embodiment of the present invention indicates an actual document that implements the PDI table according to the XML schema.

FIGS. 13 and 14 also represent definition of XML schema for a root element QIA, QBA, QSA, QTA, or QAA indicating an individual question capable of being exchanged between a DO and an included receiver using a PDI API. Details of the PDI API according to an embodiment of the present invention will be described later. The elements represented in FIGS. 13 and 14 may conform to definition of XML schema, a namespace of which is “http://www.atsc.org/XMLSchemas/iss/pdi/I”.

The difference between a PDI question (or PDI-Q) and a PDI answer (or PDI-A) is specified in a usage rule rather than in the schema itself. A question part of an entry in the PDI table is non-officially called “PDI question” or “PDI-Q”. An answer to a given PDI question is unofficially called “PDI-A”. For example, schema indicates minOccurs=“0” for “q” element of various types of questions. If the schema is used for PDI-Q, use of the “q” element in that case is mandatory. If the schema is used for PDI-A, inclusion of the “q” element is optional.

A PDI-Q instance document may conform to the “PDI table” XML schema, which is part of the ATSC 2.0 standard, together with a namespace and definition thereof may take precedence over the description provided herein in the event of any difference. The PDI-Q instance document according to an embodiment of the present invention indicates an actual document that implements a PDI table including PDI-Q according to the XML schema.

The PDI-Q instance document consists of one or more elements of type QIA (integer-answer type question), QBA (Boolean-answer type question), QSA (selection-type question), and/or QTA (textual-answer type question).

No “A” (answer) child element of theses top-level elements may be present in a PDI-Q instance.

An identifier attribute (“id”) in each of these elements may serve as a reference or linkage to a corresponding element in a PDI-A instance document. The PDI-A instance document according to an embodiment of the present invention indicates an actual document that implements a PDI table including PDI-A according to the XML schema.

The PDI-A instance document may conform to “PDI table” XML schema, which is part of ATSC 2.0 standard, together with a namespace thereof and definition thereof may take precedence over the description provided herein in the event of any difference.

The PDI-A instance document consists of one or more elements of type QIA (integer-answer type question), QBA (Boolean-answer type question), QSA (selection-type answer question), QTA (textual-answer type question), and/or QAA (any-format answer type question).

Each of these elements has at least one “A” (answer) child element. The elements may or may not include any “Q” (question string) child element.

An identifier attribute (“id”) in each of these elements may serve as a reference to linkage to a corresponding element in the PDI-Q instance document.

Hereinafter, semantics of elements and attributes included in the PDI table of FIGS. 13 and 14 will be described.

As illustrated in FIGS. 13 and 14, in the PDI table according to an embodiment of the present invention, “@” is indicated in front of the name of an attribute to distinguish between an attribute and an element.

The PDI table according to an embodiment of the present invention may include a PDI type element. Specifically, the PDI type element may include a QIA element, a QBA element, a QSA element, a QTA element, and/or a QAA element as described with reference to FIG. 12.

In addition, as illustrated in FIGS. 13 and 14, the PDI table according to an embodiment of the present invention question may include a protocolVersion attribute, a pdiTableId attribute, a pdiTableVersion attribute, and/or a time attribute, regardless of a question type element.

All “id” attributes of the QIA, QBA, QSA, QTA, and QAA elements have the same semantics, like “expire” attributes of these elements. Similarly, “lang” attributes of Q elements have the same semantics, like “time” attributes of A elements. In addition, the “id” attributes may mean the PDI data identifier described with reference to FIG. 10.

A PDITable element includes the list of one or more question elements. Each question element is in the format of QIA, QBA, QSA, QTA, or QAA. The use of <choice> constructed with cardinality 0 . . . N means that any number of QIA, QBA, QSA, QTA and QAA elements may appear in any order.

The protocolVersion attribute of the PDITable element consists of two hexadecimal digits. Four high-order bits indicate a major version number of table definition. Four low-order bits indicate a minor version number of the table definition. The major version number for this version of this standard is set to 1. Receivers are expected to discard instances of a PDI indicating major version values that they are not prepared to support. The minor version number for this version of the standard is set to 0. Receivers are expected not to discard instances of the PDI indicating minor version values that they are not prepared to support. In this case, receivers are expected to ignore any individual elements or attributes that they do not support.

The pdiTableId attribute of the PDITable element may be a globally unique identifier of this PDI table.

The pdiTableVersion attribute of the PDITable element indicates the version of this PDI table. An initial value may be 0. The value may be incremented by 1 each time this PDI table changes, with rollover to 0 after 255.

The time attribute of the PDITable element indicates date and time of the most recent change to any question in this PDI table.

The QIA element represents an integer-answer type of a question. The QIA element includes optional limits specifying maximum and minimum allowed values of an answer.

A QIA.loEnd attribute of QIA indicates a minimum possible value of an “A” child element of the QIA element. That is, the value of the “A” element is not less than loEnd. If the loEnd attribute is not present, this indicates that there is no minimum value.

A QIA.hiEnd attribute of QIA indicates a maximum possible value of the “A” child element of the QIA element. That is, the value of an answer is not greater than hiEnd. If the hiEnd attribute is not present, this indicates that there is no a maximum value.

A QIA.Q element is a child element of the QIA element and represents a question string to be presented to users. A question should be formulated to have an integer-type answer. There may be multiple instances of this element in different languages.

A QIA.A element is a child element of the QIA element and may have an integer value. The QIA. A element represents an answer to a question in QIA.Q.

The QBA element may represent a Boolean-answer type of question.

A QBA.Q element is a child element of the QBA element. The value of the QBA.Q element may represent a question string to be presented to users. A question should be formulated to have a yes/no or true/false type of answer. There may be multiple instances of this element in different languages.

A QBA.A element is a child element of the QBA element and may have a Boolean value. The QBA.A element may represent an answer to a question in QBA.Q.

The QSA element represents a selection-answer type of question.

A QSA.minChoices attribute of the QSA element may specify a minimum number of selections that can be made by a user.

A QSA.maxChoices attribute of the QSA element may specify a maximum number of selections that can be made by a user.

A QSA.Q element is a child element of the QSA element. The value of the QSA.Q element may represent a question string to be presented to users. A question should be formulated to have an answer that corresponds to one or more provided selection choices.

A QSA.Q.Selection element is a child element of the QSA.Q element and the value of the QSA.Q.Selection element may represent a possible selection to be presented to users. If there are multiple QSA.Q child elements of the same QSA element (in different languages), each of the elements has the same number of Selection child elements with the same meanings.

A QSA.Q.Selection.id attribute of QSA.Q Selection may be an identifier for a Selection element which is unique within the scope of QSA.Q. If there are multiple QSA.Q child elements of the same QSA element (in different languages), there is a one-to-one correspondence between id attributes of Selection elements, with corresponding Selection elements having the same meaning.

A QSA.A element is a child element of the QSA element. Each instance of the child element of the QSA element may specify one allowed answer to this selection-type question in the form of an id value of one of the Selection elements.

The QTA element represents a textual-answer (free-form entry) type of question.

A QTA.Q element is a child element of the QTA element. The value of the QTA.Q element may represent a question string to be presented to users. A question should be formulated to have a free-form text answer.

A QTA.A element is a child element of the QTA element. The value of the QTA.A element may represent an answer to a question in QTA.Q.

The QAA element may be used to hold various types of information, like an entry in a database.

A QAA.A element is a child element of the QAA element. The value of the QAA.A element contains some type of information.

The id attributes of the QIA, QBA, QSA, QTA, and QAA elements may be a URI which is a globally unique identifier for an element in which each id attribute appears.

The expire attributes of the QIA, QBA, QSA, QTA, and QAA elements may indicate a date and time deleted from the table because an element in which each expire attribute appears is no longer relevant.

The lang attributes of the QIA.Q, QBA.Q, QSA.Q, QTA.Q, and QTA.A elements may indicate the language of a question or answer string. In the case of QSA.Q, the lang attribute may also indicate the language of a Selection child element of QSA.Q. If the lang attribute is not present, this may indicate that the language is English.

The time attributes of the QIA.A, QBA.A, QSA.A, QTA.A, and QAA.A elements may indicate date and time that an answer is entered into the table.

Although not illustrated in FIGS. 13 and 14, the PDI table according to an embodiment of the present invention may further include a QIAD element, a QBAD element, a QSAD element, a QTAD element, and/or a QAAD element. These elements are collectively called a QxAD element. Hereinafter, the QxAD element will be described.

The QIAD element as a root element may include an integer-answer type of question in a child element of QIA. The QIA element may include optional limits specifying maximum and minimum allowed values of an answer.

The QBAD element as the root element may represent a Boolean-answer type of question.

The QSAD element as the root element may represent a selection-answer type of question.

The QTAD element as the root element may represent a text-answer (free-form entry) type of question.

The QAAD element as the root element may be used to hold various types of information, like an entry in a database.

In addition, although not illustrated in FIGS. 13 and 14, the PDI type element according to an embodiment of the present invention may further include a QText element and/or a time attribute.

A QIA.Q.QText element is a child element of the QIA.Q element. The value of the. QIA.Q.QText element may represent a question string to be presented to users. A question should be formulated to have an integer-type answer.

A QIA.A.answer attribute is an integer value attribute of the QIA.A element. The QIA.A.answer attribute may represent an answer to a question in the QIA.Q.QText element.

A QBA.Q.Qtext element is a child element of the QBA.Q element. The value of the QBA.Q.Qtext element may represent a question string to be presented to users. A question should be formulated to have a yes/no or true/false type of answer. There may be multiple instances of this element in different languages.

A QBA.A.answer attribute is a Boolean value attribute of the QBA.A element. A QBA.A@answer attribute may represent an answer to a question in the QBA.Q.QText element.

A QSA.Q.QText element is a child element of the QSA.Q element. The QSA.Q.QText element may represent a question string to be presented to users. A question should be formulated to have an answer that corresponds to one or more of provided selection choices. There may be multiple instances of this element in different languages.

A QSA.A.answer attribute of a child element of QSA.A may specify one allowed answer to this selection-type question in the form of an id value of one of the Selection elements.

A QTA.Q.QText element is a child element of the QTA element. The value of the QTA.Q.QText element may represent a question string to be presented to users. A question should be formulated to have a free-form text answer.

A QTA.A.answer attribute is a child element of the QTA element. The value of the QTA.A.answer element represents an answer to a question in the QTA.Q.QText element.

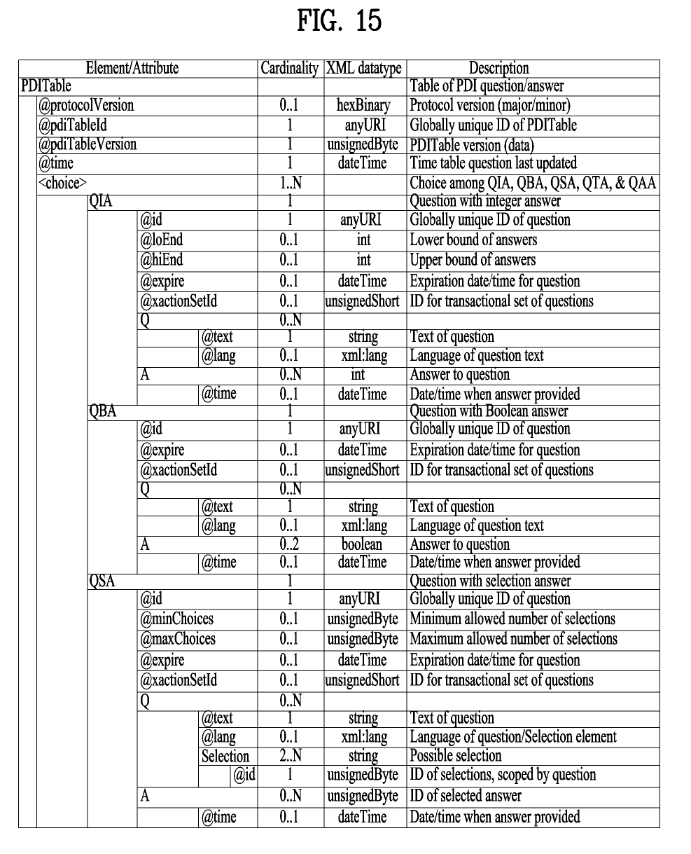

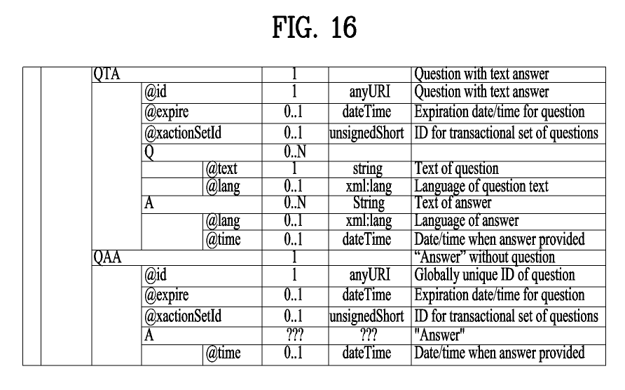

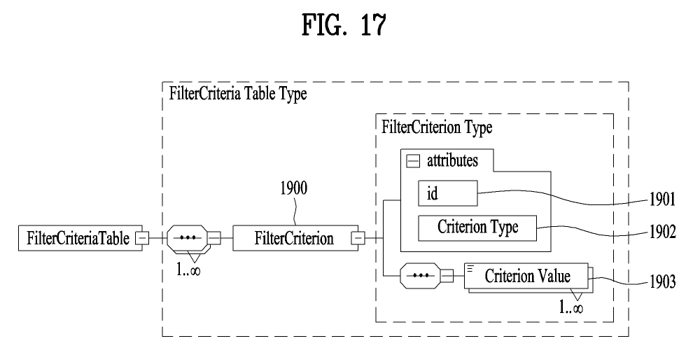

FIGS. 15 and 16 are diagrams illustrating a PDI table according to another embodiment of the present invention.

Specifically, FIGS. 15 and 16 are diagrams illustrating the structure of a PDI table according to the XML schema described with reference to FIG. 12.

A basic structure of the PDI table illustrated in FIGS. 15 and 16 and semantics of basic elements and attributes included in the PDI table are as described with reference to FIGS. 13 and 14. Notably, unlike the PDI table illustrated in FIGS. 13 and 14, the PDI table illustrated in FIGS. 15 and 16 may further include an xactionSetId attribute and/or a text attribute. Hereinafter, a description will be given focusing on the xactionSetId attribute and/or the text attribute.

The xactionSetId attribute of the QxA element indicates that a question belongs to a transactional set of questions, which is a set to be treated as a unit for the purpose of answering the questions. The xactionSetId attribute also provides an identifier for a transactional set to which a question belongs. Thus, the set of all questions in a PDI table that have the same value of the xactionSetId attribute is answered on an “all or nothing” basis.

The text attribute of the QxA element is a child element of the QxA.Q element. The value of the text attribute may represent a question string to be presented to users.

FIG. 17 is a diagram illustrating a filtering criteria table according to an embodiment of the present invention. The aforementioned personalization broadcast system of FIG. 9 may use filtering criteria in order to provide a personalization service. The filtering criteria described with reference to FIGS. 9, 10, and 11 may be processed in the form of filtering criteria table. According to an embodiment of the present invention, the filtering criteria table may be represented in the form of XML Schema.

According to an embodiment of the present invention, the filtering criteria table may have a similar format to a format of the PDI table in order to effectively compare the PDI data and the filtering criteria. The format of the filtering criteria table according to the present embodiment may be changed according to a designer's intention.

As illustrated in FIG. 17, the filtering criteria table according to the present embodiment may include a filtering criteria element 1900. The filtering criteria element 1900 may include identifier attribute 1901, criteria type attribute 1902, and/or a criteria value element 1903. The filtering criteria according to the present embodiment may be interpreted as corresponding to the aforementioned PDI question. Hereinafter, elements of the filtering criteria table illustrated in FIG. 17 will be described.

The filtering criteria element 1900 according to the present embodiment may indicate filtering criteria corresponding to the PDI question.

The identifier attribute 1901 according to the present embodiment may identify a PDI question corresponding to the filtering criteria.

The criteria type attribute 1902 according to the present embodiment may indicate a type of the filtering criteria. The type of the filtering criteria will be described in detail.

The criteria value element 1903 according to the present embodiment may indicate a value of the filtering criteria. Each criteria value is a possible answer to the PDI question.

In detail, the type of the filtering criteria according to the present invention may be one of an integer type, a Boolean type, a selection type, a text type, and/or any type.

The filtering criteria of the integer type (or integer type criteria) refers to filtering criteria corresponding to a PDI answer of the integer type.

The filtering criteria of the Boolean type (or Boolean type criteria) refers to filtering criteria corresponding to a PDI answer of the Boolean type.

The filtering criteria of the selection type (or selection type criteria) refers to filtering criteria corresponding to a PDI answer of the selection type.

The filtering criteria of the text type (or text type criteria) refers to filtering criteria corresponding to a PDI answer of the text type.

The filtering criteria of any type (or any type criteria) refers to filtering criteria corresponding to a PDI answer of any type.

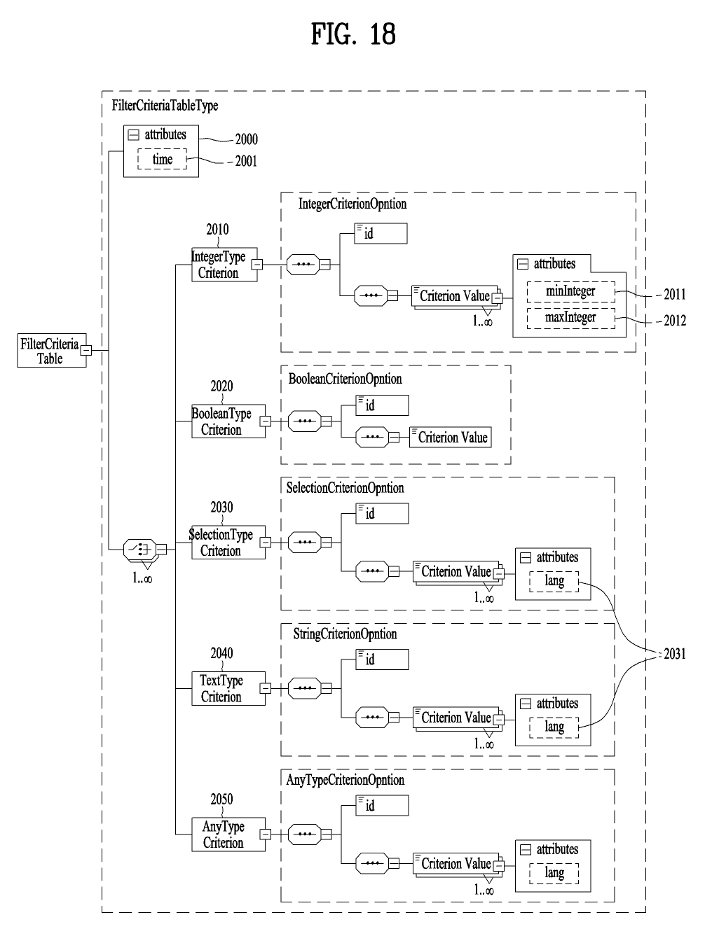

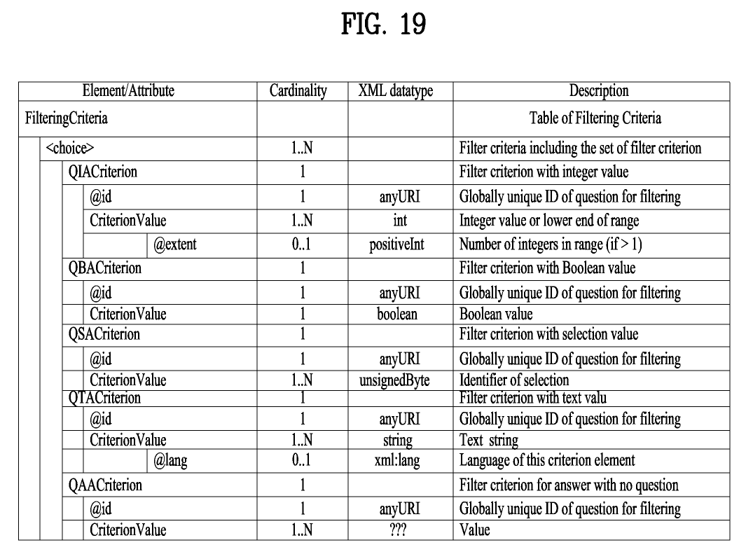

FIG. 18 is a diagram illustrating a filtering criteria table according to another embodiment of the present invention.

In detail, FIG. 18 illustrates an extended format of a filtering criteria table in XML schema as the filtering criteria table described with reference to FIG. 17. When the filtering criteria table is configured in the XML schema of the filtering criteria illustrated in FIG. 17, a type of filtering criteria according to an embodiment of the present invention, and detailed attribute for each type thereof cannot be set. Thus, FIG. 18 illustrates a type of filtering criteria and proposes XML schema for setting attribute for each type. A personalization broadcast system according to an embodiment of the present invention may more precisely filter content using a filtering criteria table configured in the XML schema of FIG. 18.

As illustrated in FIG. 18, the filtering criteria table may include attributes 2000 and/or filtering criteria type elements. The attributes 2000 according to the present embodiment may include time attribute 2001. The filtering criteria type elements according to the present embodiment may include an integer type criteria element (or QIA criteria element) 2010, a Boolean type criteria element (or QBA criteria element) 2020, a selection type criteria element (or QSA criteria element) 2030, a text type criteria element (or QTA criteria element) 2040, and/or any type criteria element (or QAA criteria element) 2050. Hereinafter, elements of the filtering criteria table illustrated in FIG. 18 will be described.

In detail, the attributes 2000 illustrated in FIG. 12 may indicate information of attributes of the filtering criteria table according to the present embodiment. Thus, even if filtering criteria type elements included in the filtering criteria table are changed, the attributes 2000 may not be changed. For example, the time attribute 2001 according to the present embodiment may indicate time when the filtering criteria are generated or updated. In this case, filtering criteria tables including different filtering criteria type elements may include the time attribute 2001 even if the filtering criteria type elements are changed.

The filtering criteria table according to the present embodiment may include one or more or more filtering criteria type elements. The filtering criteria type elements according to the present embodiment may indicate a type of filtering criteria. The type of filtering criteria has been described with reference to FIG. 17. In this case, the filtering criteria type elements may be represented in a list form.

The filtering criteria type elements according to the present embodiment may also be referred to as “QxA” criteria. In this case, “x” may be determined according to a type of filtering criteria.

As illustrated in FIG. 18, each of the filtering criteria type elements may include an identifier attribute and/or a criteria value element. An identifier attribute and a criteria value element illustrated in FIG. 18 are the same as those described with reference to FIG. 17.

However, as illustrated in FIG. 18, an integer type criteria element 2010 may further include a min integer attribute 2011 and/or a max integer attribute 2012. The min integer attribute 2011 according to the present embodiment may indicate a minimum value of the filtering criteria represented as an integer type answer. The max integer attribute 2012 according to the present embodiment may indicate a maximum value of the filtering criteria represented as an integer type answer.

As illustrated in FIG. 18, a selection type criteria element 2030 and/or a text type criteria element 2040 may include lang attribute 2031. The lang attribute 2031 according to the present embodiment may indicate a value of the filtering criteria represented in a text type answer.

FIG. 19 is a diagram illustrating a filtering criteria table according to another embodiment of the present invention.

In detail, FIG. 19 illustrates a filtering criteria table in the XML schema described with reference to FIGS. 17 and 18. Basic elements of the filtering criteria table illustrated in FIG. 19 are the same as the elements described with reference to FIGS. 17 and 18. Hereinafter, semantics of the elements and attributes included in the filtering criteria table illustrated in FIG. 19 will be described.

As illustrated in FIG. 19, in the filtering criteria table according to the present embodiment, “@” may be indicated at the front of a name of attribute so as to distinguish between the attributes and the elements.

In each place where an @id attribute appears in the table, it shall be the @id attribute of a question in a PDI Table, thereby identifying the question that corresponds to the filtering criteria in which the @id attribute appears.

A QIA Criteria element shall represent a filtering criteria corresponding to a question with an integer value.

If a Criteria Value child element of a QIA Criteria element does not contain an a extent element, it shall represent an integer answer for the question corresponding to the filtering criteria. If a Criteria Value child element of a QIA Criteria element contains an @extent attribute, then it shall represent the lower end of a numeric range of answers for the question, and the @extent attribute shall represent the number of integers in the range.

A QBA Criteria element shall represent a filtering criteria corresponding to a question with a Boolean value.

A Criteria Value child element of a QBACriteria element shall represent a Boolean answer for the question corresponding to the filtering criteria.

A QSA Criteria element shall represent a filtering criteria corresponding to a question with selection value(s).

A Criteria Value child element of a QSA Criteria element shall represent the identifier of a selection answer for the question corresponding to the filtering criteria.

A QTA Criteria element shall represent a filtering criteria corresponding to a question with string value.

A Criteria Value child element of a QTA Criteria element shall represent a text answer for the question corresponding to the filtering criteria.

A QAA Criteria element shall represent a filtering criteria corresponding to a “question” that has only a text “answer” with no question.

A Criteria Value child element of a QAACriteria element shall represent a text “answer” for the “question” corresponding to the filtering criteria.

If there is only one Criteria Value element in the Filtering Criteria element, then the filtering decision for whether the service or content item passes the filter shall be “true” (yes) if the value of the Criteria Value element matches a value that is among the answers in the PDI-A for the question corresponding to the element containing the Criteria Value element (where the question is indicated by the id attribute of the element containing the Criteria Value element), and it shall be “false” (no) otherwise.

In the case of a Criteria Value child element of a QIA Criteria element in which the “extent” attribute is present, the value of the Criteria Value element shall be considered to match a value that is among the answers in the corresponding PDI-A if the value of the answer is in the interval defined by the Criteria Value and the extent attribute.

If the total number of Criteria Value elements in the Filtering Criteria element is greater than one, the result of each Criteria Value element shall be evaluated as an intermediate term, returning “true” if the Criteria Value matches a value that is among the answers in the PDI-A for the question corresponding to the filtering criteria (as indicated by the id value) and returning “false” otherwise. Among these intermediate terms, those with the same value of their parent element identifier (QIA.id, QBA.id, etc.) shall be logically ORed to obtain the interim result for each targeting criteria, and these interim results shall be logically ANDed together to determine the final result. If the final result evaluates to “true” for a receiver, it shall imply that the associated content item passes the filter.

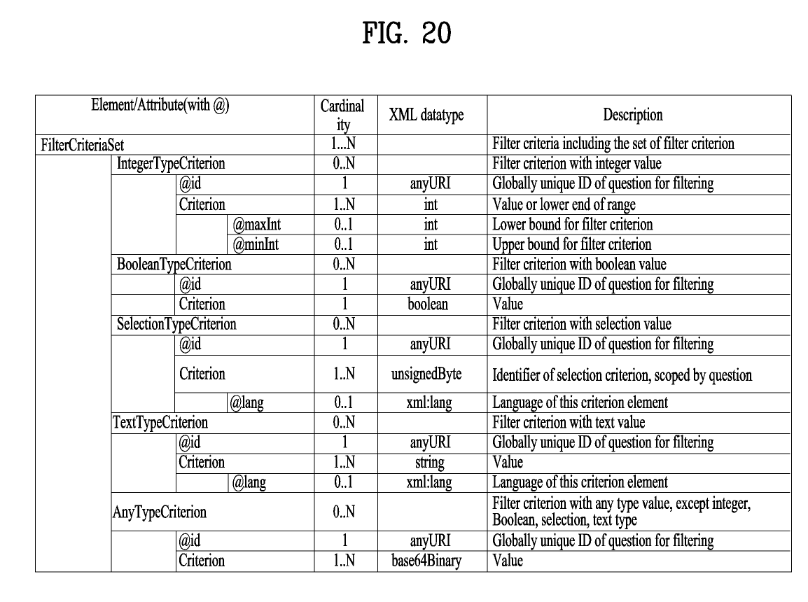

FIG. 20 is a diagram illustrating a filtering criteria table according to another embodiment of the present invention.

In detail, FIG. 20 illustrates an extended format of the filtering criteria table illustrated in FIG. 19. Basic elements of the filtering criteria table illustrated in FIG. 20 are the same as the elements described with reference to FIG. 19. Hereinafter, the filtering criteria table illustrated in FIG. 20 will be described in terms of differences from the filtering criteria table described with reference to FIG. 19.

The filtering criteria table illustrated in FIG. 20 allows multiple instances of the set of filtering criteria. Each set includes multiple instance of filtering criteria. Each filtering criteria allows multiple values to be provided for some of the filtering criteria. The filtering logic is “OR” logic among multiple instances of the set of filtering criteria. Within each set of filtering criteria, the filtering logic is “OR” logic among multiple values for the same filtering criteria, and “AND” logic among different filtering criteria.

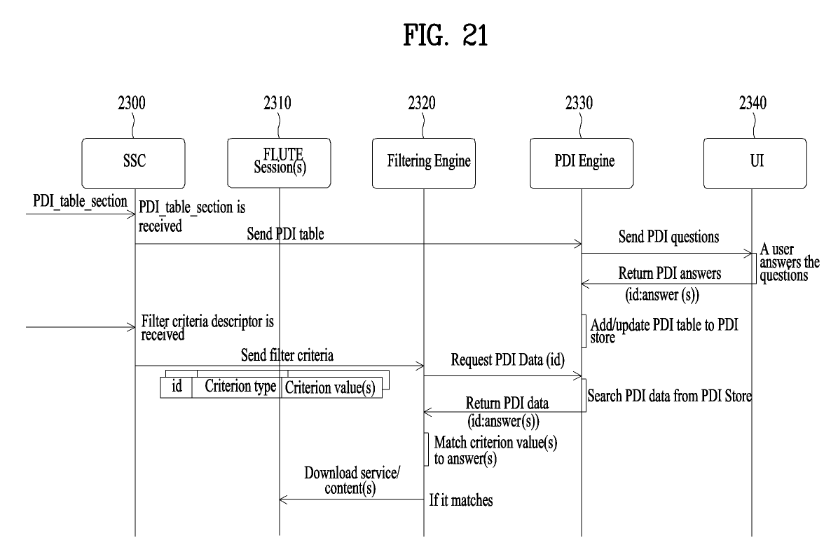

FIG. 21 is a flowchart of a digital broadcast system according to another embodiment of the present invention.

In detail, FIG. 21 is a flowchart of a personalization broadcast system that allows a receiver according to the embodiment of the present invention to receive a PDI table and/or a filtering criteria table via a broadcast network.

The basic structure of the personalization broadcast system according to the present embodiment is the same as the structure described with reference to FIGS. 9 through 11. The PDI table according to the present embodiment is the same as the table described with reference to FIGS. 10 through 16. The filtering criteria table according to the present embodiment is the same as the table described with reference to FIGS. 17 through 20.

As illustrated in FIG. 21, the personalization broadcast system according to the present embodiment may include a service signaling channel (SSC) 2300, a file delivery over unidirectional transport (FLUTE) session 2310, a filtering engine 2320, a PDI engine 2330, and/or a UI 2340. The receiver according to the present embodiment may receive a PDI table through a digital storage media command and control (DSM-CC) section. In this case, the receiver according to the present embodiment may receive the PDI table through the FLUTE session 2310. The structure of the aforementioned personalization broadcast system may be changed according to a designer's intention. Hereinafter, operations of elements of FIG. 21 will be described.

First, the receiver according to the present embodiment may receive the PDI table section through the SSC 2300. In detail, the receiver according to the present embodiment may parse IP datagram corresponding to the SSC 2300 among IP datagram received through the DSM-CC section to receive the PDI table section. In this case, the receiver according to the present embodiment may receive the PDI table section using a well-known IP address and/or UDP port number included in the SSC 2300. The PDI table section according to the present embodiment refers to a table obtained by compressing a PDI table according to an embodiment of the present invention in order to transmit the PDI table via a broadcast network. The PDI table section will be described in detail.

The receiver according to the present embodiment may parse the PDI table section received through the SSC 2300 to acquire the PDI table. Then, the receiver according to the present embodiment may transmit the PDI table to the PDI engine 2330.

The PDI engine 2330 according to the present embodiment may process the received PDI table and extract PDI questions included in a corresponding PDI table. Then, the PDI engine 2330 according to the present embodiment may transmit the extracted PDI questions to the UI 2340.

The UI 2340 according to the present embodiment may display the received PDI questions and receive PDI answers to the corresponding PDI questions. In this case, the UI 2340 according to the present embodiment may receive the PDI answers through a remote controller. Then, the PDI engine 2330 according to the present embodiment may update PDI data using the PDI answer received from the UI 2340. A detailed description thereof has been described with reference to FIG. 9.

The receiver according to the present embodiment may receive a service map table (SMT) and/or a non real time information table (NRT-IT) through the SSC 2300. The SMT according to the present embodiment may include signaling information for a personalization service. The NRT-IT according to the present embodiment may include announcement information for a personalization service.

Then, the receiver according to the present embodiment may parse the received SMT and/or NRT-IT to acquire a filtering criteria descriptor. The receiver may transmit filtering criteria to the filtering engine 2320 using the filtering criteria descriptor. In this case, according to an embodiment of the present invention the filtering criteria may be a filtering criteria table with a format of xml document. The filtering criteria table has been described in detail with reference to FIGS. 19 and 20. Then, the filtering engine 2320 according to the present embodiment may transmit a PDI data request signal to the PDI engine 2330. When the PDI engine 2330 according to the present embodiment receives the PDI data request signal, the PDI engine 2330 may search for PDI data corresponding to the corresponding PDI data request signal and transmit the PDI data to the filtering engine 2320. As a result, the receiver according to the present embodiment may download content using a filtering result. Processes subsequent to the filtering according to the present embodiment have been described in detail with reference to FIGS. 10 and 11

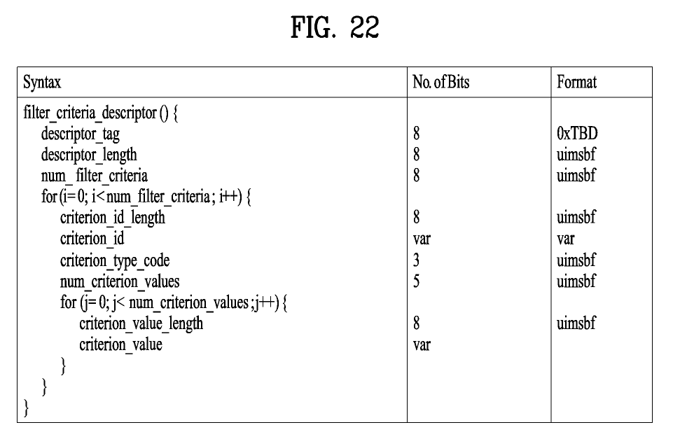

FIG. 22 is a diagram illustrating filtering criteria descriptor syntax according to an embodiment of the present invention.

In detail, FIG. 22 illustrates the bit stream syntax of the Filtering Criteria Descriptor for receiving a filtering criteria table by a receiver according to the embodiment of the present invention, in the personalization broadcast system described with reference to FIG. 21.

Filtering criteria according to an embodiment of the present invention are associated with downloadable content, so that the receiver according to the present embodiment can decide whether or not to download the content. There are two categories of downloadable content in an ATSC 2.0 environment: Non-Real Time (NRT) content in stand-alone NRT services and NRT content items used by TDOs in adjunct interactive data services.

Hereinafter, filtering criteria for filtering NRT content in stand-alone NRT services will be described with reference to FIG. 22.

In a filtering Criteria for NRT Services and Content Items according to the embodiment of the present invention, one or more instances of the Filtering Criteria Descriptor defined below can be included in a service level descriptor loop in an SMT, to allow receivers to determine whether to offer the NRT service to the user or not, or it can be included in a content item level descriptor loop in a NRT-IT, to allow receivers to determine whether to download that particular content item and make it available to the user or not.

The one or more instances of the Filtering Criteria Descriptor allow multiple values to be provided for the same or different targeting criteria. The intended targeting logic is “OR” logic among multiple values for the same targeting criteria, and “AND” logic among different targeting criteria.

Hereinafter, semantic definition of each field of the bit stream syntax of the Filtering Criteria Descriptor illustrated in FIG. 22 will be described.

A descriptor_tag field, a 8-bit field can be set to 0xTBD to indicate that the descriptor is a Filtering Criteria Descriptor according to the embodiment of the present invention.

A descriptor_length field, a 8-bit unsigned integer field can indicate the number of bytes following the descriptor_length field itself.

A num_filter_criteria field, a 8-bit field can indicate the number of filtering criteria contained in this descriptor shown in FIG. 22.

A criteria_id_length field, a 8-bit field can indicate the length of the criteria_id field.

A criteria_id field, a variable length field can give the identifier of this filtering criteria, in the form of a URI matching the id attribute of a question (QIA, QBA, QSA, QTA, or QAA element) in the PDI Table of the virtual channel in which this descriptor appears.

A criteria_type_code field, a 3-bit field can give the type of this criteria (question), according to Table below.

TABLE 35

| criteria_type_code | Value |
|---|---|
| 0x00 | Reserved |
| 0x01 | Integer type(including selection id), in uimsbf |
| | format |
| 0x02 | Boolean type, 0x01 for “true” and 0x00 for “false” |
| 0x03 | String type |
| 0x04-0x07 | Reserved for future ATSC use |

A num_criteria_values field, a 5-bit field gives the number of targeting criteria values in this loop for this filtering criteria, where each value is a possible answer to the question (QIA, QBA, QSA, QTA, or QAA) identified by the criteria_id.

A criteria_value_length field, a 8-bit field gives the number of bytes needed to represent this targeting criteria value.

A criteria_value field, a variable length field gives this targeting criteria value.

The Filtering Criteria Descriptor according to the embodiment of the present invention indicates values for certain targeting criteria associated with services or content items. In an ATSC 2.0 emission, one or more instances of the filtering_criteria_descriptor( ) defined above may go in the descriptor loop of an NRT service in an SMT or in the descriptor loop of a content item in an NRT-IT. In the former case, they shall apply to the service itself (all content items). In the latter case they shall apply to the individual content item.

If there is only one Filtering Criteria Descriptor in a descriptor loop, and if it has only one criteria value, then the decision for whether the service or content item passes the filter shall be “true” (yes) if the criteria value matches a value that is among the answers in the PDI-A for the question corresponding to the filtering criteria (as indicated by the criteria_id), and it shall be “false” (no) otherwise.

If the total number of criteria values in all Filtering Criteria Descriptors in a single descriptor loop is greater than one, the result of each criteria value shall be evaluated as an intermediate term, returning “true” if the criteria value matches a value that is among the answers in the PDI-A for the question corresponding to the filtering criteria (as indicated by the criteria_id) and returning “false” otherwise. Among these intermediate terms, those with the same value of filtering criteria (as determined by the criteria_id) shall be logically ORed to obtain the interim result for each targeting criteria, and these interim results shall be logically ANDed together to determine the final result. If the final result evaluates to “true” for a receiver, it shall imply that the associated NRT service or content item passes the filter and is available to be downloaded to the receiver.

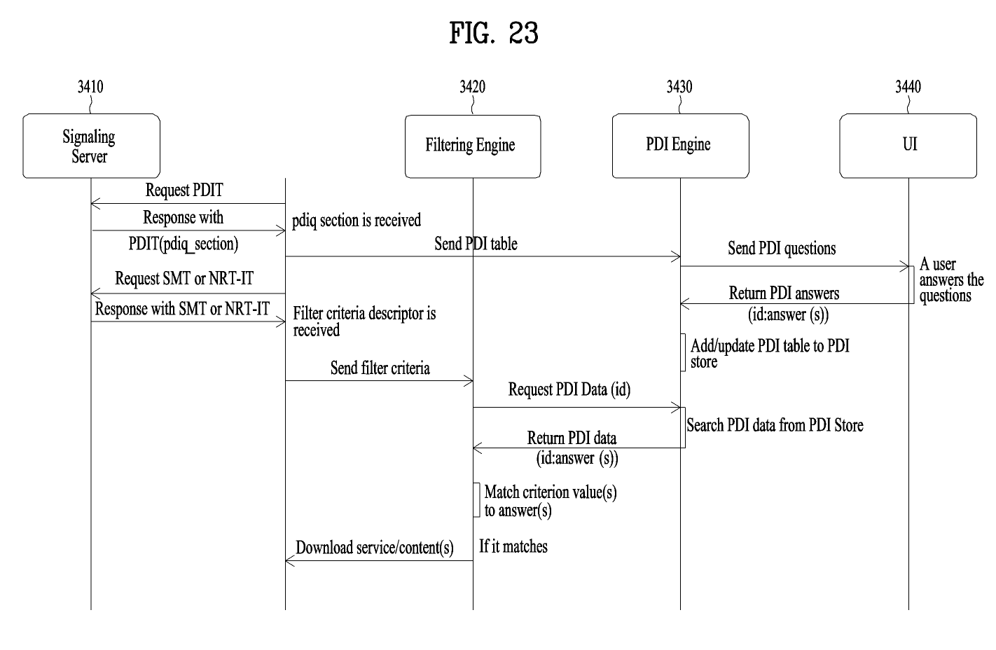

FIG. 23 is a flowchart of a digital broadcast system according to another embodiment of the present invention.

In detail, FIG. 23 is a flowchart of a personalization broadcast system for receiving a PDI table and/or a filtering criteria table through a broadcast network by a receiver according to the embodiment of the present invention.

The basic structure of the personalization broadcast system according to the present embodiment is the same as the structure described with reference to FIGS. 9 through 11. The PDI table according to the present embodiment is the same as the table described with reference to FIGS. 10 through 16. The filtering criteria table according to the present embodiment is the same as the table described with reference to FIGS. 17 through 20.

As illustrated in FIG. 23, the personalization broadcast system according to the present embodiment may include a signaling server 3410, a filtering engine 3420, a PDI engine 3430, and/or a UI 3440. The structure of the aforementioned personalization broadcast system may be changed according to a designer's intention.

Operations of the filtering engine 3420, the PDI engine 3430, and/or the UI 3440 for processing the PDI table and the filtering criteria according to the present embodiment are the same as the operations described with reference to FIG. 21. Hereinafter, the digital broadcast system will be described in terms of an operation of the signaling server 3410 illustrated in FIG. 23.

First, a receiver according to the present embodiment may transmit a request signal for receiving a PDI table section to the signaling server 3410. In this case, the receiver according to the present embodiment may transmit the request signal using a query term. A query will be described in detail.

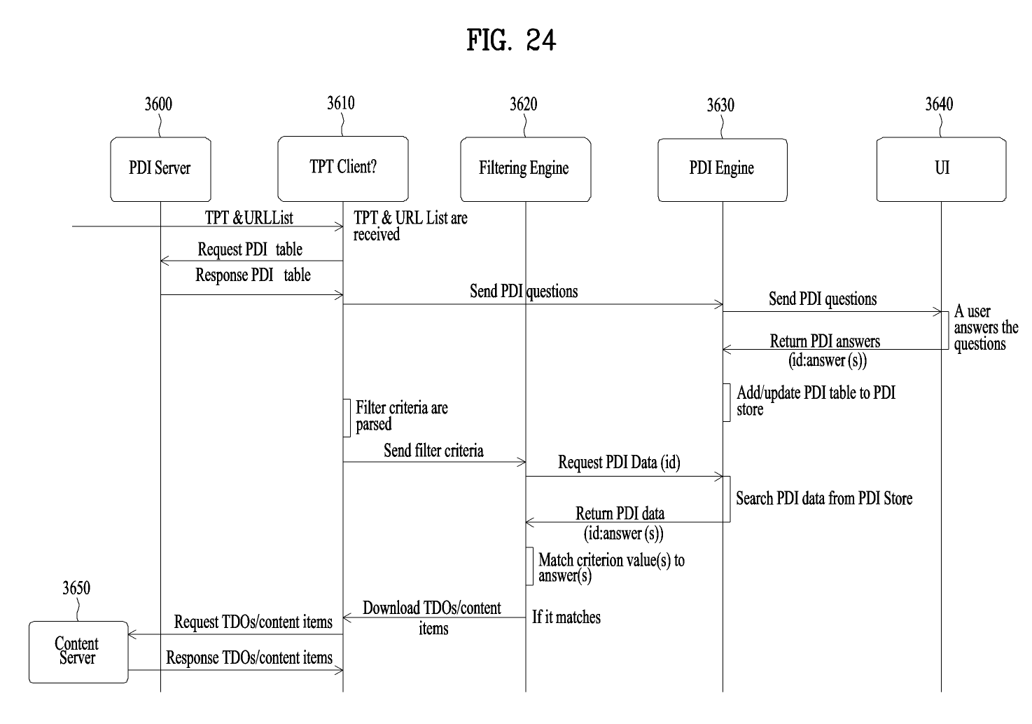

The signaling server 3410 according to the present embodiment may transmit a PDI table section corresponding to a corresponding query to the receiver. FIG. 24 is a flowchart illustrating a digital broadcast system according to another embodiment of the present invention.

In detail, FIG. 24 is a diagram illustrating a personalization broadcast system for receiving a PDI table and/or a filtering criteria table through the Internet by a receiver according to the embodiment of the present invention.

The basic structure of the personalization broadcast system according to the present embodiment is the same as the structure described with reference to FIGS. 9 through 11. The PDI table according to the present embodiment is the same as the structure described with reference to FIGS. 15 through 16. The filtering criteria table according to the present embodiment is the same as the table described with reference to FIGS. 17 through 20.

When delivered over the Internet, PDI Table instances shall be delivered via HTTP or HTTPS. The Content-Type of a PDI Table in the HTTP Response header shall be “text/xml”.

The URL used to retrieve a PDI Table via Internet can be delivered via SDOPrivateDataURIString commands which are transported in Standard caption service #6 in the DTV closed caption channel, or it can be delivered in a UrlList XML element delivered along with a TPT.

A TPT (TDO Parameters Table) contains metadata about the TDOs of a segment and the Events targeted to them. The term “Triggered Declarative Object” (TDO) is used to designate a Declarative Object that has been launched by a Trigger in a Triggered interactive adjunct data service, or a DO that has been launched by a DO that has been launched by a Trigger, and so on iteratively. A trigger is a signaling element whose function is to identify signaling and establish timing of playout of interactive events.

As illustrated in FIG. 24, the personalization broadcast system according to the present embodiment may include a PDI server 3600, a content server 3650, and/or a receiver. The receiver according to the present embodiment may include a TDO parameter table (TPT) client 3610, a filtering engine 3620, a PDI engine 3630, and/or a UI 3640. The structure of the aforementioned personalization broadcast system may be changed according to a designer's intention. Hereinafter, operations of elements illustrated in FIG. 24 will be described.

The TPT client 3610 according to the present embodiment may receive a TPT and/or a URL list table. A TDO parameters table (TPT) according to the embodiment of the present invention contains metadata about the triggered declarative objects (TDOs) of a segment and the events targeted to them. The TPT according to the present embodiment may include information regarding a PDI table and a filtering criteria table. The URL list table according to an embodiment of the present invention may include URL information of the PDI server 3600. The TPT and the URL list table will be described in detail.

The TPT client 3610 according to the present embodiment may acquire URL information of the PDI server 3600 from the URL list table. The TPT client 3610 may access the PDI server 3600 using the acquired URL information and request the PDI server 3600 to transmit the PDI table according to the present embodiment. The PDI server 3600 according to the present embodiment may transmit the corresponding PDI table to the TPT client 3610 according to the request of the TPT client 3610.

As illustrated in FIG. 24, the TPT client 3610 according to the present embodiment may transmit the received PDI table to the PDI engine 3630. The PDI engine 3630 according to the present embodiment may process the received PDI table and extract PDI questions included in the corresponding PDI table. Then, the PDI engine 3630 according to the present embodiment may transmit the extracted PDI questions to the UI 3640.

The UI 3640 according to the present embodiment may display the received PDI questions and receive PDI answers to the corresponding PDI questions. The UI 3640 according to the present embodiment may receive the PDI answers through a remote controller. Then, the PDI engine 3630 according to the present embodiment may update PDI data using the PDI answer received from the UI 3640. A detailed description thereof has been described with reference to FIG. 9.

The TPT client 3610 according to the present embodiment may parse TPT to acquire filtering criteria. As illustrated in FIG. 24, the TPT client 3610 may transmit the filtering criteria to the filtering engine 3620. In this case, according to an embodiment of the present invention, the filtering criteria may be filtering criteria table with a format of xml document. The filtering criteria table has been described in detail with reference to FIGS. 19 and 20.

Then, the filtering engine 3620 according to the present embodiment may transmit a PDI data request signal to the PDI engine 3630. When the PDI engine 3630 according to the present embodiment receives the PDI data request signal, the PDI engine 3630 may search for PDI data corresponding to the corresponding PDI data request signal and transmit the PDI data to the filtering engine 3620. Processes subsequent to the filtering according to the present embodiment have been described in detail with reference to FIGS. 10 and 11.

As a result, a receiver according to the present embodiment may download content using the filtering result. In more detail, the TPT client 3610 may receive the filtering result from the filtering engine 3620 and transmit TDO and/or content download request signal to the content server 3650. The content server 3650 may transmit the TDO and/or the content to the TPT client 3610 according to the TDO and/or the content download request signal.

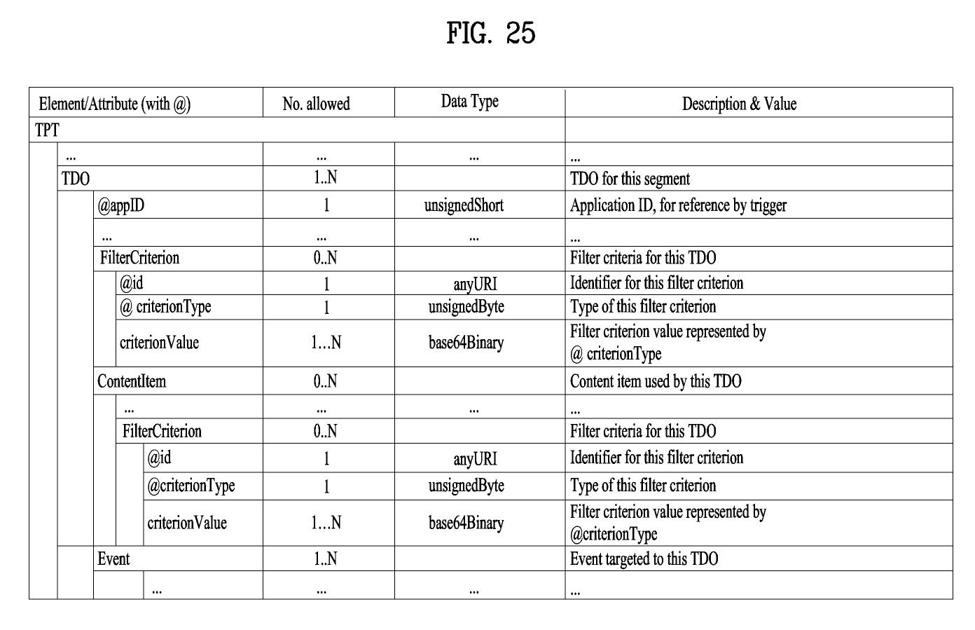

FIG. 25 is a diagram illustrating a TPT according to an embodiment of the present invention.

In detail, the TPT illustrated in FIG. 25 may include URL information of a PDI table and/or filtering criteria. A process of transmitting and receiving the TPT according to the present embodiment has been described with reference to FIG. 24. Hereinafter, an element of filtering criteria included in the TPT will be described.

In detail, the filter criteria element illustrated in FIG. 25 may include information regarding filtering criteria.

The id attribute according to the present embodiment may indicate a PDI question of the corresponding filtering criteria.

The criteria type attribute according to the present embodiment may indicate a filtering criteria type (or filtering criteria type elements). A type of the filtering criteria according to the present embodiment has been described with reference to FIG. 18.

The criteria value attribute according to the present embodiment may indicate a value of the filtering criteria according to the aforementioned criteria type attribute.

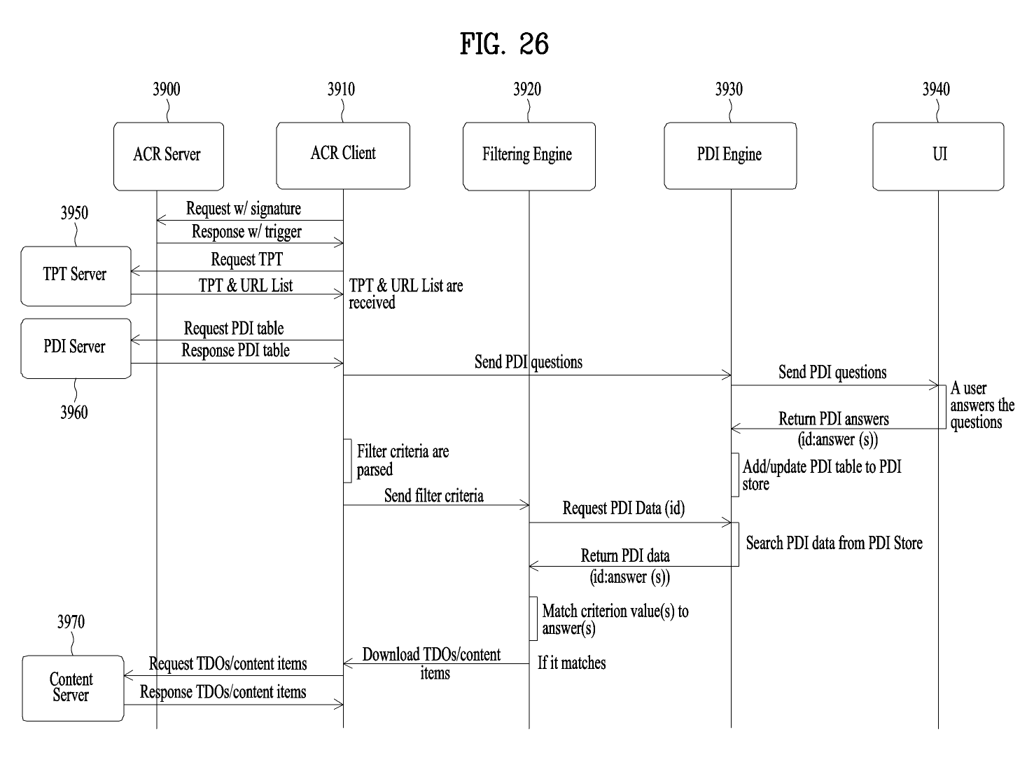

FIG. 26 is a flowchart of a digital broadcast system according to another embodiment of the present invention.

In detail, FIG. 26 is a diagram illustrating a personalization broadcast system for receiving a PDI table and/or a filtering criteria table in an ACR system by a receiver according to the embodiment of the present invention.

As illustrated in FIG. 26, the personalization broadcast system according to the present embodiment may include an ACR server 3900, a TPT server 3950, a PDI server 3960, a content server 3970, an ACR client 3910, a filtering engine 3920, a PDI engine 3930, and/or a UI 3940. The structure of the aforementioned personalization broadcast system may be changed according to a designer's intention. Operations of elements illustrated in FIG. 26 will be described.

The ACR client 3910 according to the present embodiment may extract signature from fingerprint and transmit a request together with the signature to the ACR server 3900. The ACR server 3900 according to the present embodiment may receive the signature and transmit a response together with trigger, etc. related to the corresponding signature to the ACR client 3910.

The ACR client 3910 according to the present embodiment may request a TPT and/or a URL list table to the TPT server 3950 using the received trigger, etc. The TPT server 3950 according to the present embodiment may transmit the TPT and/or the URL list table to the ACR client 3910 according to the request of the ACR client 3910. A detailed description of the TPT and/or the URL list table has been given. Then, the TPT server 3950 according to the present embodiment may transmit the received TPT and/or URL list table to the ACR client 3910.

The ACR client 3910 according to the present embodiment may acquire URL information of the PDI server 3960 from the URL list table. The ACR client 3910 may access the PDI server 3960 using the acquired URL information and request the PDI server 3960 to transmit the PDI table according to the present embodiment. The PDI server 3960 according to the present embodiment may transmit the corresponding PDI table to the ACR client 3910 according to the request of the ACR client 3910.

As illustrated in FIG. 23, the ACR client 3910 according to the present embodiment may transmit the received PDI table to the PDI engine 3930. The PDI engine 3930 according to the present embodiment may process the received PDI table and extract PDI questions included in the corresponding PDI table. Then, the PDI engine 3930 according to the present embodiment may transmit the extracted PDI questions to the UI 3940.

The UI 3940 according to the present embodiment may display the received PDI questions and receive PDI answers to the corresponding PDI questions. The UI 3940 according to the present embodiment may receive the PDI answers through a remote controller. Then, the PDI engine 3930 according to the present embodiment may update PDI data using the PDI answer received from the UI 3940. A detailed description thereof has been described with reference to FIG. 9.

In addition, the ACR client 3910 according to the present embodiment may parse TPT to acquire filtering criteria. As illustrated in FIG. 26, the ACR client 3910 may transmit the filtering criteria to the filtering engine 3920. In this case, according to an embodiment of the present invention, the filtering criteria may be a filtering criteria table with a format of xml document. The filtering criteria table has been described in detail with reference to FIGS. 19 and 20.

Then, the filtering engine 3920 according to the present embodiment may transmit a PDI data request signal to the PDI engine 3930. When the PDI engine 3930 according to the present embodiment receives the PDI data request signal, the PDI engine 3930 searches for PDI data corresponding to the corresponding PDI data request signal and transmits the PDI data to the filtering engine 3920. Processes subsequent to the filtering according to the present embodiment have been described in detail with reference to FIGS. 6 and 11.

As a result, a receiver according to the present embodiment may download content using a filtering result. In detail, the ACR client 3910 may receive the filtering result from the filtering engine 3920 and transmit a TDO and/or content download request signal to the content server 3970. The content server 3970 may transmit the TDO and/or the content to the ACR client 3910 according to the TDO and/or content download request signal.

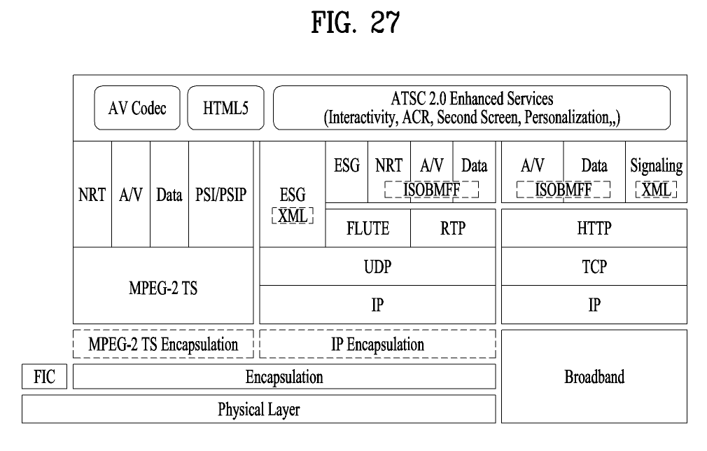

FIG. 27 is a view showing a Protocol Stack for a next generation broadcasting system according to an embodiment of the present invention.

The present invention may proposes a scheme for exchanging the above-described PDI information between a receiver and a companion device in a next generation broadcasting system based on interlocking between a terrestrial broadcast network and an Internet network. In the present invention, the above-described PDI information may be provided to the companion device in addition to being utilized only by the receiver. A user may receive an interactive service in which the PDI information is reflected utilizing the companion device.

On the other hand, one user may use several companion devices. In this case, if PDI user data are set per companion device, the user may continue to repeatedly answer. For this reason, it is necessary for the PDI user data to be shared among several companion devices. Consequently, the present invention proposes a scheme for exchanging/sharing PDI information among a plurality of companion devices. The exchanged/shared PDI information may be the above-described PDI Question, Answer, and/or Filtering Criteria.

In addition, the present invention proposes a method of providing/storing PDI information of a plurality of users and providing a filtered interactive service utilizing the same.

In addition, the present invention proposes a scheme for converting received relevant information into PDI Question and presenting the PDI Question to a user to personalize preference for presented information, i.e. Presentation Preference. In addition, the present invention also proposes a scheme for updating Presentation Preference, which is already set.

The broadcasting system according to the present invention may correspond to a hybrid broadcasting system in which an Internet Protocol (IP) centric broadcast network and a broadband network are coupled.

The broadcasting system according to the present invention may be designed to maintain compatibility with a conventional MPEG-2 based broadcasting system.

The broadcasting system according to the present invention may correspond to a hybrid broadcasting system based on coupling of an IP centric broadcast network, a broadband network, and/or a mobile communication network (or a cellular network).

Referring to the figure, a physical layer may use a physical protocol adopted in a broadcasting system, such as an ATSC system and/or a DVB system. For example, in the physical layer according to the present invention, a transmitter/receiver may transmit/receive a terrestrial broadcast signal and convert a transport frame including broadcast data into an appropriate form.

In an encapsulation layer, an IP datagram is acquired from information acquired from the physical layer or the acquired IP datagram is converted into a specific frame (for example, an RS Frame, GSE-lite, GSE, or a signal frame). The frame may include a set of IP datagrams. For example, in the encapsulation layer, the transmitter include data processed from the physical layer in a transport frame or the receiver extracts an MPEG-2 TS and an IP datagram from the transport frame acquired from the physical layer.

A fast information channel (FIC) includes information (for example, mapping information between a service ID and a frame) necessary to access a service and/or content. The FIC may be named a fast access channel (FAC).

The broadcasting system according to the present invention may use protocols, such as an Internet Protocol (IP), a User Datagram Protocol (UDP), a Transmission Control Protocol (TCP), an Asynchronous Layered Coding/Layered Coding Transport (ALC/LCT), a Rate Control Protocol/RTP Control Protocol (RCP/RTCP), a Hypertext Transfer Protocol (HTTP), and a File Delivery over Unidirectional Transport (FLUTE). A stack between these protocols may refer to the structure shown in the figure.

In the broadcasting system according to the present invention, data may be transported in the form of an ISO based media file format (ISOBMFF). An Electrical Service Guide (ESG), Non Real Time (NRT), Audio/Video (A/V), and/or general data may be transported in the form of the ISOBMFF.

Transport of data through a broadcast network may include transport of a linear content and/or transport of a non-linear content.

Transport of RTP/RTCP based A/V and data (closed caption, emergency alert message, etc.) may correspond to transport of a linear content.

An RTP payload may be transported in the form of an RTP/AV stream including a Network Abstraction Layer (NAL) and/or in a form encapsulated in an ISO based media file format. Transport of the RTP payload may correspond to transport of a linear content. Transport in the form encapsulated in the ISO based media file format may include an MPEG DASH media segment for A/V, etc.

Transport of a FLUTE based ESG, transport of non-timed data, transport of an NRT content may correspond to transport of a non-linear content. These may be transported in an MIME type file form and/or a form encapsulated in an ISO based media file format. Transport in the form encapsulated in the ISO based media file format may include an MPEG DASH media segment for A/V, etc.

Transport through a broadband network may be divided into transport of content and transport of signaling data.

Transport of the content includes transport of a linear content (A/V and data (closed caption, emergency alert message, etc.)), transport of a non-linear content (ESG, non-timed data, etc.), and transport of a MPEG DASH based media segment (A/V and data).

Transport of the signaling data may be carried out including a signaling table (including an MPD of MPEG DASH) transported through a broadcasting network.

In the broadcasting system according to the present invention, synchronization between linear/non-linear contents transported through the broadcasting network or synchronization between a content transported through the broadcasting network and a content transported through the broadband network may be supported. For example, in a case in which one UD content is separately and simultaneously transported through the broadcasting network and the broadband network, the receiver may adjust a timeline dependent upon a transport protocol and synchronize the content through the broadcasting network and the content through the broadband network to reconfigure the contents as one UD content.

An applications layer of the broadcasting system according to the present invention may realize technical characteristics, such as Interactivity, Personalization, Second Screen, and automatic content recognition (ACR). These characteristics are important in extension from ATSC 2.0 to ATSC 3.0. For example, HTML5 may be used for a characteristic of interactivity.

In a presentation layer of the broadcasting system according to the present invention, HTML and/or HTML5 may be used to identify spatial and temporal relationships between components or interactive applications.

In the present invention, signaling includes signaling information necessary to support effective acquisition of a content and/or a service. Signaling data may be expressed in a binary or XML form. The signaling data may be transmitted through the terrestrial broadcasting network or the broadband network.

A real-time broadcast A/V content and/or data may be expressed in an ISO Based Media File Format, etc. In this case, the A/V content and/or data may be transmitted through the terrestrial broadcasting network in real time and may be transmitted based on IP/UDP/FLUTE in non-real time. Alternatively, the broadcast A/V content and/or data may be received by receiving or requesting a content in a streaming mode using Dynamic Adaptive Streaming over HTTP (DASH) through the Internet network in real time. In the broadcasting system according to the embodiment of the present invention, the received broadcast A/V content and/or data may be combined to provide various enhanced services, such as an Interactive service and a second screen service, to a viewer.

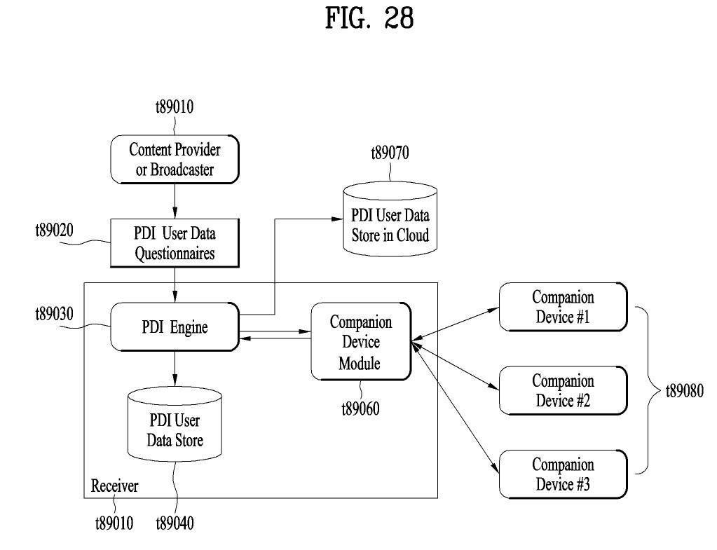

FIG. 28 is a structural view showing exchange of user data between a receiver and a companion device according to an embodiment of the present invention.

As described above, the present invention proposes a method of exchanging/transmitting PDI user data between a receiver and a companion device.

A content provider or broadcaster t80010. PDI Questionnaires t89020, a PDI engine t89030, and a PDI store t89040 may be identical to the above-described modules having the same names.

As described above, the PDI Questionnaires t89020 created by the content provider or broadcaster t80010 may be transmitted to a receiver t89050. The PDI engine t89030 may provide corresponding Questionnaires to a user, receive answers from the user, and store the received answers in the PDI store t89040. According to embodiments, answers may be automatically entered in the receiver without inducing the user to answer questionnaires.

The mechanism of presenting questionnaires to the user and storing answers may be the same as in the previous embodiment but is only an embodiment. The present invention is not limited thereto.

As described above, the PDI store t89040 may be located in the receiver t89050. According to embodiments, however, a PDI cloud store t89070 may be provided outside the receiver. The PDI cloud store t89070 may perform the same operation as the above-described PDI store t89040. On the other hand, the PDI cloud store t89070 may be located outside the receiver t89050 such that PDI cloud store t89070 can operate as a cloud server.

In this embodiment, the receiver t89050 may further include a companion device module t89060. Stored PDI user data may be transmitted to companion devices t89080 through the companion device module t89060. On the other hand, answers set by the companion devices may be transmitted to the receiver through the companion device module t89060.

The present invention describes an embodiment of communication between the receiver and the companion devices based on UPnP. However, the communication protocol between the receiver and the companion devices is not limited thereto.

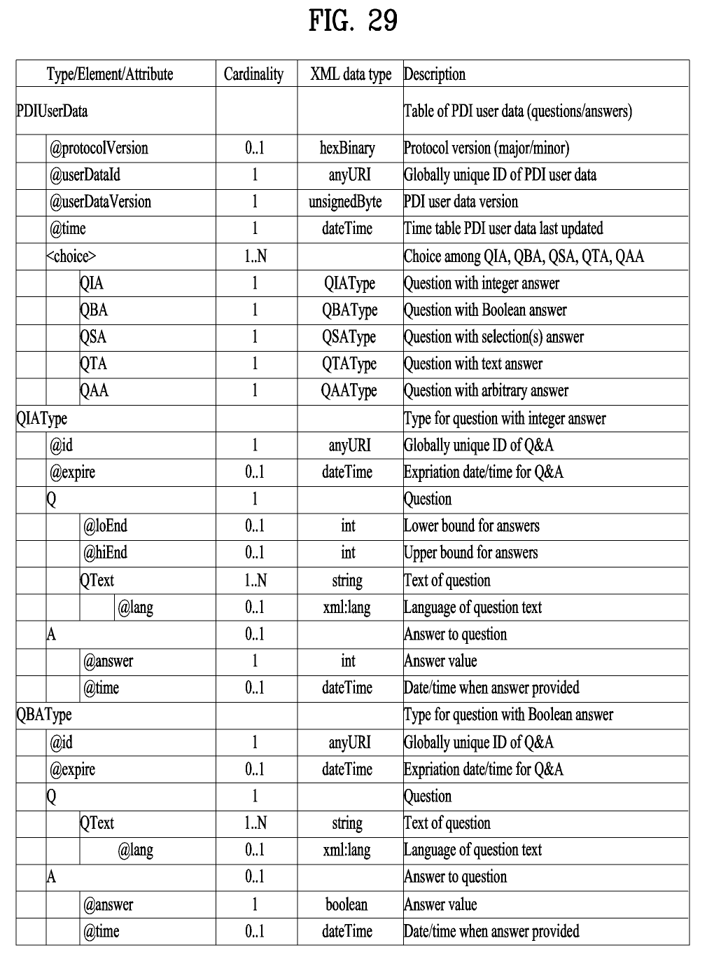

FIG. 29 is a view showing a portion of PDI user data according to an embodiment of the present invention.

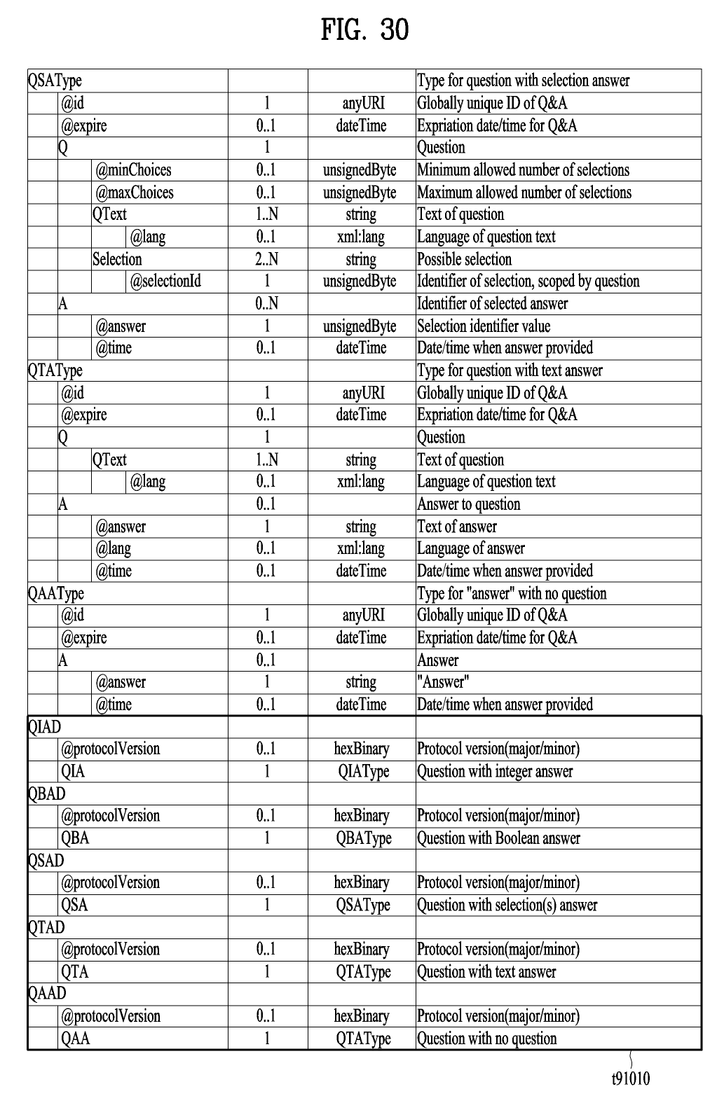

FIG. 30 is a view showing another portion of PDI user data according to an embodiment of the present invention.

The two figures show one table, which, however, is divided into two parts due to spatial limitations.

The shown PDI user data may be another embodiment of the above-described PDITable (an XML form). That is, an embodiment of exchanged PDI user data may be the above-described PDI table.

PDIUserData may be a root element including one or more question elements. @Protocol Version may be the same as @ProtocolVersion in the above-described PDITable. @userDataId may be the same as @pdiTableId in the above-described PDITable. @userDataVersion may be the same as @pdiTableVersion in the above-described PDITable. @time may be the same as @time in the above-described PDITable.

QxA (i.e. QIA, QBA, QSA, QTA, or QAA) may be another embodiment of QxA in the above-described PDITable. In this embodiment, each QxA may have the same meaning as in the above description but may have a slight different internal structure. The internal structure of each QxA is expressed in a QxAType element. For example, the structure of QIA is expressed in a QIAType field.

@id below QxA may be the same as @id in the above-described PDITable. @expire below QxA may be the same as @expire in the above-described PDITable.

Q below QxA may be the same as Q in the above-described PDITable. In this embodiment, the Q element may have a QText element expressing question text. @lang below QxA may be the same as @lang in the above-described PDITable. In this embodiment, however, @lang may be located below the QText element.

A below QxA may be the same as A in the above-described PDITable. In this embodiment, the A element may have @answer having actual answer information. @time below QxA may be the same as @time in the above-described PDITable.

@loEnd and @hiEnd below QIA may be the same as @loEnd and @hiEnd in the above-described PDITable. In this embodiment, however, @loEnd and @hiEnd may be located below the Q element.

@minChoices and @maxChoices below QSA may be the same as @minChoices and @maxChoices in the above-described PDITable. In this embodiment, however, @minChoices and @maxChoices may be located below the Q element. A Selection element and @selectionld below QSA may be the same as the Selection element and @id located therebelow in the above-described PDITable.

A below QTA may have @lang, which may be same as @lang of the A element of QTA in the above-described PDITable.

As described above, QAA may have no Q element.

QxAD may mean a Q&A document classified according to data type of answer. That is, QxAD may include a QxA element and @protocolVersion related to an actual question and answer, x may correspond to any one selected from among I (integer), B (Boolean), S (Selection), T (text), A (without question) according to data type.

Among the shown PDI user data, a part denoted by t91010 may be omitted according to embodiments.

The above-described PDI user data is only an embodiment of PDI user data. The PDI user data of the present invention is not limited to any form.

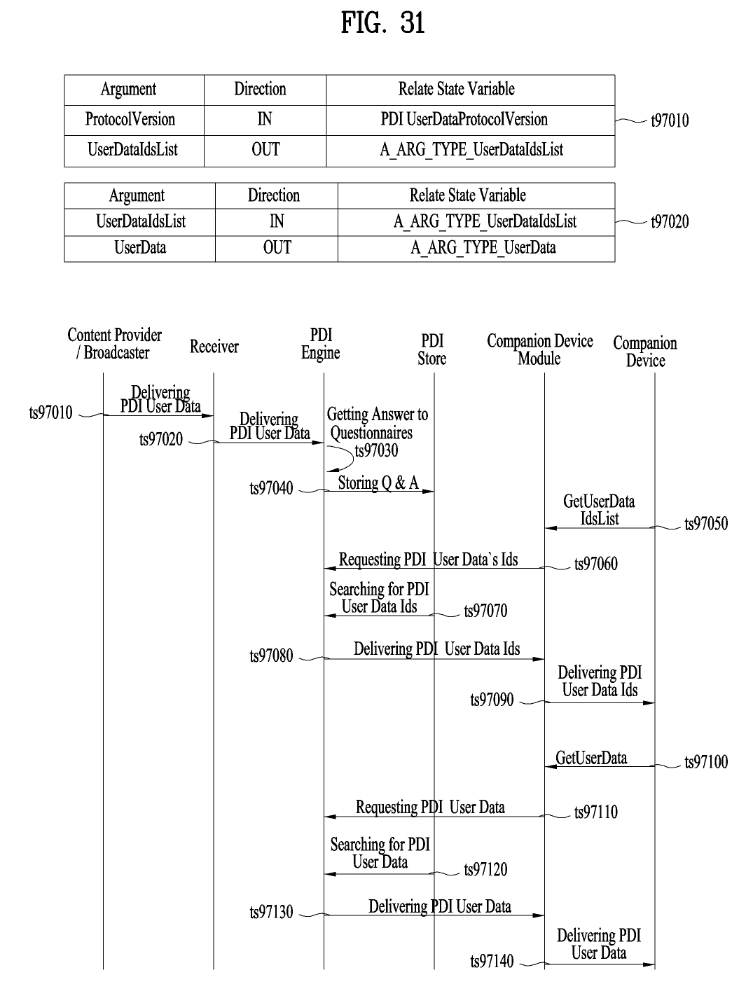

FIG. 31 is a view showing GetUserDataIdsList and GetUserData, actions of a UserData service, according to an embodiment of the present invention.

A GetUserDataIdsList action will be described.

The GetUserDataIdsList action may be an action used to bring IDs of PDI user data stored in the above-described PDI store. A companion device may bring Id information of PDI user data from a PDI store provided in/outside a receiver using the GetUserDataIdsList action. At this time, protocol version of PDI user data may be referred to such that only IDs of PDI user data supporting a corresponding protocol can be brought.

In order to use the GetUserDataIdsList action, a ProtocolVersion input argument and a UserDataIdsList output argument may be defined (t97010). The ProtocolVersion input argument, which is protocol version information of PDI user data, may be related to the above-described PDIUserDataProtocolVersion state variable. The UserDataIdsList output argument, which is a string type list of IDs of PDI user data, may be related to the above-described A_ARG_TYPE UserDataIdsList state variable.

When the GetUserDataIdsList action is used, if elements having the same value of @protocolVersion and ProtocolVersion, which is an input argument, exist among PDIUserData elements of a UserDataList state variable, @userDataId values may be output as a list among the PDIUserData elements having the same value of @protocolVersion and ProtocolVersion. The output, which is the above-described UserDataList output argument, may be transmitted from the receiver to the companion device.

According to an embodiment, if ProtocolVersion is set to 00000000, a list of all IDs may be requested irrespective of ProtocolVersion and, if ProtocolVersion is set to 11111111, a list of IDs corresponding to the latest ProtocolVersion may be requested.

A GetUserData action will be described.

The GetUserData action may be an action used to bring PDI user data stored in the above-described PDI store. The companion device may bring PDI user data from the PDI store provided in/outside the receiver using the GetUserData action. At this time, the above-described UserDataIdsList may be referred to such that only PDIUserData matched with PDIUserDataId can be brought in a fragment form.

In order to use the GetUserData action, a UserDataIdsList input argument and a UserData output argument may be defined (t97020). The UserDataIdsList input argument may be the same as in the above description and may be related to the above-described PDIUserDataProtocolVersion state variable. The UserData output argument, which is a fragment of the above-described UserDataList state variable, may be related to the above-described A_ARG_TYPE_UserData state variable. The UserData output argument may have information, such as elements, and may be based on data type of UserDataList (e.g. XML).

For example, in a case in which an action, such as GetUserData(UserDataIdsList=“atsc.org/userdata1”, “atsc.org/userdata3”), is used, PDIUserData having userDataId of “atsc.org/userdata1” and “atsc.org/userdata3” among a plurality of PDIUserData included in UserDataList in an XML structure of the above-described UserDataList may be returned. At this time, the XML structure of the returned UserData may have only PDIUserData having userDataId of “atsc.org/userdata1” and “atsc.org/userdata3” and may not have a PDIUserData element having userDataId of “atsc.org/userdata2”.

In the GetUserData action, the number of PDIUserData elements of UserData, which is an output argument, may be less than or equal to the number of PDIUserDataIds in UserDataIdsList, which is an input argument.

According to embodiments, when UserDataIdsList, which is an input argument, is set to “ALL”, all PDIUserData may be requested irrespective of PDIUserDataId.

An embodiment of an operation sequence diagram of the above-described GetUserDataIdsList and GetUserData actions will be described.

In this operation sequence diagram, the companion device and the receiver are already paired with each other. A paring procedure is omitted from the operation sequence diagram. In addition, it is assumed that the companion device already knows utilizable protocol version.

The above-described content provider or broadcaster may transmit PDI user data to the receiver to provide a personalized service (ts97010). The PDI user data may be a plurality of questionnaires or a combination of a plurality of questionnaires and answers.

The receiver transmits the received PDI user data to the above-described PDI engine (ts97020). The PDI engine may present questionnaires to a user and obtain answers corresponding to the respective questionnaires from the user (ts97030). The PDI engine may store completed Q&A in the above-described PDI store (097040).

The above-described companion device may perform the above-described GetUserDataIdsList action to obtain PDI user data from the receiver (ts97050). The companion device may request IDs of PDI user data from a companion device module in the above-described receiver.

The companion device module may request IDs of PDI user data requested by the companion device from the PDI engine (ts97060). The PDI engine may retrieve corresponding IDs of PDI user data from the PDI store (ts97070). Subsequently, the PDI engine may transmit the retrieved IDs of PDI user data to the companion device module (ts97080).

The companion device module may transmit the received IDs of PDI user data to the companion device (ts97090).

The companion device having obtained IDs of PDI user data may utilize the above-described GetUserData action to obtain PDI user data (ts97100). The companion device may request PDI user data using the received IDs of PDI user data or using the received IDs of PDI user data as input arguments.

The companion device module may request corresponding PDI user data from the PDI engine (ts97110). The companion device module may retrieve corresponding PDI user data stored in the PDI store (ts97120) and transmits the retrieved PDI user data to the companion device module (ts97130).

The companion device module may transmit the received PDI user data to the companion device (ts97140). The companion device may store the received PDI user data. The stored PDI user data may be semi-permanently stored and utilized. In a case in which there is no store in the companion device, the PDI user data may be temporarily stored in a space, such as a memory.

In the present invention, a time at which the GetUserDataIdsList and GetUserData actions are executed is not limited to a specific time. According to embodiments, each action may be executed immediately after the companion device and the receiver are paired with each other. In addition, according to embodiments, the companion device may request execution of each action from the receiver during periodic polling.

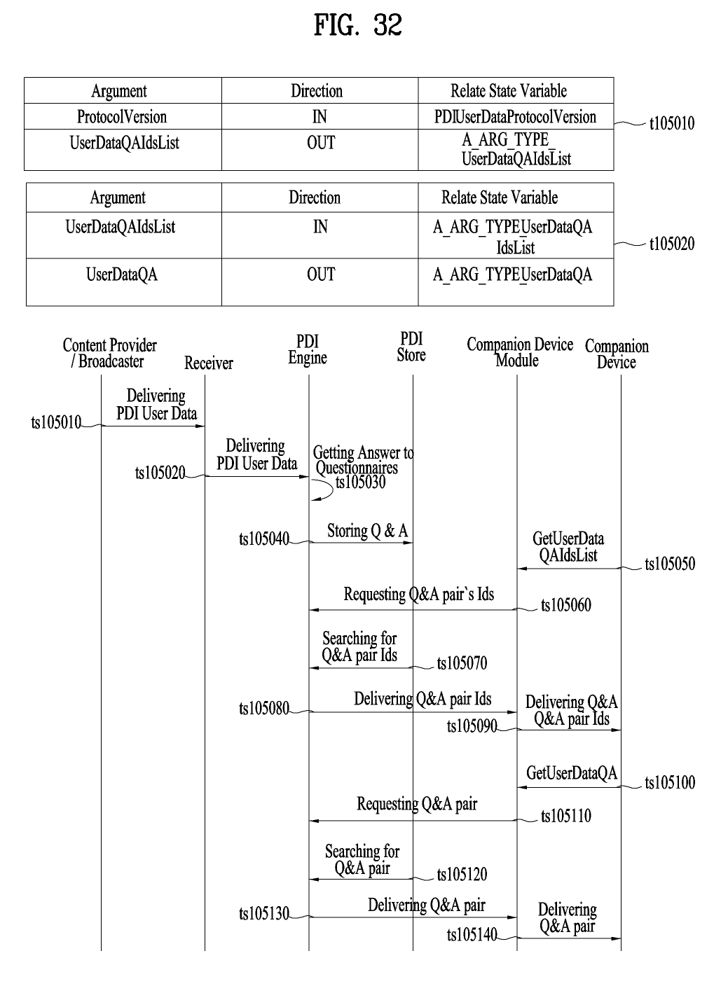

FIG. 32 is a view showing GetUserDataQAIdsList and GetUserDataQA, actions of a UserData service for transmission on a per pair basis of questions and answers, according to an embodiment of the present invention.

A GetUserDataQAIdsList action will be described.

The GetUserDataQAIdsList action may be an action used to bring IDs of Q&A pairs stored in the above-described PDI store. That is, the GetUserDataQAIdsList action may be an action for bringing a list of @id values of Q×A of the QxAD element of the UserDataQAList state variable. This state variable may be configured in the form of a string (e.g. CSV) or another form. A companion device may bring, Id information of Q&A pairs from a PDI store provided in/outside a receiver using the GetUserDataQAIdsList action. At this time, protocol version of PDI user data may be referred to such that @ids matched with @protocolVersion values of the QxAD element can be brought to the companion device.

In order to use the GetUserDataQAIdsList action, a ProtocolVersion input argument and a UserDataQAIdsList output argument may be defined (t105010). The ProtocolVersion input argument may be the same as in the above description and may be related to the above-described PDIUserDataProtocolVersion state variable. The UserDataQAIdsList output argument, which is a list of @id values of Q×A of the QxAD element, may be related to the above-described A_ARG_TYPE_UserDataQAIdsList state variable. UserDataQAIdsList may be a string type list (e.g. CSV).

A GetUserDataQA action will be described.

The GetUserDataQA action may be an action used to bring Q&A pairs stored in the above-described PDI store. The companion device may bring Q&A pairs from the PDI store provided in/outside the receiver using the GetUserDataQA action. At this time, the above-described UserDataQAIdsList may be referred to such that only QxAD matched with the ID can be brought in a fragment form.

In order to use the GetUserDataQA action, a UserDataQAIdsList input argument and a UserDataQA output argument may be defined (t105020). The UserDataQAIdsList input argument may be the same as in the above description and may be related to the above-described A_ARG_TYPE_UserDataQAIdsList state variable. The UserDataQA output argument, which is a fragment of the above-described UserDataQAList state variable, may be related to the above-described A_ARG_TYPE_UserDataQA state variable. The UserDataQA output argument may have information, such as a QxAD element, and may be based on data type of UserDataQAList (e.g. XML).

For example, in a case in which an action, such as GetUserDataQA(UserDataQAIdsList=“question1”, “question3”), is used, QxAD having ids of “question1” and “question3” among a plurality of QxAD included in UserDataQAList in an XML structure of the above-described UserDataQAList may be returned. At this time, the XML structure of the returned UserData may have only QxAD having ids of “question1” and “question3” and may not have a QxAD element having an id of “question2”.

In the GetUserDataQA action, the number of QxAD elements of UserDataQA, which is an output argument, may be less than or equal to the number of @ids in UserDataQAIdsList, which is an input argument.

An embodiment of an operation sequence diagram of the above-described GetUserDataQAIdsList and GetUserDataQA actions will be described.

In this operation sequence diagram, the companion device and the receiver are already paired with each other. A paring procedure is omitted from the operation sequence diagram. In addition, it is assumed that the companion device already knows utilizable protocol version.

Procedures (ts105010, ts105020, ts105030, and ts105040) in which the content provider transmits PDI user data to the receiver, the PDI user data are transmitted to the PDI engine, answers are obtained, and O&A are stored may be the same as in the above description.

The above-described companion device may perform the above-described GetUserDataQAIdsList action to obtain Q&A pairs from the receiver (ts105050). The companion device may request IDs of Q&A pairs from a companion device module in the above-described receiver.

The companion device module may request IDs of Q&A pairs requested by the companion device from the PDI engine (ts105060). The PDI engine may retrieve corresponding IDs of Q&A pairs from the PDI store (ts97070). Subsequently, the PDI engine may transmit the retrieved IDs of Q&A pairs to the companion device module (ts105080).

The companion device module may transmit the received IDs of Q&A pairs to the companion device (ts105090).

The companion device having obtained IDs of Q&A pairs may utilize the above-described GetUserDataQA action to obtain Q&A pairs (ts105100). The companion device may request Q&A pairs using the received IDs of Q&A pairs or using the received IDs of Q&A pairs as input arguments.

The companion device module may request corresponding Q&A pairs from the PDI engine (ts105110). The companion device module may retrieve corresponding Q&A pairs from the PDI store (ts105120) and transmits the retrieved Q&A pairs to the companion device module (ts105130).

The companion device module may transmit the received Q&A pairs to the companion device (t5105140). The companion device may store the received Q&A pairs. The stored Q&A pairs may be semi-permanently stored and utilized. In a case in which there is no store in the companion device, the Q&A pairs may be temporarily stored in a space, such as a memory.

In the present invention, a time at which the GetUserDataQAIdsList and GetUserDataQA actions are executed is not limited to a specific time. According to embodiments, each action may be executed immediately after the companion device and the receiver are paired with each other. In addition, according to embodiments, the companion device may request execution of each action from the receiver during periodic polling.

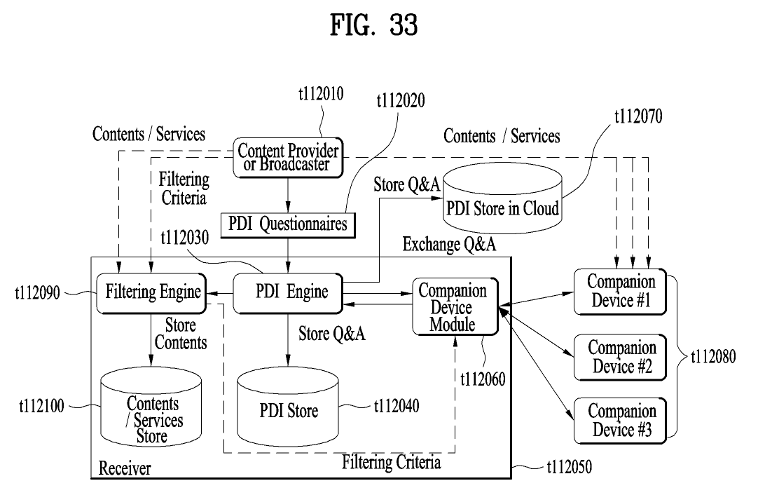

FIG. 33 is a structural view showing exchange of user data between a receiver and companion devices according to another embodiment of the present invention.

As described above, a personalized service may be provided using PDI user data designated by a user. To this end, filtering criteria may be provided. The receiver/companion devices may provide content customized to the user through the filtering criteria.

A content provider or broadcaster t112010, PDI Questionnaires t112020, a PDI engine t112030, a PDI store t112040, a PDI cloud store t112070, a companion device module t112060, and companion devices t112080 may be identical to the above-described modules having the same names.

Unlike the above-described structural view, a receiver t112050 may further include a filtering engine t112090 and a content/service store t112100. The filtering engine may compare filtering criteria of each content/service with stored PDI user data to select a content/service customized to the user. The filtering criteria may be transmitted to the companion devices.

According to embodiments, data selected by the filtering criteria may be transmitted to companion devices or the filtering criteria may be transmitted to the companion devices such that the companion devices can directly perform filtering.

The XML structure of the filtering criteria was described above. However, the XML structure of the filtering criteria is not limited to the above-described structure. According to embodiments, filtering criteria having different structures may be used. Hereinafter, the filtering criteria may be abbreviated to FC.

The content/service store t112100 is a space in which the received content/service is stored. According to embodiments, a content/service filtered by the filtering engine may be stored in the content/service store t112100. In addition, according to embodiments, all contents/services may be stored in the content/service store, the filtering engine may perform filtering, and the filtered contents/services may be stored in the content/service store.

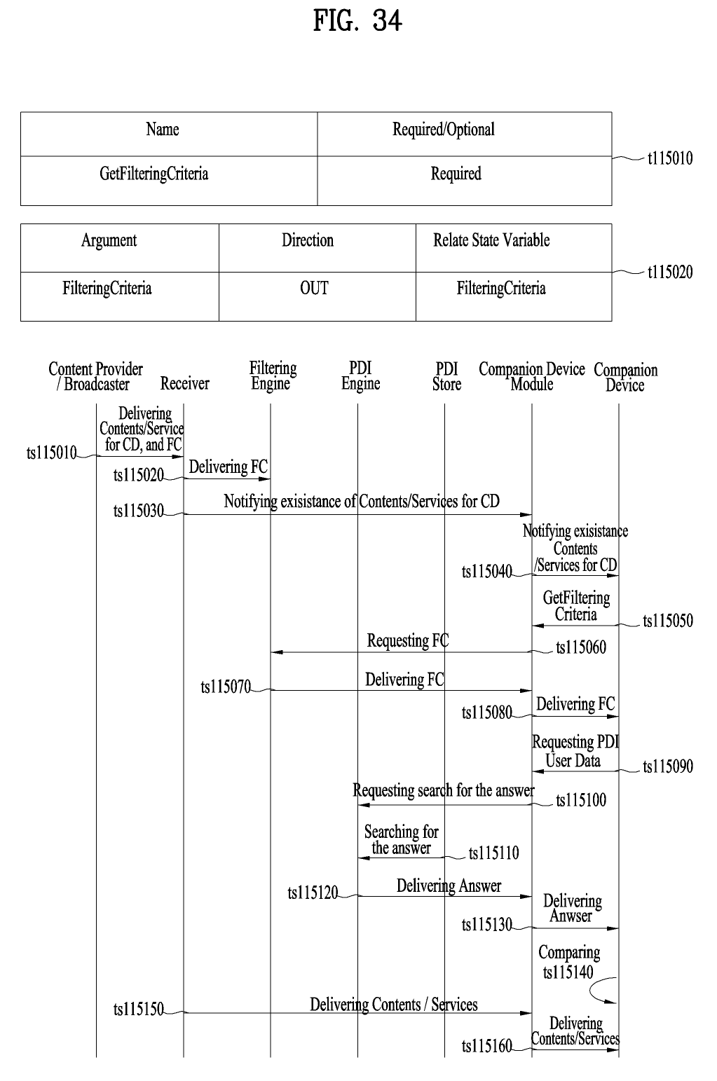

FIG. 34 is a view showing an action of a FilteringCriteria service according to an embodiment of the present invention.

The FilteringCriteria service may have a GetFilteringCriteria action (t115010). This action may be an action for the companion device bringing filtering criteria from the received.

The GetFilteringCriteria action may have FilteringCriteria as an output argument (t115020). This action may be related to the above-described FilteringCriteria state variable. FilteringCriteria may be output to the companion device using this action.

An embodiment of a sequence diagram for providing a personalized service using the operation and filtering criteria of the above-described GetFilteringCriteria action will be described.

In this operation sequence diagram, the companion device and the receiver are already paired with each other. A paring procedure is omitted from the operation sequence diagram.

The content provider or broadcaster may transmit a content or service which will be executed by the companion device to the receiver (ts115010). At this time, the content provider or broadcaster may also transmit FC to the receiver.

The receiver may transmit the FC to the filtering engine (ts115020). In addition, the receiver may notify the companion device module that there is a content/service for the companion device (ts115030). The companion device module may notify the companion device of the same (ts115040).

The companion device module may use the above-described GetFilteringCriteria action (ts115050). The companion device module may request the FC through this action. The FC may be used to refer to PDI user data set by a user before the companion device receives a content/service.

The companion device module may request the FC from the filtering engine (ts115060). The filtering engine may transmit the FC to the companion device module (ts115070). The companion device module may transmit the FC to the companion device (ts115080).

The companion device may request PDI user data from the companion device module (ts115090). The above-described actions may be utilized to request PDI user data.

The companion device module may request answers to questionnaires from the PDI engine (ts115100). The PDI engine may retrieve answers to questionnaires which are already stored in the PDI store (ts115110). The PDI engine may transmit the retrieved answers to the companion device module (ts115120). The companion device module may transmit corresponding answers, which are PDI user data, to the companion device (ts115130).

The companion device module may compare the FC with answers preset by the user (ts115140). In a case in which the FC satisfy the answers, i.e. the PDI user data, of the user, a corresponding content/service may be provided to the user. In a case in which the FC do not satisfy the answers, i.e. the PDI user data, of the user, a corresponding content/service may not be provided to the user.

In a case in which the FC coincide with the answers of the user, the companion device may bring a corresponding content/service from the receiver. At this time, transmission of the corresponding content/service may be performed through the companion device module (ts115150 and ts115160). According to embodiments, in a case in which the FC coincide with the answers of the user, the companion device may directly receive a corresponding content/service from the service provider or broadcaster.

Subsequently, the companion device may expose a content/service having FC suitable for the PDI user data to the user.

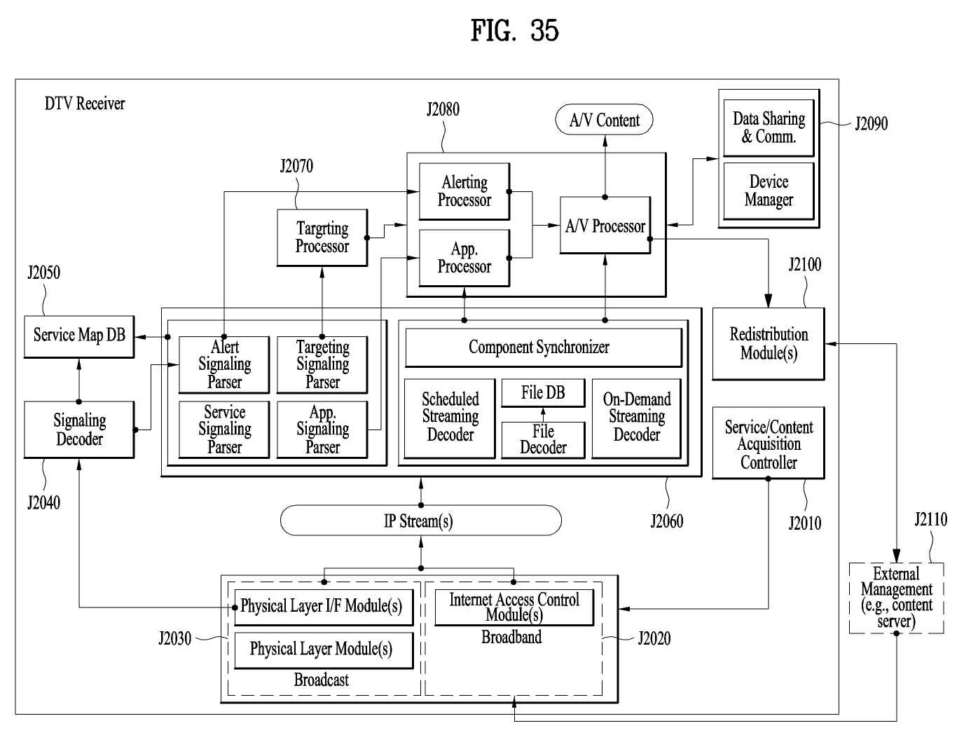

FIG. 35 is a view showing a broadcast receiver according to an embodiment of the present invention.

The broadcast receiver according to the embodiment of the present invention includes a service/content acquisition controller J2010, an Internet interface J2020, a broadcast interface J2030, a signaling decoder J2040, a service map database J2050, a decoder J2060, a targeting processor J2070, a processor J2080, a managing unit J2090, and/or a redistribution module J2100. In the figure is shown an external management device J2110 which may be located outside and/or in the broadcast receiver

The service/content acquisition controller J2010 receives a service and/or content and signaling data related thereto through a broadcast/broadband channel. Alternatively, the service/content acquisition controller J2010 may perform control for receiving a service and/or content and signaling data related thereto.

The Internet interface J2020 may include an Internet access control module. The Internet access control module receives a service, content, and/or signaling data through a broadband channel. Alternatively, the Internet access control module may control the operation of the receiver for acquiring a service, content, and/or signaling data.

The broadcast interface J2030 may include a physical layer module and/or a physical layer I/F module. The physical layer module receives a broadcast-related signal through a broadcast channel. The physical layer module processes (demodulates, decodes, etc.) the broadcast-related signal received through the broadcast channel. The physical layer I/F module acquires an Internet protocol (IP) datagram from information acquired from the physical layer module or performs conversion to a specific frame (for example, a broadcast frame, RS frame, or GSE) using the acquired IP datagram

The signaling decoder J2040 decodes signaling data or signaling information (hereinafter, referred to as ‘signaling data’) acquired through the broadcast channel, etc.

The service map database J2050 stores the decoded signaling data or signaling data processed by another device (for example, a signaling parser) of the receiver.

The decoder J2060 decodes a broadcast signal or data received by the receiver. The decoder J2060 may include a scheduled streaming decoder, a file decoder, a file database (DB), an on-demand streaming decoder, a component synchronizer, an alert signaling parser, a targeting signaling parser, a service signaling parser, and/or an application signaling parser.

The scheduled streaming decoder extracts audio/video data for real-time audio/video (A/V) from the IP datagram, etc. and decodes the extracted audio/video data.

The file decoder extracts file type data, such as NRT data and an application, from the IP datagram and decodes the extracted file type data.

The file DB stores the data extracted by the file decoder.

The on-demand streaming, decoder extracts audio/video data for on-demand streaming from the IP datagram, etc. and decodes the extracted audio/video data.

The component synchronizer performs synchronization between elements constituting a content or between elements constituting a service based on the data decoded by the scheduled streaming decoder, the file decoder, and/or the on-demand streaming decoder to configure the content or the service.

The alert signaling parser extracts signaling information related to alerting from the IP datagram, etc. and parses the extracted signaling information.

The targeting signaling parser extracts signaling information related to service/content personalization or targeting from the IP datagram, etc. and parses the extracted signaling information. Targeting is an action for providing a content or service satisfying conditions of a specific viewer. In other words, targeting is an action for identifying a content or service satisfying conditions of a specific viewer and providing the identified content or service to the viewer.

The service signaling parser extracts signaling information related to service scan and/or a service/content from the IP datagram, etc. and parses the extracted signaling information. The signaling information related to the service/content includes broadcasting system information and/or broadcast signaling information.

The application signaling parser extracts signaling information related to acquisition of an application from the IP datagram, etc. and parses the extracted signaling information. The signaling information related to acquisition of the application may include a trigger, a TDO parameter table (TPT), and/or a TDO parameter element.

The targeting processor J2070 processes the information related to service/content targeting parsed by the targeting signaling parser

The processor J2080 performs a series of processes for displaying the received data. The processor J2080 may include an alert processor, an application processor, and/or an A/V processor.

The alert processor controls the receiver to acquire alert data through signaling information related to alerting and performs a process for displaying the alert data.

The application processor processes information related to an application and processes a state of a downloaded application and a display parameter related to the application.

The A/V processor performs an operation related to audio/video rendering based on decoded audio data, video data, and/or application data.

The managing unit J2090 includes a device manager and/or a data sharing & communication unit.

The device manager performs management for an external device, such as addition/deletion/renewal of an external device that can be interlocked, including connection and data exchange.

The data sharing & communication unit processes information related to data transport and exchange between the receiver and an external device (for example, a companion device) and performs an operation related thereto. The transportable and exchangeable data may be signaling data, a PDI table, PDI user data, PDI Q&A, and/or A/V data.

The redistribution module J2100 performs acquisition of information related to a service/content and/or service/content data in a case in which the receiver cannot directly receive a broadcast signal.

The external management device J2110 refers to modules, such as a broadcast service/content server, located outside the broadcast receiver for providing a broadcast service/content. A module functioning as the external management device may be provided in the broadcast receiver.

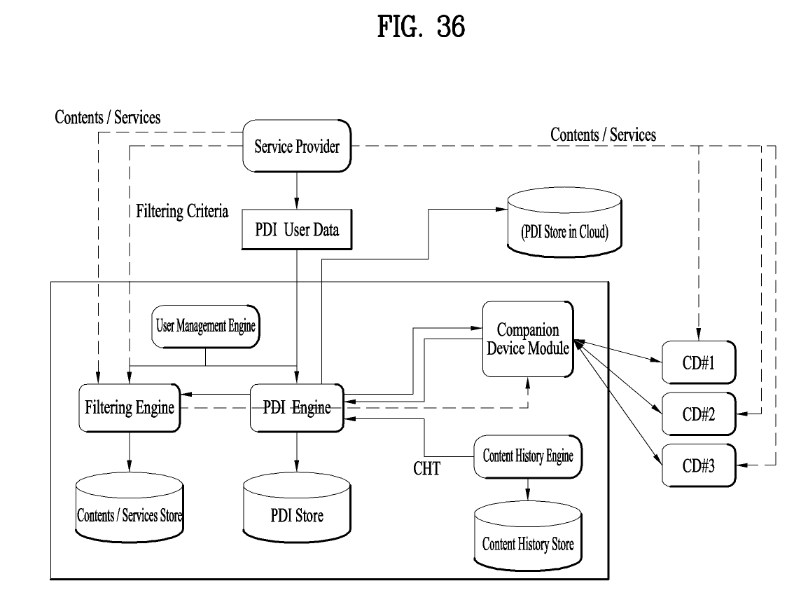

FIG. 36 is a diagram illustrating a receiver further including a content history engine according to another embodiment of the present invention.

The present invention proposes a method of personalizing a service/content using a content viewing history of a user in addition to a method of personalizing a service through a question and an answer. The receiver may generate content viewing history information and provide a personalized service to a user using the information.

In the illustrated structure of the receiver, a service provider, a PDI engine, a PDI store, a PDI cloud store, a companion device module, a companion device, a filtering engine, and a content/service store may the same as those described above.

The structure of the receiver may further include a content history engine and/or a content history store therein. According to an embodiment, the added modules may be located at an external device of the receiver or an external server of the receiver.

The content history engine may serve to monitor, collect, and/or signal information about a service/content viewed by a user. The content history engine may continuously monitor a usage history of a service/content of the user and may generate a content history table including information about viewed services/content. The content history table will be described later. The content history engine may add/delete/update service/content viewing history information of the user to/from/to the content history table. The information about a service/content may be received at the moment when signaling for the service/content is performed. In addition, the content history engine may store the content history table in the content history store. The content history engine may also transmit the content history table to the PDI engine and/or the filtering engine so that the content history table may be referenced for service personalization based on a viewing history. The content history engine may be called a CH (content history) engine and the content history table may be called a CHT (content history table).

The content history store may serve as a store for storing the above-described content history table. The content history store may include information about the viewing history of the service/content of the user. The content history store may be called a CH (content history) store.

The content history engine may not be present as a separate module and may be incorporated into the PDI engine. According to an embodiment, the content history table may use usage reporting data without change or may be generated with reference to necessary information among the usage reporting data. In this case, the content history engine may be replaced or linked with a usage reporting engine. In addition, the content history table may be replaced or linked with a usage reporting store and the content history table may be replaced or linked with the usage reporting data. The illustrated broadcast receiver may have an extended structure to provide a personalized service by factoring in a service/content viewing history. Internal structural modules of the broadcast receiver may be the same as those of the above-described broadcast receiver. The illustrated broadcast receiver may further include a content history processor and a content history DB Each of the internal structure modules may further include a buffer if needed.

The content history processor may serve to generate a table or data for recording information about a service/content viewed by a user. The content history processor may perform an operation corresponding to the above-described content history engine. As described above, the information about the service/content may be received at the moment when signaling is performed. In this case, the received information may be received from a service signaling parser/web signaling parser. Alternatively, according to an embodiment, preknown information may be received from a signaling decoder. The generated content history related table or data may be transmitted to a user data sharing and targeting processor and may be used for personalization of services/content. The user data sharing and targeting processor may perform an operation corresponding to the above-described PDI engine.

The content history DB may serve as a store in which the table of data generated by the content history processor is stored. The content history DB may perform an operation corresponding to the above-described content history store.

According to an embodiment, the content history processor and the content history DB may be replaced or linked with the usage reporting processor and/or the usage reporting DB as described above.

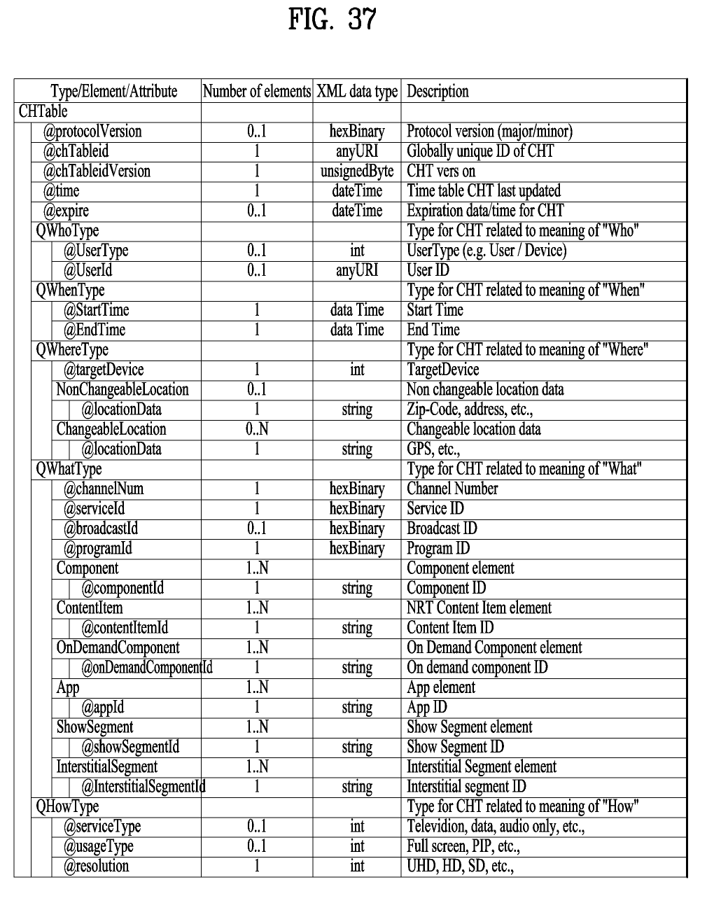

FIG. 37 is a diagram illustrating a content history table according to an embodiment of the present invention.

The content history table may be a table for storing history information of a service/content that a user is viewing or has viewed. The content history table may include not only information about the service/content viewed by a user but also information as to how many times and by which scheme a user has viewed the service/content. The content history table may be used to provide a personalized service/content.

Service/content viewing history information of a user may be automatically stored in the form of a content history table without entry by the user. A procedure of generating the content history table and storing information in the table may be performed by the above-described content history engine. If the content history engine is incorporated into the PDI engine as described above, the PDI engine may perform the above procedure. The service/content viewing history information of the user may be acquired while the service/content is signaled. Alternatively, information capable of being directly acquired by a receiver, such as a GPS, may also be acquired by an API supported by the receiver. The content history table may be generated while the user is viewing a service and may be generated in units of services or programs.

To provide a personalized service using the generated content history table, filtering criteria (FC) corresponding to the content history table may be needed. In providing the personalized service using PDI user data, the PDI user data including a PDI question and an answer may be compared with the FC to determine whether to download a specific service/content. Through this selection procedure, a personalized service can be provided. Even in providing the personalized service using the content history table, a service/content to be downloaded may be selected by comparing the generated content history table with the FC so that the personalized service may be provided.

According to an embodiment, filtering may be performed by referring to the PDI user data of the user as well as the content history. In this case, FC corresponding to the content history table and FC corresponding to the above-described PDI user data are incorporated and then transmitted to a receiver. Alternatively, according to an embodiment, the FC corresponding to the content history table and the FC corresponding to the PDI user data may be separately transmitted to the receiver. FC may be processed by the PDI engine or the filtering engine. If a service/content satisfies both the FC corresponding to the PDI user data and the FC corresponding to the content history table or satisfies only one thereof, the service/content may be set so as to be provided to the user. This may be differently set according to an embodiment. In addition, if the content history table can be changed to the form of the PDI user data, only the FC corresponding to the PDI user data may be transmitted to the receiver.

There may be various methods of configuring the content history table and the FC. The present invention proposes an embodiment of configuring the content history table based on five W's and one H (5W1H). The FC, which will be described later, may also be configured by the same method as the method of configuring the content history table. This method is efficient relative to a method of simply classifying data of the content history table according to IDs and then performing filtering because data is categorized. In the case of filtering using the PDI user data, categorization has been performed according to types of answers. However, in the case of the content history information, it is more efficient to conform to the 5W1H scheme in selecting a service/content.

First, Who, that is, information as to who has viewed the service/content may be included in the content history table. The subject of viewing may be a person (an individual or a group) or may be a device. For example, the subject of viewing may be defined in terms of capability of the device and thus information indicating that a device supporting a resolution of 1920×1080 has viewed the service/content may be included in the content history table. Then, FC may provide a personalized service by filtering features (e.g., sex, etc.) of a person and/or capability of the device.

In addition, When, that is, information as to when the service/content has been viewed may be included in the content history table. A start viewing time/end viewing time of a specific service/content may be specified. According to an embodiment, a duration time of viewing may also be specified.

In addition, Where, that is, information as to where the service/content has been viewed may be included in the content history table. Such information may mean a viewing location (e.g. GPS information). According to an embodiment, Where may mean through which device (e.g. mobile/stationary device) the service/content has been viewed.

Further, What, that is, information as to what has been viewed may be included in the content history table. The object of viewing may be indicated using a channel number, a service ID, or an application ID.

Moreover, How, that is, information as to how the service/content has been viewed may be included in the content history table. When specific content/service is viewed, information as to whether the specific content/service has been viewed through a full screen or a picture-in-picture (PIP) scheme may be included. Alternatively, according to an embodiment, information about resolution of a viewed service may be included.

While a Why part has not been considered in this embodiment, Why information may be included for deep personalization according to an embodiment. In this case, Why, that is, information as to the reason of viewing may be obtained in a manner of acquiring an answer by exposing a question to a user.

The illustrated content history table has been configured according, to the 5W1H scheme and this is purely one embodiment of the present invention. Therefore, the table may be configured by other schemes.

A CHTable element is a root element of the content history table and may include attributes such as @protocolVersion and elements corresponding to 5W1H such asw QWhoType, QWhenType, QWhereType, QWhatType, and QHowType elements.

The @protocol Version attribute may indicate a protocol version of the content history table. This field is optional and may include two hexadecimal digits. Four high-order bits may represent a major version number and Four low-order bits may represent a minor version number.

An @chTableId attribute may indicate the ID of the content history table. This field is a required field and the ID may be globally unique.

An @chTableVersion attribute may indicate the version of the content history table. This field is a required field and may have an initial value of 0. This value may be incremented by 1 with rollover to 0 after 255.

An @time attribute may indicate information about a changed time when there is change in fields of the content history table. This time information may be represented by date and time and this field may be a required field.

An @expire attribute may indicate an expiry time of the content history table. This time information may be represented by date and/or time and this field may be optional. If the expiry time elapses, the content history table is not valid and may be deleted.

The QWhoType element may be an element corresponding to Who of a 5W1H category.

An @userType attribute may indicate a type of a viewing subject. That is, this field may serve to indicate whether the viewing subject is a person or a device (e.g., if this field is 0, this indicates that the viewing subject is a person and, if 1, this indicates that the viewing subject is a device). According to the value of this field, the format of @userId may be changed.

An @userId attribute may include an ID for distinguishing between viewing subjects. The type/format of this field may be changed according to the value of @userType. For example, if a viewing subject is a person, the ID of this field may have the format such as atsc.org/user1. If the viewing subject is a device, the ID of this field may be the ID of a MAC address such as atsc.org/device1:AA:BB:CC:DD:EE:FF. Alternatively, according to an embodiment, the ID of this field may have the format of adding capability of a device such as atsc.org/device1&1920×1080. According to an embodiment, a value indicating an address or an area that distinguishes between viewing, subjects may be the ID.

The QWhenType element may be an element corresponding to When of the 5W1H category.

An @startTime attribute may include information about a viewing start time of specific content. An @endTime attribute may include information about a viewing end time of specific content. The format of these fields may be date and/or time. As described above, viewing duration information may be included in the QWhenType element instead of these fields. Alternatively, according to an embodiment, the duration information added to @startTime and @endTime information may be included in the QWhenType element.

The QWhereType element may be an element corresponding to Where of the 5W1H category.

An @targetDevice attribute may include information about the type of a device that has viewed a specific service/content. For example, a device type such as a TV or a smartphone may be indicated.

A NonChangeableLocation element may be an element for storing non-changeable information out of location information. For example, information such as a zip code may be location information of a non-changeable type. @locationData may include the value of the location information of the non-changeable type.

A ChangeableLocation element may be an element for storing changeable information out of the location information. For example, information such as GPS information may be location information of a changeable type. @locationData may include the value of the location information of the changeable type.

The QWhatType element may be an element corresponding to What of the 5W1H category.

@channelNum, @serviceId, @broadcastId, and @programId may include channel number information, serviceID/contentID information, ID information of a broadcaster, and ID information of a program of a service/content corresponding to a viewing object, respectively.

A Component element may include information about a component of a service/content corresponding to a viewing object and @componentId may include ID information of the object component.

A ContnentItem element may include information about a content item of a service/content corresponding to a viewing object and @contentItemId may include ID information of the object content item. For example, @contentItemId may include the ID of an NRT content item.

An OnDemandComponent element may include information about an on-demand component of a service/content corresponding to a viewing object and @onDemandComponentId may include ID information of the object on-demand component.

An App element may include information about an application of a service/content corresponding to a viewing object and @appId may include ID information about the object application.

A ShowSegment element may include information about a show segment of a service/content corresponding to a viewing object and @showSegmentId may include ID information of the object show segment.

An InterstitialSegment element may include information about an interstitial segment of a service/content corresponding to a viewing object and @interstitialSegmentId may include ID information of the object interstitial segment. For example, @interstitialSegmentId may include the ID of an advertisement.

The QHowType element may be an element corresponding to How of the 5W1H category.

An @serviceType attribute may include information about a service type of a viewed service/content. For example, type information as to whether the viewed service/content is a TV service, data, or content only including audio may be included.

An @usageType attribute may include information about a usage type of a viewed service/content. For example, information as to whether a service has been viewed through PIP or a full screen may be included.

An @resolution attribute may include information about a usage type of a viewed service/content. For example, information as to whether a service has a quality of an ultra high definition (UHD) level, a high definition (HD) level, or a standard definition (SD) level may be included.

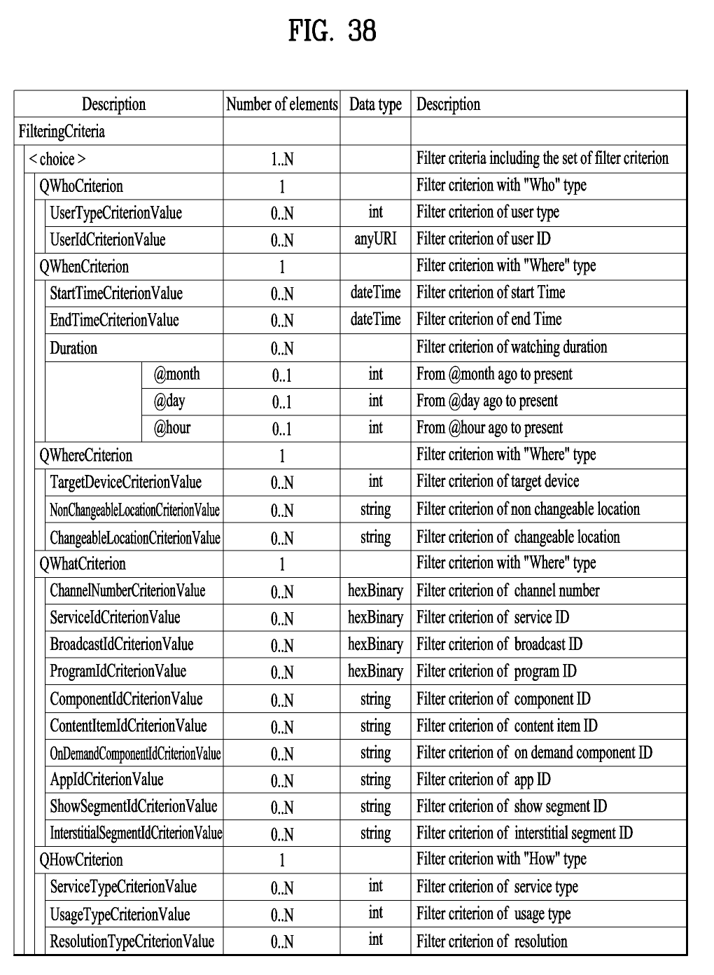

FIG. 38 is a diagram illustrating FC corresponding to a content history table according to an embodiment of the present invention.

As described above, FC may be defined to provide a personalized service by comparison with information of the content history table.

The illustrated FC may be a modified type of FC suitable for the content history table according to the above-described 5W1H scheme. However, the FC does not need to always have a type corresponding to the content history table and a normal type of FC may also be used for comparison with the content history table. In this case, necessary information for comparison may be extracted from information of the content history table.

As described above, a service/content to be downloaded is selected by comparing the content history table with the FC so that a personalized service may be provided.

A FiteringCriteria element may be a root element of the FC. The FilteringCriteria element may include criteria information elements such as QWhoCriteria and QWhereCriteria according to 5W1H. According to an embodiment, the FilteringCriteria element may include at least one criteria information element among criteria information per category such as QWhoCriteria. For example, there may be FC including only three QWhereCriteria elements.

The QWhoCriteria element may be a criteria information element including criteria information corresponding to the content history information of Who.

A UserTypeCriteriaValue element may be a criteria information element corresponding to the @userType attribute of the content history table. That is, this field may include a criteria value for distinguishing between user types (person or device).

A UserIdCriteriaValue element may be a criteria information element corresponding to the @userId attribute of the content history table. That is, this field may include a criteria value for distinguishing between users.

A QWhenCriteria element may be a criteria information element corresponding to content history information of When.

A StartTimeCriteriaValue element may be a criteria information element corresponding to the @startTime attribute of the content history table. That is, this field may include a criteria value for a viewing start time.

An EndTimeCriteriaValue element may be a criteria information element corresponding to the @endTime attribute of the content history table. That is, this field may include a criteria value for a viewing end time.

According to an embodiment, StartTimeCriteriaValue and EndTimeCriteriaValue may specify respective specific times or a duration between StartTimeCriteriaValue and EndTimeCriteriaValue.

A Duration element may be a criteria information element having criteria information about a viewed duration. The viewed duration may indicate the difference between a viewing starting time and a viewing end time. @month, @day, and @hour may be criteria information about a month, day, and hour, respectively and may represent a duration corresponding to criteria information values starting from the current time. For example, if @month, @day, and @hour have values of 3, 2, and 2, respectively, a receiver may perform a comparison operation by searching for a content history table generated during a duration from the past three months, two days, and 2 hours to the current time.

A QWhereCriteria element may be a criteria information element having criteria information corresponding to content history information of Where.

A TargetDeviceCriteriaValue element may be a criteria information element corresponding to the @targetDevice attribute of the content history table. That is, this field may include a criteria value according to a target device.

A NonChangeableLocationCriteriaValue element may be a criteria information element corresponding to the NonChangeableLocation element of the content history table. That is, this field may include a criteria value for non-changeable location information.

A ChangeableLocationCriteriaValue element may be a criteria information element corresponding to the ChangeableLocation element of the content history table. That is, this field may include a criteria value for changeable location information.

A QWhatCriteria element may be a criteria information element corresponding to content history information of What.

A ChannelNumberCriteriaValue element, a ServiceIdCriteriaValue element, a BroadcastIdCriteriaValue element, a ProgramIdCriteriaValue element, a ComponentIdCriteriaValue element, a ContentItemIdCriteriaValue element, an OnDemandComponentIdCriteriaValue element, an AppIdCriteriaValue element, and an InterstitialSegmentIdCriteriaValue element may be elements having criteria information corresponding to the @channelNum, @serviceId, @broadcastId, @programId, @componentId, @comtentId, @onDemandComponentId, @appId, @showSegmentId, and @interstitialSegmentId of the content history table, respectively. Each field may include criteria information about a channel number or ID information. Accordingly, the fields are used to filter a service, a broadcaster, and a program.

A QHowCriteria element may be a criteria information element corresponding to content history information of How.

A ServiceTypeCriteriaValue element may be a criteria information element corresponding to the @serviceType of the content history table. That is, this field may include a criteria value according to a service type.

A UsageTypeCriteriaValue element may be a criteria information element corresponding to the @usageType of the content history table. That is, this field may include a criteria value according to a usage type.

A ResolutionCriteriaValue element may be a criteria information element corresponding to the @resolution of the content history table. That is, this field may include a criteria value according to resolution.

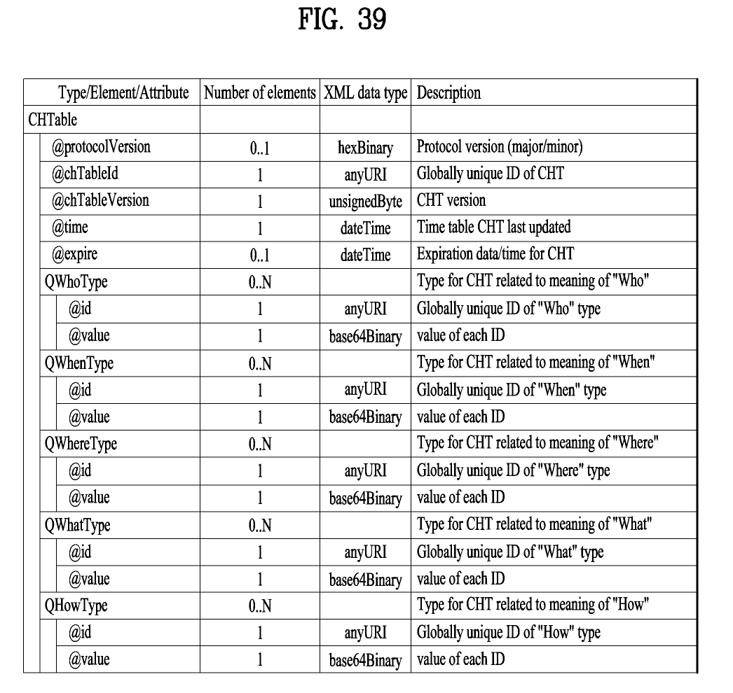

FIG. 39 is a diagram illustrating a simplified content history table according to an embodiment of the present invention.

The above-described content history table may include detailed content history information, such as the QWhoType element, in content history information. The detailed history information, i.e., fields in the content history table may have unique IDs and the content history table may be simplified using the unique IDs.

For example, information about a user ID of the @userID attribute may include ID information such as atsc.org/CHT/user-id and information about a target device of the @targetDevice attribute may include ID information such as atsc.org/CHT/target-device.

To simplify the content history table using the ID information, each ID may be predefined. For example, a criteria indicating that atsc.org/CHT/user-id, which is the ID information of @userID, should belong to a QWhoType element may also be predefined. A method of defining the criteria may differ according to an embodiment.

The illustrated content history table may be a simplified content history table using unique IDs.

Each of QWhoType, QWhenType, QWhereType, QWhatType, and QHowType elements may include @id and @value information. @id may include ID information about a specific content history table field. @value may include a value of a specific content history table field indicated by the ID information.

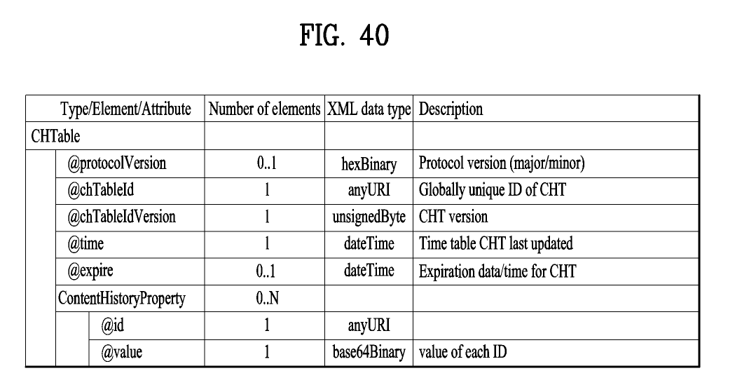

FIG. 40 is a diagram illustrating a simplified content history table according to another embodiment of the present invention.

In addition to the method of simplifying the content history table, the content history table may be further simplified when information as to a category to which IDs of any fields belong is predetermined.

The illustrated content history table may be a further simplified content history table.

A ContentHistoryProperty element may be an element including information about content history information capable of configuring the content history table. Since information about to which category the content history information belongs may be known only by ID information, it may be unnecessary to distinguish between categories according to 5W1H.

@id may be ID information of a content history field. To which category the content history information identified by ID information belongs may be known only by the ID information. @value may include the value of the history information.

For example, if the ID information of @id indicates an @userID field, it may be appreciated by @id information that history information included in the ContentHistoryProperty element is about ID information of a user. In addition, it can also be appreciated that the history information belongs to a Who type by a predefined item. Actual user ID information may be acquired by referring to @value.

FIG. 41 is a diagram illustrating simplified FC corresponding to the content history table according to an embodiment of the present invention.

FC may also be simplified using the simplified method using the ID information. Various detailed criteria information elements may be included in a criteria information element of FC. Each of the detailed criteria information elements may have a unique ID and the FC may be simplified using the unique ID.

The illustrated FC may be simplified FC using the ID information (t174010).

A FilteringCriteria element may be an element having information about the criteria information.

@id may indicate ID information of the criteria information. Through this, associated history information in the content history table may be matched with the criteria information.

@CriteriaType may include information about the type of the criteria information such as Who, When, Where, What, or How. According to an embodiment, if the ID information is classified according to a category, it may be unnecessary to classify the criteria information according to the category.

A CriteriaValue element may include the value of the criteria information identified by @id.

The simplified FC may be configured by a bit stream. The illustrated descriptor may be a descriptor of the simplified FC (t174020). This descriptor may be present in a descriptor loop such as a signaling table transmitted over a broadcast network.

descriptor_tag is a descriptor tag and may be a field indicating that the descriptor is an FC descriptor for selecting a service/content. descriptor_length may indicate the length of the descriptor. num_filter_criteria may indicate the number of criteria information included in the descriptor. Type information, ID information, etc. corresponding to a number indicated by num_filter_criteria may be present in order to represent each criteria information.

criteria_type_code may be a field indicating the type of included criteria information. For example, criteria_type_code of 0x01, 0x02, 0x03, 0x04, and 0x05 may mean Who, When, Where, What, and How types, respectively. Criteria_type_code of 0x00, 0x06, and 0x07 may be reserved for future use. The meaning of each value may differ according to an embodiment.

criteria_id may indicate an ID of the included criteria information. criteria_id_length may indicate the length of the ID of the criteria information. num_criteria_values may indicate the number of criteria values for the criteria information. As many criteria_value_length and criteria_value fields as a number indicated by this field may be present in order to represent each criteria value.

criteria_value may indicate an actual value of the criteria value. criteria_value_length may indicate the length of the criteria value.

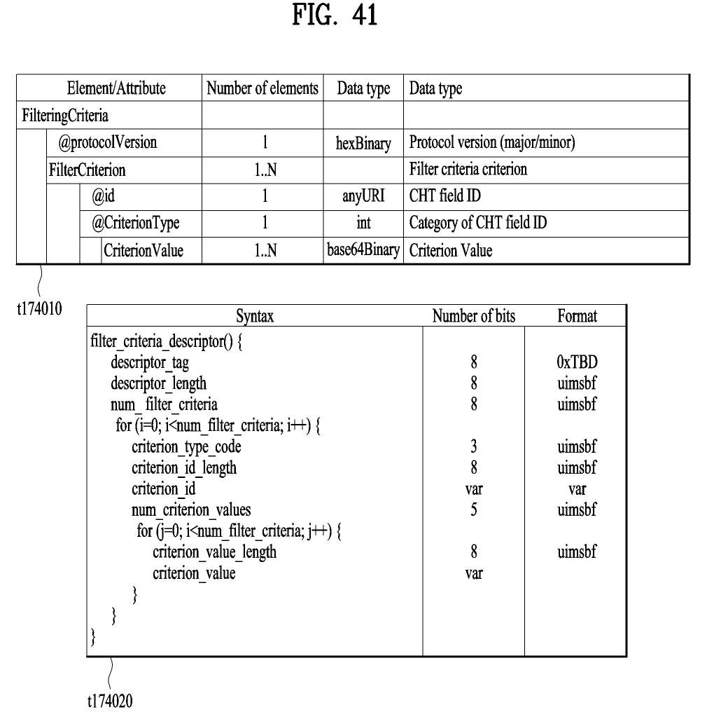

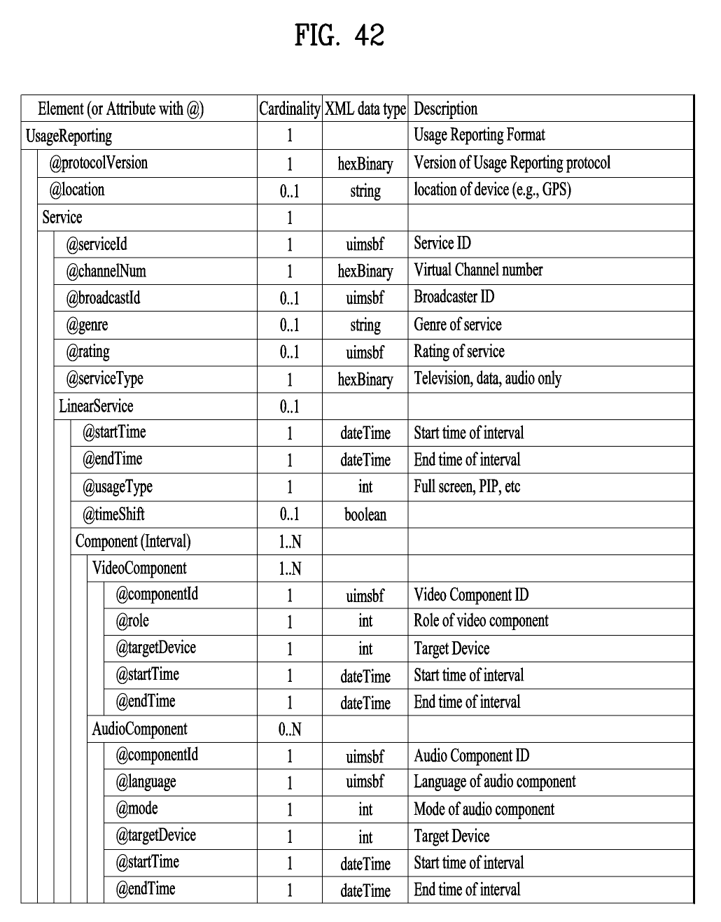

FIG. 42 is a diagram illustrating part of usage reporting data according to an embodiment of the present invention.

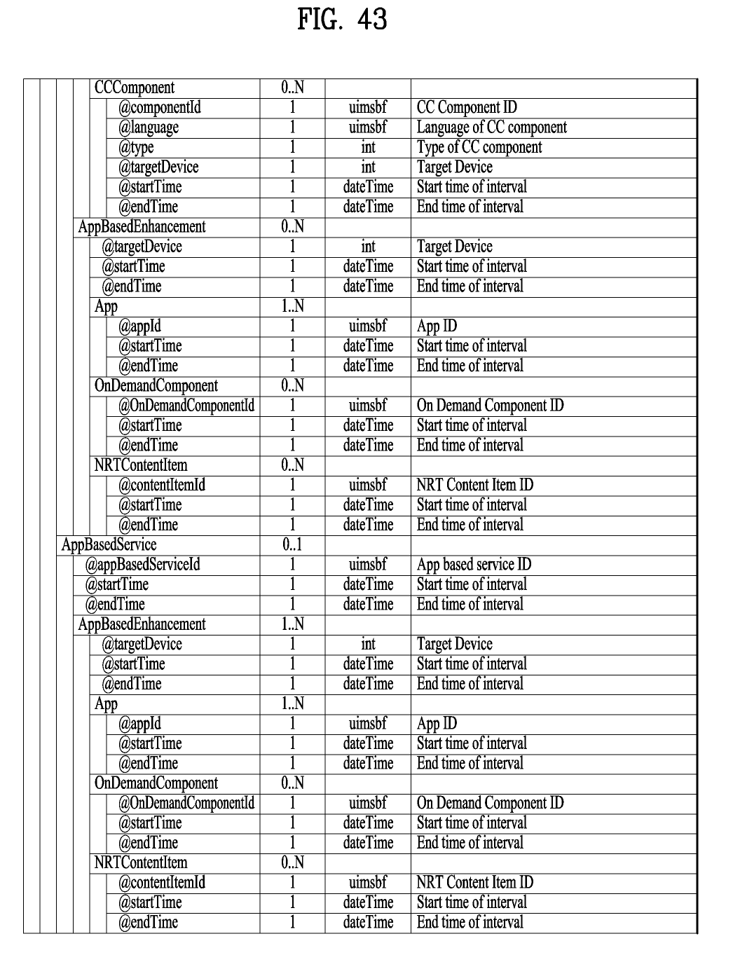

FIG. 43 is a diagram illustrating another part of usage reporting data according to an embodiment of the present invention.

One piece of usage reporting data is separately illustrated in FIGS. 42 and 43 in consideration of the size of the drawings.

As described above, the content history table may use the usage reporting data without change or may be generated by referring to necessary information. If a receiver supports a usage reporting service, part of field values of the content history table may be selected as values of the usage reporting data. If all/some of fields of the content history table are mapped to fields of the usage reporting data, the content history table may be generated by referring to all/some of the field values of the usage reporting data. In addition, the content history table may be replaced with the usage reporting data.

That is, according to an embodiment, if the usage reporting data is used without change as the content history table, the format of the illustrated usage reporting data may be the format of the content history table.

Alternatively, according to an embodiment, if the content history table uses or refers to part of the usage reporting data, the content history table may be used by adding partial fields of the illustrated usage reporting data to the above-described content history table. In this case, part of the illustrated usage reporting data may be used without change as the content history table.

The illustrated usage reporting data is an embodiment of the present invention and the fields may be differently configured.

UsageReporting may be a root element of the usage reporting data. @protocol Version may indicate the version of a usage reporting protocol. @location may include location information of a device, for example, GPS information.

A Service element may include information about a target service on which usage reporting is performed. @serviceId may include ID information of a service, @channelNum may include channel number information, @broadcastId may include ID information of a broadcaster, @genre may include genre information of a service, @rating may include rating information of a service, and @serviceType may include type information of a service.

A LinearService element may include information about a linear service when a service is the linear service. @startTime may indicate a start time of a linear service usage interval. @endTime may indicate an end time of the linear service usage interval. @usageType may include information about in which manner the linear service has been used (e.g., full screen, PIP, etc.). @timeShift may indicate whether time has been shifted.

A Component element may include information related to a component of the linear service. The Component element may include VideoComponent, AuioComponent, and CCComponent elements.

A VideoComponent element may include information related to a video component of the linear service. @componentId may include ID information of the video component, @role may include role information of the video component, and @targetDevice may include information about a target device of the video component. @startTime and @endTime may include information about a start time and an end time at which the video component has been used.

An AudioComponent element may include information related to an audio component of the linear service. Fields having the same names as fields in the VideoComponent element may include similar information with respect to the audio component of the linear service. @language may include language information of the audio component. @mode field may include mode information of the audio component.

A CCComponent element may include information about a closed caption component of the linear service. Fields having the same names as fields in the VideoComponent element may include similar information with respect to the closed caption component of the linear service. @language may include language information of the closed caption. @type field may include type information of the closed caption.

An AppBasedEnhancement element may include usage information about an application based additional service of the linear service. @targetDevice may include information about a target device of the application based additional service. @startTime and @endTime may include information about a usage start time and end time of the application based additional service.

The AppBasedEnhancement element may include an App element, an OnDemandComponent element, and an NRTContentItem element and each application may include information about an on-demand component and an NRT content item. Each of the App element, the OnDemandComponent element, and the NRTContentItem element may include an ID information field for distinguishing between the application, the on-demand component, and the NRT content item and an information field about a usage start time and end time.

The Service element may include an AppBasedService element in addition to the LinearService element. The AppBasedService element may include usage information about an application based service.

@appBasedServiceId of the AppBasedService element may include ID information of the application based service. @startTime and @endTime may include information about a usage start time and end time of the application based service.

The AppBasedService element may include the AppBasedEnhancement element, like the LinearService element. The AppBasedEnhancement element may have the same format as described above.

FIG. 44 is a diagram illustrating a sequence for providing a personalized service using a content history table and FC according to an embodiment of the present invention.

As described above, the content history table may be generated according to a viewing history and a service/content may be selected by comparing the content history table with FC.

First, signaling information about a service/content to be broadcast may be received through a channel such as an SSC or FIC (t177010 and t177020). A signaling parser may parse the received signaling information and transmit the parsed information to a content history engine (t177030).

A content history engine may generate a content history table by referring to the received signaling information (t177040). This content history table may be stored in a content history store.

A receiver may receive FC transmitted through the SSC or the FIC (t177050). In this case, the FC may have the form of the above-described FC descriptor. The FC for the content history table may be present in a descriptor loop of an SMT or NRT-IT service level like existing FC. If the FC is transmitted to an SMT or an NRT-IT, since the FC may be used to filter an NRT service or a content item, the FC may be transmitted through the SSC or the FIC in order to filter a specific service.

The signaling parser parses an FC descriptor and transmits criteria information to the filtering engine (t177060). The filtering engine may request a content history table related to the content history engine using the received criteria information (t177070).

The content history engine may search for a related content history table (t177080) and transmit the content history table to the filtering engine (t177090). The filtering engine may compare the received content history table with the criteria information (t177100). Through this comparison procedure, it may be determined whether the service/content is suitable for the receiver.

If the service/content is suitable for the receiver, the service/content may be downloaded or displayed.

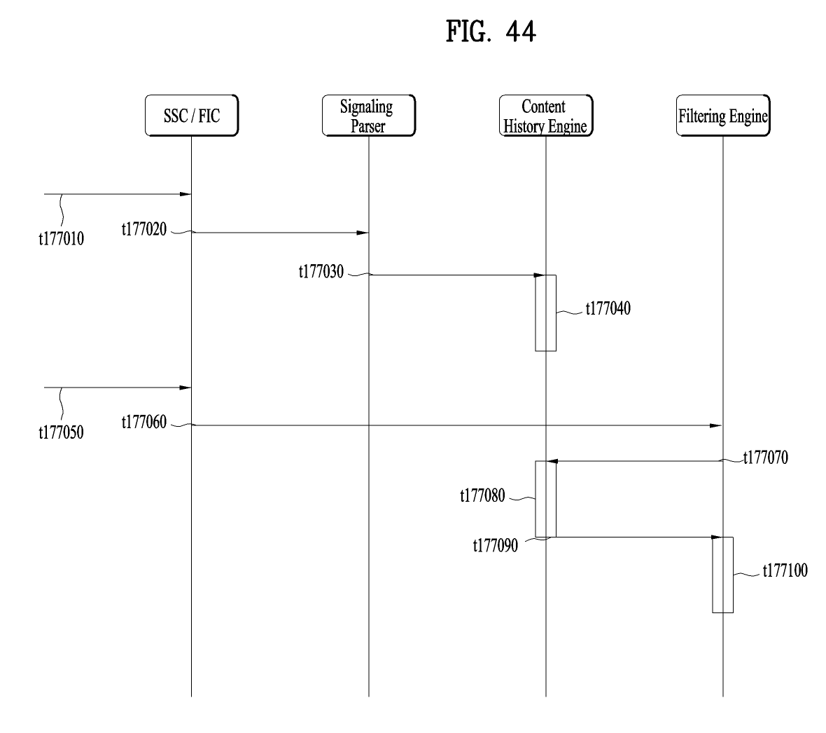

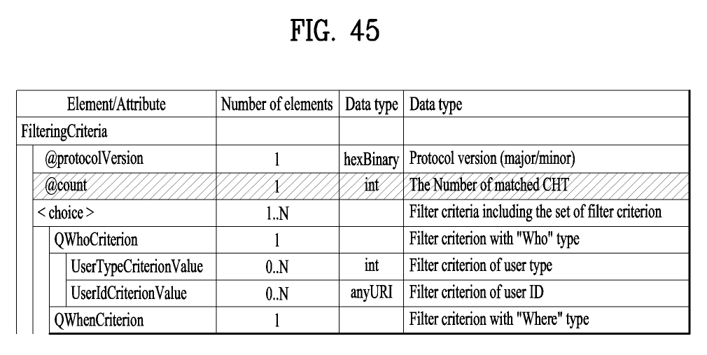

FIG. 45 is a diagram illustrating part of FC including count information according to an embodiment of the present invention.

A method in which a receiver receives FC and compares criteria information of the FC with history information in a content history table will now be described.

The comparison procedure is performed by determining whether specific history information satisfies a criteria value in criteria information associated with the history information. In this case, whether a service/content is suitable for the receiver may be determined by applying AND logic with respect to history information satisfying criteria information. That is, it may be determined that the service/content is suitable for the receiver when the history information should satisfy all of the criteria information.

According to an embodiment, whether the service/content is suitable for the receiver may be determined by applying OR logic with respect to the history information satisfying the criteria information. That is, if the history information satisfies any one of the criteria information, it may be determined that the service/content is suitable for the receiver.

In addition, according to an embodiment, whether the service/content is suitable for the receiver may be determined by applying AND logic with respect to criteria information belonging to different categories (Who, When, etc.) and applying OR logic with respect to criteria information belonging to the same category.

According to an embodiment, AND logic or OR logic may be applied with respect to the criteria information according to intention of a designer.

In particular, a comparison method for criteria information of When type will now be described.

Information such as @startTime and @endTime constituting the criteria information of When type basically indicates a viewing starting time and a viewing end time, respectively. Accordingly, the criteria information of When type may indicate whether viewing has been performed during a time between @startTime and @endTime. However, according to an embodiment, @startTime may be set to indicate whether viewing has been performed from a time indicated by @startTime to a current time and @endTime may be set to indicate whether viewing has been performed from the past to a time indicated by @endTime.

For example, FC in which @startTime==20140101, @endTime==20140501, @channelNum==7-1, @programId==EP00001E001, and @resolution==UHD may be received. This may mean that “a user viewed channel 7-1 or program EP00001E001 from Jan. 1, 2014 to May 1, 2014 with picture quality of UHD”. In this case, AND logic has been applied in the form of “When criteria information AND What criteria information AND How criteria information” and OR logic has been applied in What criteria information as “7-1 channel OR EP00001E001 program”.

Searching is performed to see if a content history table satisfying a condition such as the above example is present. If such a content history table or content history information is present, the corresponding service/content may be downloaded or exposed to a user. If such a content history table is not present, the service/content may not be downloaded or exposed to a user.

The illustrated FC may further include count information as an extended form of the above-described FC.

An a @count attribute is an attribute corresponding to the count information and may include information about the number of content history tables (or content history information or history information elements, such as QWhoType, in the content history table) matched with criteria information. That is, it may be determined that the FC is satisfied only when the number A of content history tables satisfying criteria information included in FC is greater than a number B indicated by @count. That is, only if A is greater than B, the service/content may be downloaded.

If the count information is not included, since the content history table is generated even when a user leaves a viewing history satisfying the FC by chance, accurate service personalization is hindered. That is, if about one content history table is present, it may be determined that the FC is not satisfied and thus efficient personalization may be achieved.

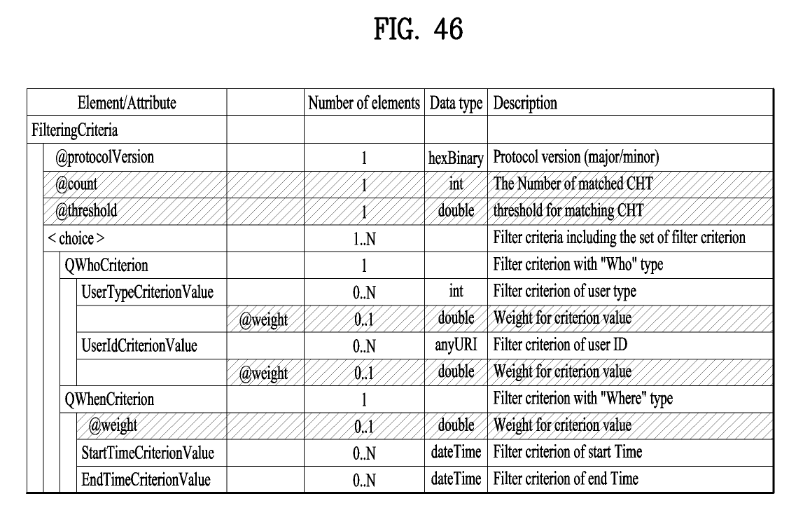

FIG. 46 is a diagram illustrating parting of FC including threshold value information according to an embodiment of the present invention.

In the above-described comparison policies, a service/content is provided only when a content history table satisfying all criteria information of the FC is present. Accordingly, if there are a few content history tables satisfying all criteria information, efficiency is lowered.

To solve this problem, a comparison policy for providing a service/content if a content history table satisfying at least one of criteria information is present may be proposed. However, in this case, since content history tables satisfying the FC excessively increase, efficiency may be lowered.

Therefore, a comparison policy is proposed in which a weight is given to each criteria information and comparison is performed based on the sum A of values obtained by multiplying criteria values of respective criteria information by weight values. To this end, the FC may further include a threshold value B. If A is greater than B, it is determined that the FC is satisfied and the service/content may be provided. According to an embodiment, the sum A may be determined not by the sum of values obtained by multiplying criteria values of respective criteria information by weight values but by the sum of simply adding weight values of matched criteria information may be A.

An @threshold attribute may be an attribute corresponding to the threshold value.

An @weight may be an attribute included in each criteria information and may include a weight value of each criteria information. The weight may be freely set according to intention of a designer. Unlike other categories, in the case of a When type, @weight may be defined as an attribute included in QWhenCriteria rather than in the criteria information. This is because StartTimeCriteriaValue or EndTimeCriteriaValue may mean a specific time. According to an embodiment, in other categories, @weight may be defined as an attribute included in QxCriteria rather than in the criteria information.

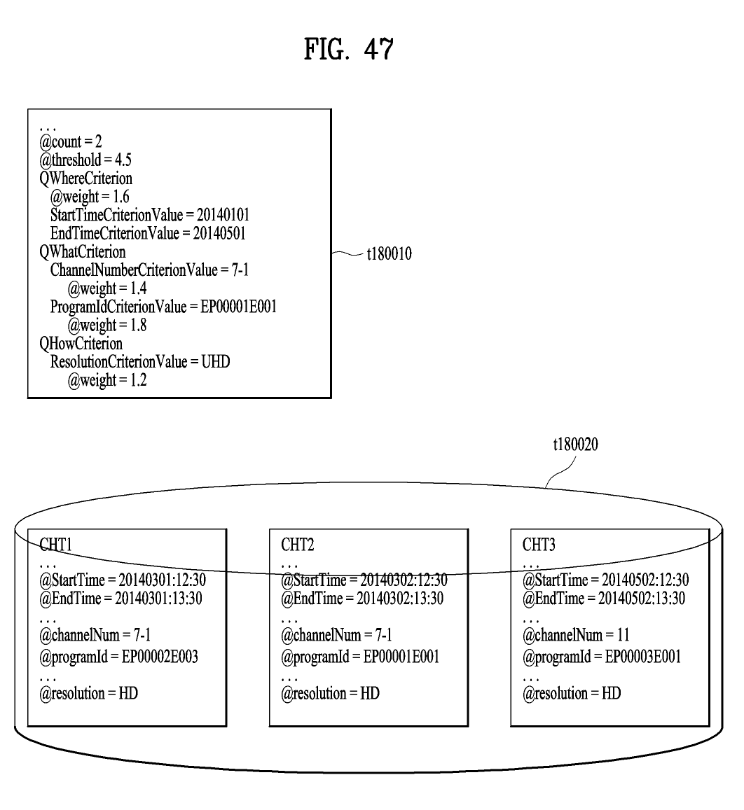

FIG. 47 is a diagram illustrating a comparison procedure in FC including threshold value information according to an embodiment of the present invention.

An embodiment of FC (t180010) and a content history store (t180020) are illustrated.

The comparison procedure may be performed by searching a content history table matched with each criteria information of received FC from a content history store and matching the content history table with criteria information. Even if one content history table matches the criteria information, a result of adding values obtained by multiplying criteria values of matched criteria information by weight values may be calculated.

In this embodiment, it is assumed that a value of simply adding weights of satisfied criteria information is compared with a threshold value.

In the case of CHT1, a viewing duration through @StartTime and @EndTime and @channelNum are matched with criteria information of the FC. The sum of weights of the matched criteria information is 3 (=1.6+1.4) which is lower than a threshold value 4.5. Therefore, it is determined that CHT1 is not a matched content history table.

In the case of CHT2, all criteria information except for @resolution is matched. Accordingly, if the sum of weightings of the matched criteria information is 4.8 (=1.6+1.4+1.8) which is greater than the threshold value. That is, CHT2 is regarded as a matched content history table.

In the case of CHT3, since there is no matched criteria information, a matching procedure may not be performed.

As a result of the comparison procedure, a total of one content history table satisfies the FC. This value is less than 2 indicated by @count. Therefore, a service/content which is expected to be provided is filtered and may not be provided to a user.

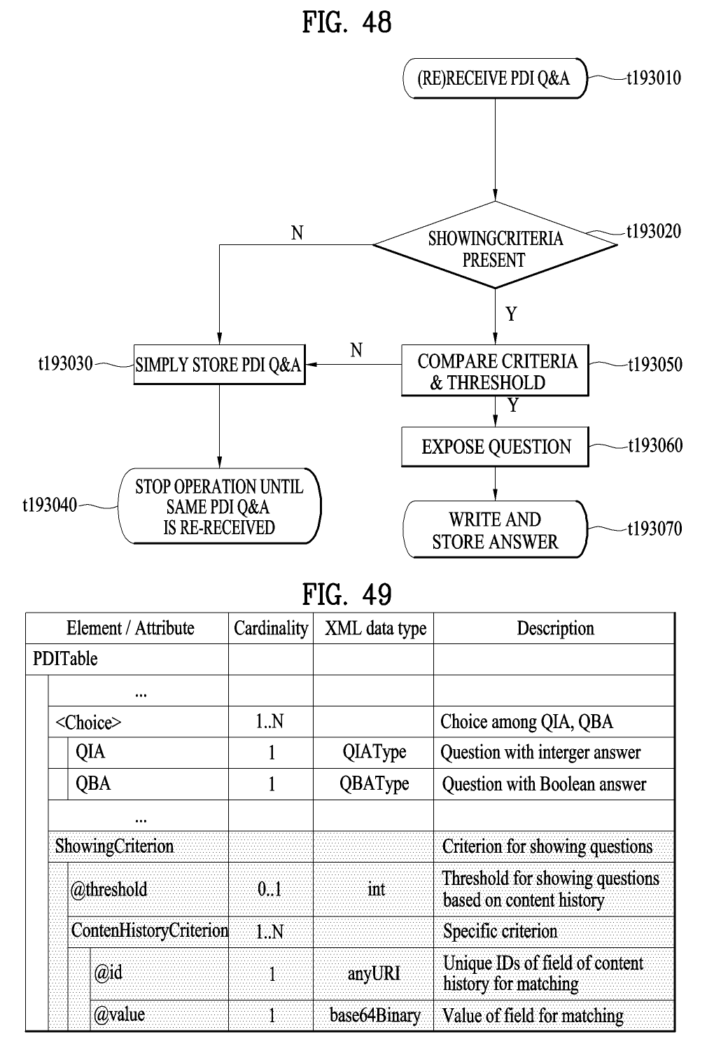

FIG. 48 is a sequence diagram illustrating the case in which criteria information is transmitted through PDI user data when PDI user data is collected based on content history information according to an embodiment of the present invention.

A PDI question of the PDI user data may be unconditionally exposed to a user and an answer may be received. However, in this case, when the corresponding user is interested in the PDI question, the PDI question may not greatly contribute to enhancement of a viewing environment. For example, when a question “What is your favorite baseball team?” is shown to a user who does not like baseball, this operation is collection of meaningless PDI user data, increasing system load.

To overcome this, the present invention proposes a method of exposing a PDI question based on content history information, i.e., viewing information of a user. The corresponding PDI question may be exposed to the user and PDI data may be collected/stored only when a predetermined condition is satisfied using the stored content history information. In addition, when the aforementioned threshold value related characteristics are added and the number of content history information items satisfying a predetermined condition exceeds a threshold value, the corresponding PDI question may be exposed to the user. Here, the content history information may refer to the aforementioned content history table (CHT) and information in the content history table.

Although modified in some embodiments below, PDI user data collection based on basic content history information may be performed in an order of PDI question reception, content history information search/comparison, and/or exposure/non-exposure of a question. First, PDI user data with a PDI question may be received. Whether the corresponding PDI question is exposed may be determined via comparison between specific criteria information of the corresponding PDI question and the content history information. Here, the specific criteria information may indicate, for example, a condition such as “the case in which baseball is watched four times (threshold) or more for one week”.

When there is no content history information that satisfies a condition of the specific criteria information, i.e., when exposure of the corresponding PDI question is determined to be meaningless based on a viewing history, the corresponding question may not be exposed to the user. When there is content history information that satisfies the specific criteria information, the corresponding PDI question may be exposed to the user and a PDI answer may be written and stored in PDI user data.

When the PDI user data is collected based on the content history information, criteria information for determining whether the PDI question is exposed may be transmitted in the PDI user data and the PDI question. In some embodiments, the criteria information may be transmitted in filtering criteria.

The case in which criteria information for exposure of the PDI question is transmitted in the PDI user data will be described below.

First, the PDI user data (=PDI table, PDI Q&A) may be received (t193010). A broadcaster or a service provider may transmit question exposure criteria information in the PDI user data to a receiver. The PDI user data may be periodically or aperiodically and repeatedly received.

The receiver may first check whether the question exposure criteria information is present in the received PDI user data (t193020). Here, the question exposure criteria information may be represented by a ShowingCriteria element. Configurations of the element and the question exposure criteria information in the PDI user data will be described below.

When question exposure criteria information is not present in the received PDI user data, the corresponding PDI user data may be simply stored rather than being exposed (t193030). Then, until PDI user data with the same PDI user data and the same PDI question is re-received, the receiver may stop an operation for the corresponding PDI user data (t193040). When the same PDI user data is re-received later, a comparison operation may be performed according to the illustrated logic to expose/non-expose the PDI user data. When the re-received PDI user data is pre-stored, the re-received PDI user data may be deleted rather than being redundantly stored.

When the question exposure criteria information is presented in the received PDI user data, the question exposure criteria information may be compared with the pre-stored content history information (t193050). When there is content history information that satisfies all conditions of the corresponding question exposure criteria information or the number of content history information items that satisfy all conditions is equal to or greater than a threshold value, the corresponding PDI question may be exposed to a user (t193060). The user may write an answer to the corresponding PDI question and the receiver may store the answer in the PDI user data and keep the answer a PDI store or the like (t193070).

When content history information that satisfies all conditions of the corresponding question exposure criteria information is not present or a smaller number of content history information items than the threshold value is present, the receiver may simply store the information instead of exposing the information (t193030). Similarly, until the PDI user data is re-received, an operation for the corresponding PDI user data may be stopped (t193040).

FIG. 49 is a diagram illustrating a configuration of PDI user data when criteria information is transmitted through the PDI user data during collection of PDI user data based on content history information according to an embodiment of the present invention.

The criteria information for determining whether the aforementioned PDI question is exposed may be included as one element in the PDI user data according to the aforementioned embodiments. The element may be the aforementioned ShowingCriteria element.

The form of the criteria information in the PDI user data may be changed according to a form for storing the content history information. As described above, in the case of the content history information and the content history table, internal information may be configured using a 5W1H scheme, a type according to 5W1H may be divided with detailed items of values of @id and @value, or the type may be simply divided with values of @id and @value. In order to correspond thereto, the question exposure criteria information may also be configured to be divided according to 5W1H, may conform to 5W1H with detailed items being divided using an ID, or may be configured to be divided using only an ID without being divided for each type. For example, when the content history information is stored, if an ID for each field is not determined, a name of each field instead of an ID may be directly determined.

The illustrated question exposure criteria information may be an embodiment configured to correspond to content history information that is divided using only an ID without being divided for each type. This is merely an embodiment and the present invention is not limited to this configuration. In addition, the remaining portions of the PDI user data except for the ShowingCriteria element may be combined with the aforementioned various embodiments of the PDI user data.

The PDI user data may include the ShowingCriteria element. The element may include question exposure criteria information items for determining whether PDI questions of the corresponding PDI user data are supposed to be exposed to a user. The element may include an @threshold attribute and/or at least one ContentHistoryCriteria element.

The ContentHistoryCriteria element may be detailed criteria information for comparison with the content history information. The element may indicate fields to be used for comparison among fields included in the stored content history information. The elements may each include @id and @value.

@id may indicate a unique ID of a field to be used for comparison of content history information. For reference, when the content history information is stored, the fields need to have unique IDs, respectively. For example, a ChannelNumber field may have a unique ID with the form such as atsc.org/CHT/ChannelNumber.

@value may indicate a value of a field identified according to @id, i.e., a value of a field to be used for comparison of content history information. Comparison with content history information using the value may be performed.

@threshold may indicate a threshold value of content history information that satisfies all criteria information items to be used to determine whether data matches. When the number of viewing history information (CHT) items that satisfy all detailed criteria information items indicated by ContentHistoryCriteria elements is equal to or greater than a threshold value indicated by @threshold, it may be determined that the corresponding PDI user data matches content history information. When the PDI user data is determined to match the content history information, PDI questions of the corresponding PDI user data may be exposed to the user. The current field may not be present and, when the current field is not present, whether PDI user data matches content history information may be determined according to whether viewing history information satisfying all detailed criteria information items is present.

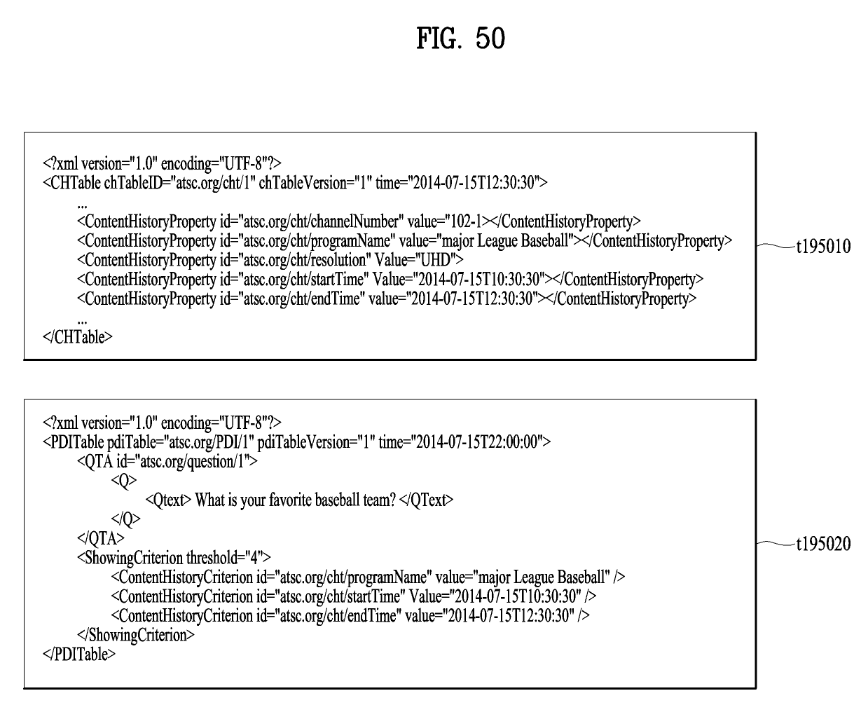

FIG. 50 is a diagram illustrating examples of content history information and PDI user data when criteria information is transmitted through the PDI user data during collection of PDI user data based on content history information according to an embodiment of the present invention.

First, the illustrated content history information t195010 may indicate information indicating that a viewer views a program “Major League Baseball” of channel #102-1. Here, a value of a field identified according to an ID of “atsc.org/cht/channelNumber” is “102-1” and, thus, it may be seen that a viewed channel number is 102-1. A value of a field identified according to “atsc.org/cht/programName” is “Major League Baseball” and, thus, it may be seen that a name of a viewed program is Major League Baseball. A value of a field identified according to an ID of “atsc.org/cht/resolution” and, thus, it may be seen that UHD image quality is used for viewing. A value of a field identified according to an ID of “atsc.org/cht/startTime”, “atsc.org/cht/endTime” is “2014-07-15T10:30:30” and “2014-07-15T12:30:30”, respectively, and, thus, it may be seen that viewing is performed from 10:30:30 to 12:30:30 of Jul. 15, 2014. The content history information may be pre-stored in a receiver or the like and the form of the stored content history information may be changed in some embodiments.

PDI user data t195020 including the next illustrated question exposure criteria information may include a PDI question of “What is your favorite baseball team”. As detailed criteria information of question exposure of the PDI user data, a program name, a viewing start time, and a viewing end time may be proposed. Here, detailed criteria information identified according to an ID of “atsc.org/cht/programName” may be “Major League Baseball” and values of a field identified according to IDs of “atsc.org/cht/startTime” and “atsc.org/cht/endTime” may be “2014-07-08T22:00:00” and “2014-07-15T22:00:00”, respectively. A value of @threshold may be 4. This may be interpreted to mean “a Major League Baseball program is watched four times or more between 22:00 on Jul. 8, 2014 and 22:00 on Jul. 15, 2014”.

The illustrated content history information t195010 may satisfy all conditions of the illustrated question exposure criteria information. Accordingly, when three or more content history information items are further retrieved, the corresponding PDI user data may be determined to satisfy content history information. When a total number of content history information items satisfying all conditions is equal to or greater than 4, the corresponding PDI question may be exposed.

FIG. 51 is a sequence diagram illustrating the case in which criteria information is transmitted through filtering criteria during collection of PDI user data based on content history information according to an embodiment of the present invention.

Question exposure criteria information for determining whether the PDI question is exposed may be transmitted in other signaling information but not PDI user data. The question exposure criteria information may be transmitted in signaling information such as SMT or EIT and signaling information into which the question exposure criteria information is to be inserted may be changed in some embodiments.

According to an embodiment of the present invention, the question exposure criteria information may be transmitted in the filtering criteria to the receiver. First, filtering criteria of a type for determining whether a question is exposed may be received by the receiver (t196010). The receiver may compare question exposure criteria information in the filtering criteria with the stored content history information (t196020). The comparison procedure may be the same as the aforementioned procedure. When the question exposure criteria information in the filtering criteria does not match the content history information, the corresponding filtering criteria may be disregarded (t196030).

When the question exposure criteria information matches the content history information, the receiver may determine whether the filtering criteria are used to determine whether the PDI question is exposed (t196040). This may be indicated by an @filteringCriteriaType field to be described later. When the filtering criteria are not determined to be used to determine whether the PDI question is exposed, the corresponding filtering criteria may be filtering criteria of a general case. In this case, the receiver may perform a process using general filtering criteria (t196050). Here, the general filtering process may refer to a process of comparing pre-stored PDI user data and received filtering criteria to determine whether corresponding service/content is supposed to be received, as described above. Here, the filtering criteria are already compared with the content history information and, thus, it may be deemed that filtering based on a viewing history of a viewer is already performed.

When corresponding filtering criteria are determined to be filtering criteria for determining whether a PDI question is exposed, the receiver may expose a PDI question of PDI user data indicated by a target question indicator (t196060). Here, the target question indicator may be a field included in the filtering criteria along with the question exposure criteria information and may correspond to @targetQuestionTableId to be described later. The user may answer the exposed question and the receiver may store the corresponding answer in the PDI user data and keep the answer in a PDI store (t196070).

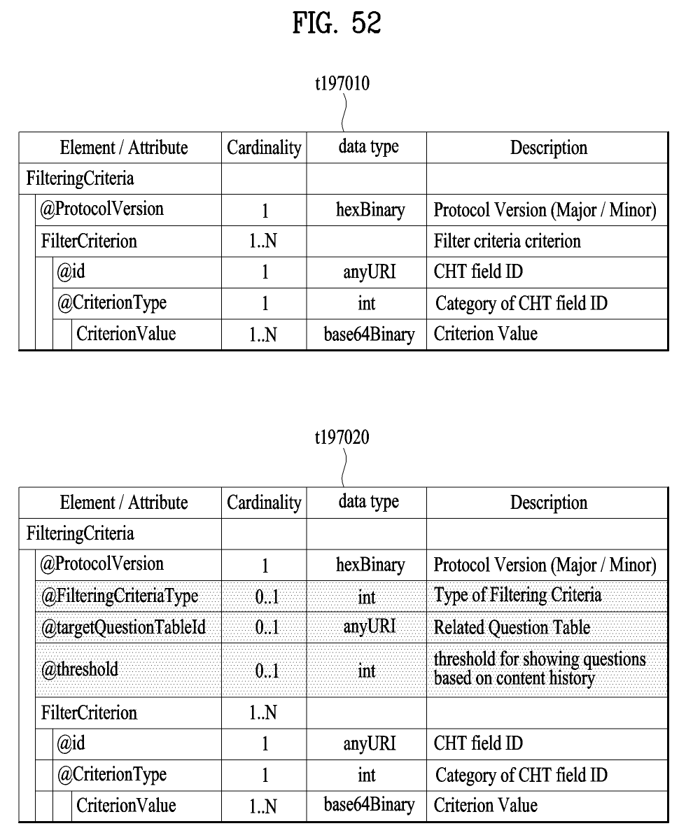

FIG. 52 is a diagram illustrating a configuration of filtering criteria when criteria information is transmitted through filtering criteria during collection of PDI user data based on content history information according to an embodiment of the present invention.

The criteria information for determining whether the aforementioned PDI question is exposed may be received in the filtering criteria according to the aforementioned embodiments of the present invention. Here, existing filtering criteria may be extended such that general filtering criteria operates as filtering criteria including exposure criteria information of a PDI question.

The illustrated filtering criteria t197010 may be one of the aforementioned configurations of the general filtering criteria. The filtering criteria may be filtering criteria for service/content filtering based on content history information. The configuration has been described above.

Filtering criteria t197020 formed by extending the general filtering criteria t197010 will also be illustrated. The extended filtering criteria may further include type information, a target question indicator, and/or threshold value information. Existing criteria information items (FilterCriteria element) for service/content filtering may be used as criteria information items for determining whether a PDI question is exposed according to values of added fields.

The extended filtering criteria may further include an @filteringCriteriaType field. The field may indicate a type of the corresponding filtering criteria. The field may determine whether corresponding filtering criteria are used to filter service/content or application or to determine whether a PDI question is exposed. For example, when the field has a value of 0, the filtering criteria may be used to filter service/content and when the field has a value of 1, the filtering criteria may be used to determine whether the PDI question is exposed. The current field may be an optional field and may have an integer (int) data type.

When the filtering criteria are used to determine whether the PDI question is exposed, FilterCriteria elements of the filtering criteria may function as the aforementioned question exposure criteria information. When fields of content history information identified according to @id of the corresponding elements are types indicated by @CriteriaType and the corresponding value corresponds to CriteriaValue, it may be deemed that a criteria of the corresponding detailed exposure criteria information is satisfied. Whether matching is achieved may be determined according to whether there is content history information satisfying all conditions of the FilterCriteria elements or whether the number of content history information items satisfying all conditions is greater than a threshold value.

The extended filtering criteria may further include an @targetQuestionTableId field. When question exposure criteria information of the corresponding filtering criteria matches content history information, the field may indicate a PDI question to be exposed. The field may correspond to the aforementioned target question indicator. The field may be used when the corresponding filtering criteria are types for determining whether the PDI question is exposed. The field may be an optional field and may have a specific URI data type.

The extended filtering criteria may further include an @threshold field. The field may indicate a threshold value for determining whether matching is achieved. The field may be an optional field and may have an integer (int) data type.

Like PDI user data, a form of the question exposure criteria information in the filtering criteria may also be changed according to the form for storing the content history information. Filtering criteria according to each form of the content history information has been described already. The illustrated filtering criteria may correspond to a form for configuring internal criteria information using only an ID without being divided for each type. The aforementioned other types of filtering criteria may be extended to determine whether the PDI question is exposed. The illustrated form is merely an embodiment and the present invention is not limited to the configuration.

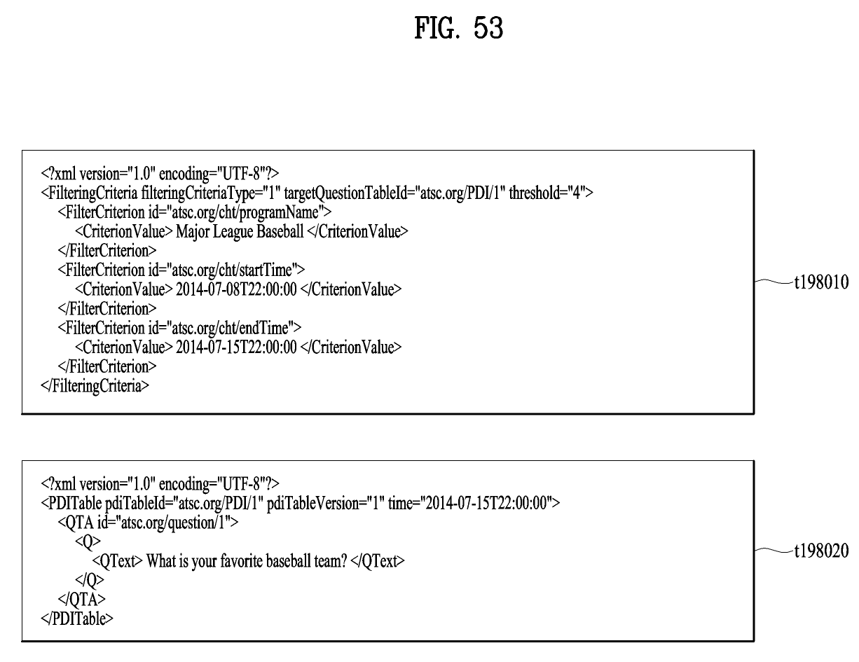

FIG. 53 is a diagram illustrating an example of filtering criteria when criteria information is transmitted through filtering criteria during collection of PDI user data based on content history information according to an embodiment of the present invention.

First, the illustrated filtering criteria t198010 may have 1 as a filteringCriteriaType value and may be filtering criteria for filtering whether a PDI question is exposed. As detailed exposure criteria information of the illustrated filtering criteria, a program name, a program name, a viewing start time, and a viewing end time may be proposed. Here, detailed criteria information identified according to an ID of “atsc.org/cht/programName” may be “Major League Baseball” and values of a field identified according to IDs of “atsc.org/cht/startTime” and “atsc.org/cht/endTime” may be “2014-07-08T22:00:00” and “2014-07-15T22:00:00”, respectively. A value of @threshold may be 4. This may be interpreted to mean “a Major League Baseball program is watched four times or more between 22:00 on Jul. 15, 2014 and 22:00 on Jul. 8, 2014”.

A receiver or a content history engine may search for content history information that satisfies a corresponding condition and is stored in a content history store. When four or more content history information items satisfying all conditions are retrieved, the illustrated question exposure criteria information may be determined to match the content history information.

When matching is achieved, a PDI question indicated by targetQuestionTableId of filtering criteria may be exposed to a user. In this case, an ID of the PDI user data is “atsc.org/PDI/1” and, thus, a PDI question of the corresponding PDI user data t198020 may be exposed. That is, a question of “What is your favorite baseball team” may be exposed to the user.

When matching is achieved, if the corresponding PDI question is not stored in the receiver, the corresponding PDI question may not be exposed in some embodiments. Alternatively, in some embodiments, a server may be requested for a corresponding PDI question and the question may be received through broadband and, then, exposed to the user.

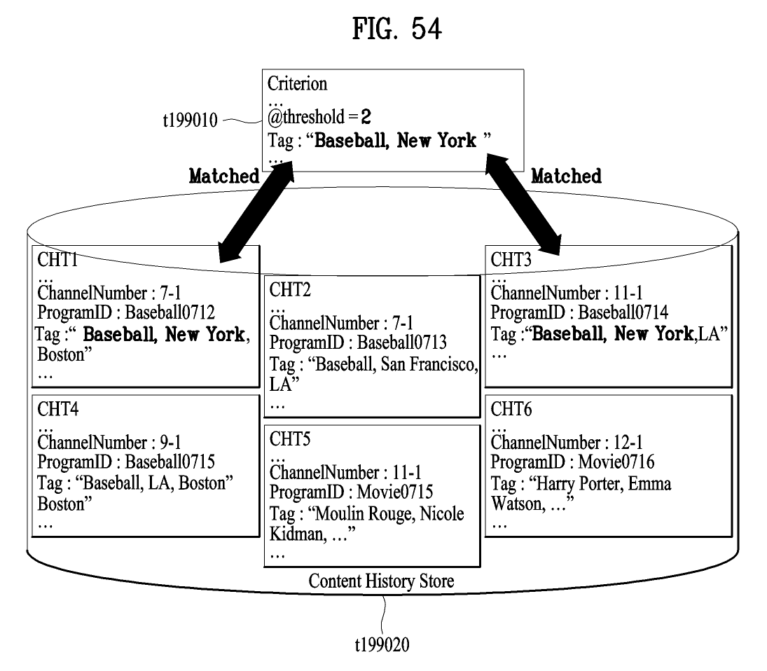

FIG. 54 is a diagram illustrating the case in which content history information is simplified using a heuristic method according to an embodiment of the present invention.

When a PDI question is exposed based on a viewing history of a user, a detailed level for the condition may be required. For example, a leveled condition such as “the case in which baseball of a team from New York is watched four times or more in one week” may be required. To this end, related information items need to be categorized from signaling (e.g., team or sporting event). However, when all information items on a broadcast program are categorized, an unlimited number of cases may be used and it may be actually difficult to define and standardize all the information items. To overcome this problem, a heuristic method, a method using EIT, a web-based method, and so on may be used.

First, the heuristic method may use a tag. During signaling, a tag field may be added to a signaling table and transmitted. A data type of a tag may be defined in various forms. For example, when a data type of a tag is a string, a series of information items such as “Baseball, New York, Boston, Yankees, and Red Socks” may be included. A broadcaster and a content provider may freely add all desired information items in a tag field. The receiver may parse a signaled tag field and the content history engine may also store the corresponding tag without changes while storing content history information. When whether the question is exposed is filtered or content/services are filtered, these tags may be used. Search and matching are possible via entire or partial character string matching during tag search and, thus, various level of format of content history information may not be required. In addition, simple character string matching is possible when a content history is stored using this method and, thus, a scheme such as natural language processing or text mining may not be required.

In order to overcome the aforementioned problem, EIT may be used. A Title field among information items transmitted through the EIT may be used in the same way as the tag field in the aforementioned heuristic method. That is, when a value of the Title field is set and stored according to preference of a broadcaster or a content provider, the receiver may store a corresponding value as one field of the content history information without change. Then, a matching procedure may be performed by searching for and comparing corresponding fields while a question is exposed or content/services are filtered.

As another method, a web-based method may be used. This may be a form in which an application for PDI question and answer is transmitted to the receiver and the PDI question and answer are performed through the application. The application may be managed by an application server. First, filtering criteria for the application may be transmitted to the receiver. The receiver may compare content history information and filtering criteria and receive a corresponding application when the content history information and the filtering criteria match. The application may be exposed to a user and an answer of the user through the application may be managed by an application server. In this case, it may not be necessary to separately receive and store a question.

The illustrated embodiment is performed by the aforementioned heuristic method. The received question exposure criteria information t199010 may have a @threshold value of 2 and have “Baseball, Newyork” as a tag value. The receiver may store the content history information using a tag value with respect to service viewing of the user. Here, the tag values may be received simultaneously when signaling is performed on a service. For example, a content history store t199020 may store six content history information items. CHT1 may include tag information such as “Baseball, Newyork, Boston . . . ” and CHT2 may include tag information such as “Baseball, San Francisco, LA . . . ”. The tag information items may be related to service viewing, indicated by the corresponding content history information. That is, CHT1 may indicate that a service related to Newyork, Boston, and Baseball is viewed. Content history information including a tag “Baseball, Newyork” as a tag included in the question exposure criteria information may be CHT1 and CHT3. Two of the content history information items greater than a threshold value 2 satisfy a condition of the question exposure criteria information and, thus, the corresponding PDI question may be exposed to the user.

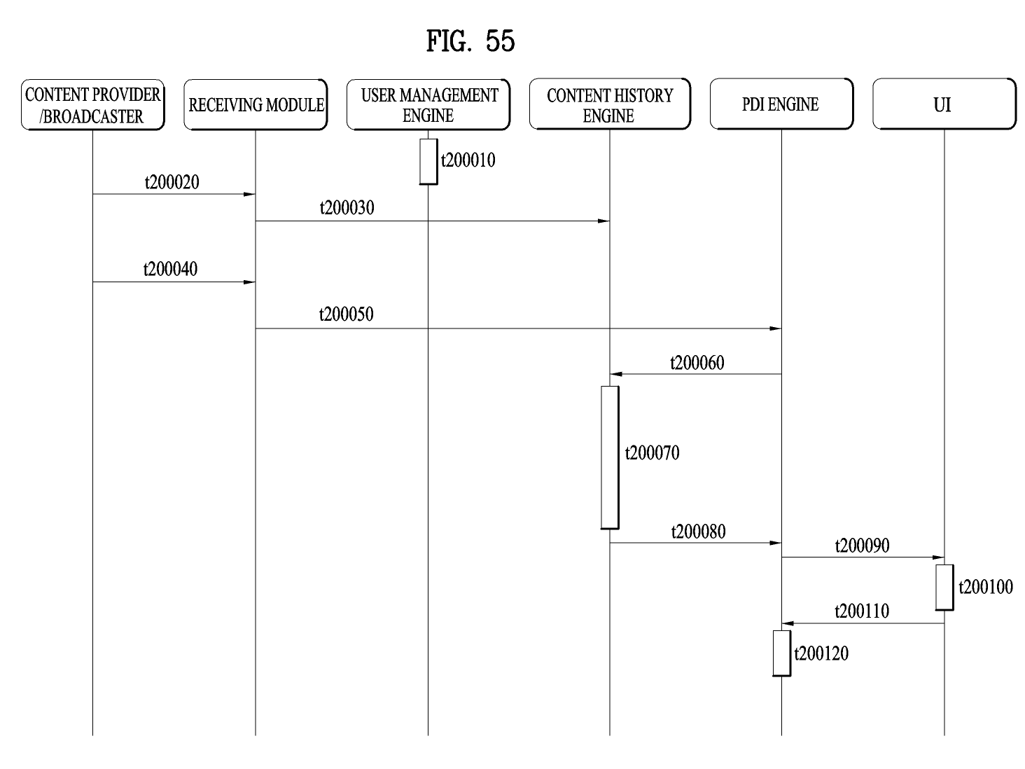

FIG. 55 is a diagram illustrating a procedure of collecting PDI user data based on simplified content history information using a heuristic method according to an embodiment of the present invention (criteria information is transmitted through PDI user data).

First, a user management engine/module may perform a login process (t200010). A receiver for providing a function of identifying a user may perform personalization for a specific user through the login process. In this case, a user ID for identifying each user may be added to PDI user data. This operation may be omitted.

The receiving module may receive signaling information on a service from the content provider and the broadcaster (t200020). The signaling information may have a tag field with tag information. For example, in the case of a service of baseball, information of “Basebal, Newyork. Boston, Yankees, Red Socks” may be included.

The receiving module may parse the received signaling information and show a corresponding service to the user. The parsed signaling information may be transmitted to a content history engine/module (t200030). While storing viewing information of the user, the content history module may store the received tag information together.

The receiving module may receive PDI user data (PDI table) from the content provider and the broadcaster (t200040). The PDI user data may include the aforementioned question exposure criteria information. Here, the question exposure criteria information may be tag information based on a heuristic method. For example, information such as “Baseball, Newyork” may be included. The PDI user data may be transmitted to the receiver through a broadcast network or a broadband. For example, when a viewer wants to show a corresponding PDI question in “the case in which a New York game of baseballs is viewed four or more times”, @threshold may be set to 4 and a tag value as question exposure criteria information may be set to “Baseball, New York”.

The receiving module may transmit the received PDI user data to a PDI engine (t200050). The PDI engine may parse the PDI user data and, then, transmit the question exposure criteria information and the threshold value to the content history engine in order to determine whether matching is achieved (t200060). The content history engine may search for content history information that satisfies conditions based on the transmitted information items (t200070). In this case, search may be performed using the tag information. A procedure of determining whether matching is achieved has been described above. The content history engine may transmit the matching result to the PDI engine (t200080).

The PDI engine may expose the PDI question of the corresponding PDI user data to the user through a UI when matching is achieved (t200090). The user may answer a question through the UI (t200100) and the PDI engine may receive the corresponding answer (t200110) and store the answer in the PDI user data of the PDI store (t200120).

Each of the aforementioned operations may be omitted or replaced with another operation with the same or similar function in some embodiments.

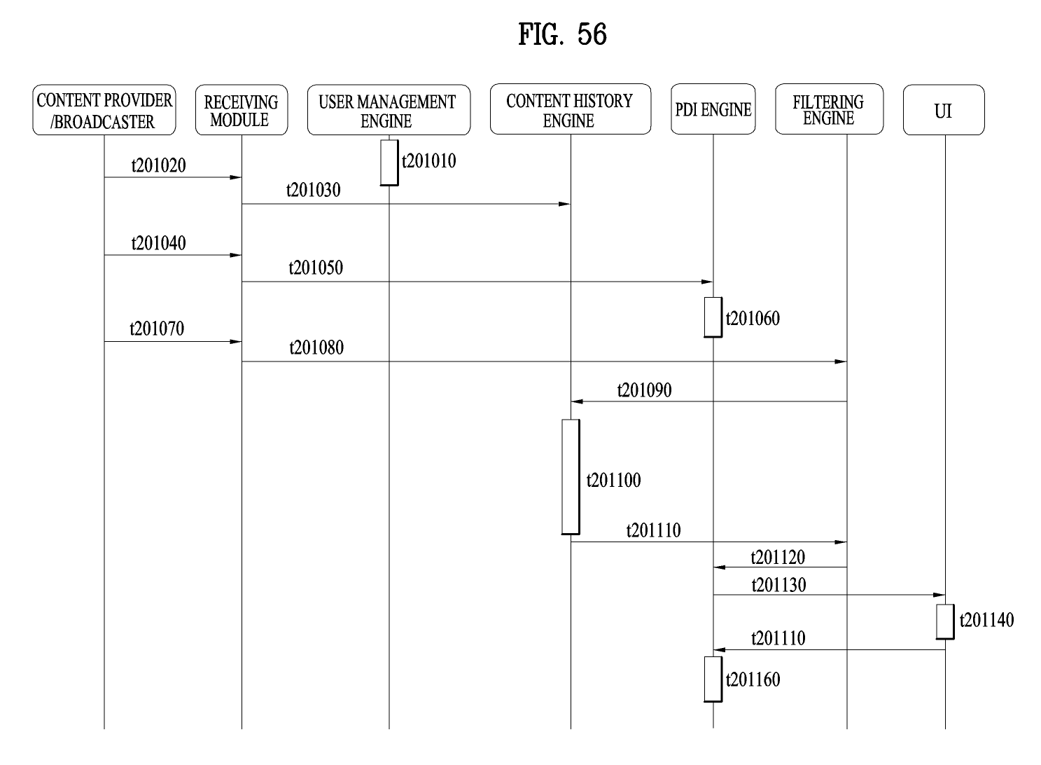

FIG. 56 is a diagram illustrating a procedure of collecting PDI user data based on simplified content history information using a heuristic method according to an embodiment of the present invention (criteria information is transmitted through filtering criteria).

The login process and the signaling of the tag information items (t201011 to t200030) may be the same as the above description. The receiving module may receive PDI user data from the content provider and the broadcaster (t201040). This may be similar to the operation of receiving the aforementioned PDI user data but, in this case, the PDI user data may not include question exposure criteria information.

The received PDI user data may be transmitted to the PDI engine (t201050) and stored in a PDI store (t201060). In this case, the corresponding PDI user data may be simply stored rather than being exposed to the user.

The receiving module may receive filtering criteria from the content provider and the broadcaster (t201070). The filtering criteria may be transmitted through a broadcast network or a broadband and may be filtering criteria of a type for determining whether a PDI question is exposed based on the content history. The question exposure criteria information in the filtering criteria may be tag type information. For example, there may be question exposure criteria information such as “Baseball, Newyork”. The receiving module may transmit the received filtering criteria to the filtering engine/module (t201080).

The filtering engine may parse the filtering criteria and, then, transmit the question exposure criteria information and the threshold value to the content history engine in order to determine whether matching is achieved (t201090). The content history engine may search for content history information that satisfies conditions based on the received information items (t201100). In this case, search may be performed using the tag information. An operation of determining whether matching is achieved has been described above. The content history engine may transmit the matching result to the filtering engine (t201110).

The filtering engine may notify the PDI engine of the PDI question of the PDI user data indicated by @targetQuestionTableId when matching is achieved (t201120). The PDI engine may expose the corresponding PDI question to a user through a UI (t201130). The user may answer to the question through the UI (t201140) and the PDI engine may receive the corresponding answer (t201150) and store the answer in the PDI user data of the PDI store (t201160).

Each of the aforementioned operations may be omitted or replaced with another operation with the same or similar function in some embodiments.

FIG. 57 is a diagram illustrating a procedure of collecting PDI user data based on content history information in an auto content recognition (ACR) situation according to an embodiment of the present invention.

In a viewing environment in which a service is provided by an external decoding unit such as a set top box (STB), signaling through a broadcast ground wave may not be possible. In this case, signaling through the aforementioned ground wave may not be possible.

Accordingly, in this environment, i.e., an environment that requires ACR, a method of performing filtering on the aforementioned content history and determination of whether a PDI question is exposed. In this case, an ACR server may simply recognize currently watched broadcast and may also perform personalization information management between users, collection/management of content history information, and so on.

The illustrated embodiment is the case in which question exposure criteria information is included in PDI user data. However, the present invention may also include the case in which question exposure criteria information is included in filtering criteria and is not limited to the illustrated embodiment. In addition, in the illustrated embodiment, ACR using a fingerprint method may be assumed but another ACR method such as a watermark is not excluded from the present invention.

First, a broadcaster may extract a fingerprint for each program using a tool provided by an ACR company. In this case, the broadcaster may establish an audio/video fingerprint DB. If necessary, both audio and video fingerprints may be extracted and stored. Then, the broadcaster may transmit the extracted fingerprint to the ACR server. In the case of pre-manufactured content/services, a fingerprint may be transmitted before being broadcast and, in the case of live content/services, a fingerprint may be extracted and transmitted in real time. In the case of live, a broadcaster may pre-apply unique ID information for recognizing content, map the ID information and a fingerprint extracted in real time, and transmit the mapping result to the ACR server. The ACR server may store the received fingerprints in a DB.

The receiving module may receive a broadcast service from the content provider and the broadcaster through an external decoding unit such as STB (t202010). The receiving module may extract a fingerprint (signature) for each frame of the received broadcast content/services and transmit the extracted fingerprint (signature) to the ACR server (t202020). This may be a type of query request. The ACR server may search for the received fingerprint in an ACR DB and retrieved matching content. When the content is recognized, the ACR server may transmit information on content and an address of a related signaling server to the receiver (t202030). Simultaneously, the ACR server recognizes viewing information of the receiver and, thus, may store and manage the information in the form of content history information.

With respect to whether related PDI user data is present according to the recognition result of content, the receiver may make a request for PDI user data to a signaling server (t202040). This may be performed by a network interface and so on in the receiver. According to the present embodiment, the receiving module may be a type of network interface. In this case, the signaling server may be a type of PDI server. The signaling server may transmit the related PDI user data to the PDI engine in the receiver (t202050).

The PDI engine may parse the received PDI user data and acquire question exposure criteria information (t202060). The PDI engine may transmit question exposure criteria information to the ACR server (t202070). The transmission may be performed through the receiving module and the network interface. The ACR server may determine whether the content history information and the received question exposure criteria information match (t202080). The matching result may be transmitted to the PDI engine (t202090). The transmission may also be performed through the receiving module and the network interface.

The PDI engine may expose the PDI question of the corresponding PDI user data to the user through a UI when matching is achieved (t202100). The user may answer the question through a UI (t202110) and the PDI engine may receive the corresponding answer and store the answer in PDI user data of the PDI store (t202120).

Each of the aforementioned operations may be omitted or replaced with another operation with the same or similar function in some embodiments.

FIG. 58 is a diagram illustrating a method of providing a personalized service according to an embodiment of the present invention.

The method of providing a personalized service according to an embodiment of the present invention may include receiving a personalization table, acquiring and storing an answer, receiving first filtering criteria, and/or receiving service data on a specific service.

First, the receiving module may receive the personalization table including at least one personalization question about provision of the personalized service (t203010). Here, the personalization question may refer to the aforementioned PDI question. The personalization table may refer to the aforementioned PDI user data and PDI table. Here, the receiving module may refer to a receiving module in a broadcast receiver and refer to a tuner or a network interface or a combination thereof.

A personalization module may acquire an answer to at least one personalization question from a user and store the answer (t203020). Here, the personalization module may refer to the aforementioned PDI engine/module. The procedure of acquiring an answer may be performed using a UI. The PDI engine may store the acquired answer in PDI user data in a PDI store.

Then, the receiving module may receive first filtering criteria including personalization criteria information on a specific service (t203030). Here, the personalization criteria information may refer to criteria information that is a criteria for filtering of content/services based on PDI user data. Here, the first filtering criteria may be filtering criteria of a type used to filter content/services. The first filtering criteria may be filtering criteria about filtering of “specific service”.

A filtering module may compare personalization criteria information of the received first filtering criteria and the stored answer and determine whether the matching is achieved, and when matching is achieved, the receiving module may receive service data about a specific service (t203040). The criteria information items of filtering criteria and PDI user data may be compared to determine whether matching is achieved. During this procedure, the aforementioned threshold value, a weight, or the like may be used. When matching is achieved, the corresponding service/content may be determined to match user preference and may be received by the receiving module.

A method of providing a personalized service according to another embodiment of the present invention may further include generating and storing viewing history information on service viewing of a user. Here, the history module may correspond to the aforementioned content history engine/module. Here, the viewing history information may correspond to the aforementioned content history information and content history table. Here, the content history information may be stored in a content history store.

In a method of providing a personalized service according to another embodiment of the present invention, the first filtering criteria may further include history criteria information on a specific service. The first filtering criteria may further include criteria information based on content history information as well as criteria information based on PDI user data. Here, the history criteria information may correspond to criteria information based on the aforementioned content history. According to the present embodiment, the content history engine/module may compare the content history information and the history criteria information. When the content history information and the history criteria information match, the corresponding service/content may be determined to correspond to a service viewing history of a user and service data may be received by the receiving module. Here, the aforementioned threshold value, a weight, or the like may be used in matching. The present embodiment may correspond to the case in which service/content filtering is performed in consideration of both the PDI user data and/or the content history information.

In a method of providing a personalized service according to another embodiment of the present invention, the personalization question may include at least one question exposure criteria information items about whether the corresponding personalization question is exposed. Here, the question exposure criteria information may correspond to the aforementioned question exposure criteria information. The present embodiment may correspond to the case in which the question exposure criteria information is transmitted in the PDI user data.

The method of providing a personalized service according to another embodiment of the present invention may further include receiving second filtering criteria including a target personalization question indicator and at least one question exposure criteria information item by the receiving module. The target personalization question indicator may correspond to the aforementioned target question indicator, i.e., @targetQuestionTableId. Here, the second filtering criteria may correspond to filtering criteria of a type that mainly determines whether the aforementioned PDI question is exposed. The question exposure criteria information may correspond to a FilterCriteria element or the like in the aforementioned filtering criteria. The present embodiment may correspond to the case in which question exposure criteria information is transmitted through filtering criteria.

In the method of providing a personalized service according to another embodiment of the present invention, the acquiring and storing of the aforementioned personalization question may include comparing and matching the question exposure criteria information and the viewing history and/or acquiring and storing an answer to the personalization question. The aforementioned content history engine/module (history module) may compare the received question exposure criteria information and content history information. Determination of whether matching is achieved may be performed according to the aforementioned embodiments of the present invention. When it is determined that matching is achieved, the PDI engine (personalization module) may expose the corresponding personalization question. Here, the corresponding personalization question may be a PDI question of PDI user data of the question exposure criteria information or a PDI question indicated by the target question indicator of filtering criteria.

In the method of providing a personalized service according to another embodiment of the present invention, the second filtering criteria may further include threshold value information. The threshold value information may correspond to the aforementioned @threshold. According to the present embodiment, when the number of viewing history information items corresponding to the question exposure criteria information items is greater than a value of the threshold value information, it may be determined that matching is achieved. When matching is achieved, the specific personalization question may be exposed. The determination may be performed by the content history engine/module or the PDI engine/module.

In the method of providing a personalized service according to another embodiment of the present invention, the stored viewing history information may be a plurality of tags for representing a viewed service. In order to overcome the aforementioned problem, a heuristic method may be used. In this case, a tag may be transmitted to the receiver along with the signaling information. The question exposure criteria information transmitted through the second filtering criteria may also be represented using a tag. According to the present embodiment, in the exposing of the specific personalization question, when the number of viewing history information items including all of at least one tag of the question exposure criteria information is greater than a value of threshold value information, it may be determined that matching is achieved. When matching is achieved, the specific personalization question may be exposed. The determination may be performed by the content history engine/module or the PDI engine/module. The present embodiment may correspond to the case in which a heuristic method is used.

In the method of providing a personalized service according to another embodiment of the present invention, the receiving module may receive broadcast content from an external decoding unit. Here, the external decoding unit may correspond to the aforementioned STB or the like. In the present embodiment, the ACR module may generate a fingerprint of frames of broadcast content and transmit the fingerprint to the ACR server. Here, the ACR module may be a specific module in the receiver or the aforementioned receiving module and network interface. Here, transmission of the fingerprint may involve viewing history information on service viewing of a user, i.e., content history information. The present embodiment may correspond to collection of PDI user data based on content history information in an ACR environment.

In the method of providing a personalized service according to another embodiment of the present invention, the personalization question may include at least one question exposure criteria information item about whether the corresponding personalization question is exposed. This is obtained by considering the case in which the question exposure criteria information is transmitted through PDI user data. The ACR module may transmit the question exposure criteria information to the ACR server. The question exposure criteria information may be compared with content history information that accumulates in the ACR server. A matching procedure may be performed in the same manner as in the aforementioned embodiments. The ACR module may receive the matching result from the ACR server. When matching is achieved, the personalization module (PDI engine/module) may expose the corresponding personalization question, acquire an answer from the user, and store the answer. The present embodiment may correspond to collection of PDI user data based on content history information in an ACR environment.

According to an embodiment of the present invention, a method of providing a personalized service by a content provider will be described. The method is not shown in the drawings.

The content provider may generate PDI user data including a PDI question and transmit the PDI user data to the receiver. Here, the PDI question and the PDI user data may be the PDI question and the PDI user data according to the aforementioned embodiments, respectively. Structures and internal information thereof may be determined according to each of the aforementioned embodiments.

The content provider may generate filtering criteria and transmit the filtering criteria to the receiver. Here, the filtering criteria may be filtering criteria according to each of the aforementioned embodiments. For example, the filtering criteria may be filtering criteria for filtering of service/content or filtering criteria for filtering whether a PDI question is exposed. Structures and internal information thereof may be determined according to each of the aforementioned embodiments.

The content provider may generate service/content and transmit the service/content to the receiver. Transmission of the service/content may be performed according to a filtering result of the filtering criteria.

Here, generation of the PDI user data and generation of filtering criteria may be performed by a PDI data generating module. Generating of service/content may be performed by a service data generating module. Data transmission to the receiver may be performed by a transmission module.

The ACR server may perform an ACR operation and, simultaneously, store content history information. The ACR server may receive question exposure criteria information and determine whether matching is achieved or receive criteria information based on PDI user data and determine whether matching is achieved. This may be performed by a content history module, a PDI module, a network interface, an ACR DB, and so on in the ACR server.

Each of the aforementioned operations may be omitted or replaced with another operation with the same or similar function in some embodiments.

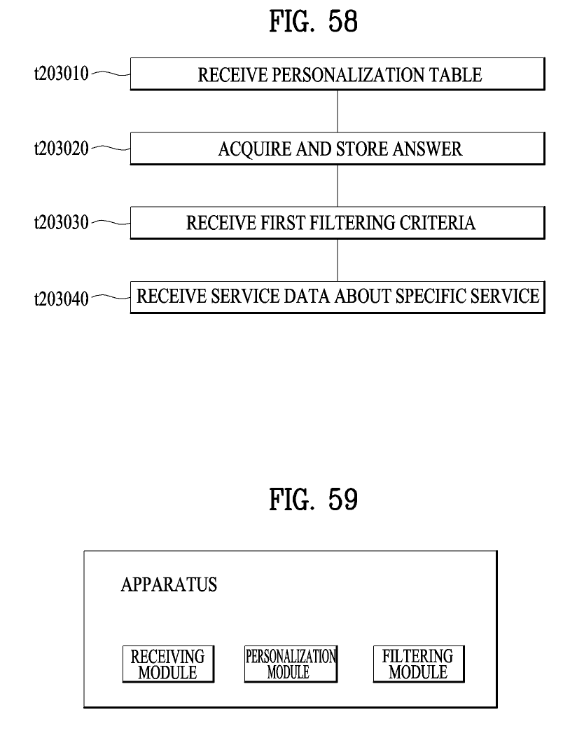

FIG. 59 is a diagram illustrating a broadcast receiver for providing a personalized service according to an embodiment of the present invention.

The broadcast receiver for providing the personalized service according to an embodiment of the present invention may include the aforementioned receiving module, the personalization module, and/or the filtering module. In some embodiments, the broadcast receiver may further include a content history module and/or an ACR module. Each block and module may be the same as in the above description.

The broadcast receiver and modules/blocks therein for providing a personalized service according to an embodiment of the present invention may perform embodiments of the aforementioned method of providing the personalized service

An apparatus for providing a personalized service according to an embodiment of the present invention by a content provider will be described. The apparatus is not shown in the drawing.

The apparatus for providing the personalized service by the content provider according to an embodiment of the present invention, the apparatus may include the aforementioned PDI data generating module, the service data generating module, and/or the transmitting module. The apparatus of the ACR server may include a content history module, a PDI module, a network interface, and/or an ACR DB. Each of blocks and modules is the same as in the above description.

The apparatus and modules/blocks therein for providing a personalized service by a content provider according to an embodiment of the present invention may perform the aforementioned embodiments of the method of providing the personalized service by the content provider. The apparatus and modules/blocks therein of the ACR server according to an embodiment of the present invention may perform the aforementioned embodiments of the method of providing the personalized service by the ACR server.

The blocks/modules, etc. in the aforementioned apparatus for a personalized service may be processors that perform consecutive procedures stored in a memory or, in some embodiments, may be hardware elements positioned inside/outside the apparatus.

The aforementioned modules may be omitted or replaced with another module with the same or similar function in some embodiments.

The module or unit may be one or more processors designed to execute a series of execution steps stored in the memory (or the storage unit). Each step described in the above-mentioned embodiments may be implemented by hardware and/or processors. Each module, each block, and/or each unit described in the above-mentioned embodiments may be realized by hardware or processor. In addition, the above-mentioned methods of the present invention may be realized by codes written in recoding media configured to be read by a processor so that the codes can be read by the processor supplied from the apparatus.

Although the description of the present invention is explained with reference to each of the accompanying drawings for clarity, it is possible to design new embodiment(s) by merging the embodiments shown in the accompanying drawings with each other. And, if a recording medium readable by a computer, in which programs for executing the embodiments mentioned in the foregoing description are recorded, is designed in necessity of those skilled in the art, it may belong to the scope of the appended claims and their equivalents.

An apparatus and method according to the present invention may be non-limited by the configurations and methods of the embodiments mentioned in the foregoing description. And, the embodiments mentioned in the foregoing description can be configured in a manner of being selectively combined with one another entirely or in part to enable various modifications.

In addition, a method according to the present invention can be implemented with processor-readable codes in a processor-readable recording medium provided to a network device. The processor-readable medium may include all kinds of recording devices capable of storing data readable by a processor. The processor-readable medium may include one of ROM, RAM, CD-ROM, magnetic tapes, floppy discs, optical data storage devices, and the like for example and also include such a carrier-wave type implementation as a transmission via Internet. Furthermore, as the processor-readable recording medium is distributed to a computer system connected via network, processor-readable codes can be saved and executed according to a distributive system.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Both the product invention and the process invention are described in the specification and the description of both inventions may be supplementarily applied as needed.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Both apparatus and method inventions are mentioned in this specification and descriptions of both of the apparatus and method inventions may be complementarily applicable to each other.

### MODE FOR INVENTION

Various embodiments have been described in the best mode for carrying out the invention.

### INDUSTRIAL APPLICABILITY

The embodiments of the present invention are available in a series of broadcast signal provision fields.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of providing a personalized service by a broadcast receiver, the method comprising:
receiving, by a receiving module, a personalization table comprising at least one personalization question about provision of a personalized service;
acquiring, by a personalization module, an answer to the at least one personalization question from a user and storing the answer;
receiving, by the receiving module, first filtering criteria comprising personalization criteria information on a specific service; and
receiving, by the receiving module, service data about the specific service when the personalization criteria information of the received first filtering criteria and the stored answer are compared and matched by a filtering module.

2. The method according to claim 1, further comprising generating and storing, by a history module, viewing history information on service viewing of a user.

3. The method according to claim 2, wherein:
the first filtering criteria further comprises history criteria information on the specific service; and
the receiving of the service data about the specific service comprises receiving the service data about the specific service when history criteria information in the first filtering criteria and the stored viewing history are compared and matched.

4. The method according to claim 2, wherein the personalization question comprises at least one question exposure criteria information item about whether a corresponding personalization question is exposed.

5. The method according to claim 2, further comprising receiving, by the receiving module, second filtering criteria comprising a target personalization question indicator and at least one question exposure criteria information item,
wherein:
the target personalization question indicator indicates a specific personalization question; and
the question exposure criteria information is information about whether the specific personalization question is exposed.

6. The method according to claim 5, wherein the acquiring and storing of the personalization question comprises:
exposing, by the personalization module, the specific personalization question when the history module compares the question exposure criteria information and the viewing history information and the question exposure criteria information and the viewing history information are matched; and
acquiring, by the personalization module, the specific personalization question from a user and storing the answer.

7. The method according to claim 6, wherein:
the second filtering criteria comprises threshold value information;
the exposing of the specific personalization question comprises exposing the specific personalization question when the number of viewing history information items corresponding to the question exposure criteria information items is greater than a value of the threshold value information.

8. The method according to claim 6, wherein:
the stored viewing history information is a plurality of tags representing a viewed service and question exposure criteria information of the second filtering criteria comprises at least one tag; and
the exposing of the specific personalization question comprises exposing the specific personalization question when the number of viewing history information items comprising all of at least one tag of the question exposure criteria information is greater than a value of the threshold value information.

9. The method according to claim 1, further comprising:
receiving, by the receiving module, broadcast content from an external decoding unit; and
generating, by an auto content recognition (ACR) module, a fingerprint of frames of the broadcast content and transmitting the fingerprint to an ACR server,
wherein the transmitting of the fingerprint involves viewing history information on service viewing of a user.

10. The method according to claim 9, wherein:
the personalization question comprises at least one question exposure criteria information item about whether a corresponding personalization question is exposed; and
the acquiring and storing of the answer of the personalization question comprises:
transmitting, by the ACR module, the question exposure criteria information to the ACR server, the question exposure criteria information being compared with viewing history information in the ACR server;
receiving, by the ACR module, a matching result between the question exposure criteria information and the transmitted viewing history information from the ACR server;
exposing, by the personalization module, the corresponding personalization question according to the matching result; and
acquiring, by the personalization module, an answer to the corresponding personalization question from a user and storing the answer

11. A broadcast receiver for providing a personalized service, comprising:
a receiving module configured to receive a personalization table comprising at least one personalization question about provision of a personalized service;
a personalization module configured to acquire an answer to the at least one personalization question from a user and to store the answer, the receiving module receiving first filtering criteria comprising personalization criteria information on a specific service; and
a filtering module configured to compare personalization criteria information of the received first filtering criteria and the stored answer, when the personalization criteria information and the stored answer are matched, the receiving module receiving service data about the specific service.

12. The broadcast receiver according to claim 11, further comprising:
a history module configured to generate and store viewing history information on service viewing of a user.

13. The broadcast receiver according to claim 12, wherein:
the first filtering criteria further comprises history criteria information on the specific service;
the history module compares history criteria information in the first filtering criteria and the stored viewing history; and
when the history criteria information matches the stored viewing history information, the receiving muddle receives service data about a specific service.

14. The broadcast receiver according to claim 12, wherein the personalization question comprises at least one question exposure criteria information item about whether a corresponding personalization question is exposed.

15. The broadcast receiver according to claim 12, wherein:
the receiving module receives second filtering criteria comprising a target personalization question indicator and at least one question exposure criteria information item;
the target personalization question indicator indicates a specific personalization question; and
the question exposure criteria information is information about whether the specific personalization question is exposed.

16. The broadcast receiver according to claim 15, wherein:
the history module compares the question exposure criteria information and the viewing history information;
when the question exposure criteria information and the viewing history information are matched, the personalization module exposes the specific personalization question, acquiring an answer to the specific personalization question from a user, and storing the answer.

17. The broadcast receiver according to claim 16, wherein:
the second filtering criteria further comprises threshold value information; and
the history module determines that the question exposure criteria information and the viewing history information match when the number of viewing history information items corresponding to the question exposure criteria information items is greater than a value of the threshold value information.

18. The broadcast receiver according to claim 16, wherein:
the stored viewing history information is a plurality of tags representing a viewed service and question exposure criteria information of the second filtering criteria comprises at least one tag;
the history module determines that the question exposure criteria information and the viewing history information match when the number of viewing history information items comprising all of at least one tag of the question exposure criteria information is greater than a value of the threshold value.

19. The broadcast receiver according to claim 11, wherein:
the receiving module receives broadcast content from an external decoding unit;
the broadcast receiver further comprises an auto content recognition (ACR) module configured to generate a fingerprint about frames of the broadcast content and to transmit the fingerprint to an ACR server;
transmitting of the fingerprint involves viewing history information on service viewing of a user.

20. The broadcast receiver according to claim 19, wherein:
the personalization question comprises at least one question exposure criteria information item about whether a corresponding personalization question is exposed; and
the ACR module transmits the question exposure criteria information to the ACR server, the question exposure criteria information being compared with viewing history information in the ACR server;
the ACR module receives a matching result between the question exposure criteria information and the transmitted viewing history information from the ACR server; and
the personalization module exposes the corresponding personalization question according to the matching result, acquires an answer to the corresponding personalization question from a user, and stores the answer.
